(19) United States
(12) Patent Application Publication
(10) Pub. No.: US 2002/0078067 A1
(43) Pub. Date: Jun. 20, 2002

(54) Method for academic achievement

(76) Inventors: Douglas J. Collins, Ozona, FL (US); Steven P. Beaver, St. Petersburg Beach, FL (US)

Correspondence Address: Stefan V. Stein, Holland & Knight LLP, Suite 2300, 400 North Ashley Drive, Tampa, FL, 33602, US

(21) Appl. No.: 09/946,162

(22) Filed: Sep. 4, 2001

Related U.S. Application Data
(60) Provisional application No. 60/229,909, filed on Sep. 1, 2000.
(60) Provisional application No. 60/307,522, filed on Jul. 24, 2001.

(51) Int. Cl. G06F 17/30

(52) U.S. Cl. 707/104.1; 707/100

(57) ABSTRACT

A method for facilitating academic improvement, comprising the steps of providing a database of students who have qualified for an academic improvement plan in at least one predefined content area, diagnostic testing of the students relating to their respective content area and recording in the database the diagnostic results of the testing in the database, developing and recording in the database at least one intervention strategy based in part upon the results of the diagnostic testing of the respective students or based in part on a standardized testing, monitoring and recording in the database each of the student's respective progress and documenting in the database the successful completion of the academic improvement for each respective student.

### CROSS-REFERENCE TO RELATED APPLICATIONS

This application claims the benefit of provisional applications Ser. No. 60/229,909, filed Sep. 1, 2000 and Ser. No. 60/307,522, filed Jul. 24, 2001, the disclosures of which are hereby incorporated by reference herein.

### BACKGROUND OF THE INVENTION

1. Field of the Invention

This invention relates to a method for determining a student's proficiency in reading, writing, science and mathematics, implementing remediation, monitoring remediation and reporting remediation in the development areas in which the student has been identified as not being proficient in reading, writing, science or mathematics.

2. Description of the Background Art

Intensive remediation is instruction that is tailored for an individual student who has been identified to be deficient in reading, writing, science or mathematics. Remediation typically includes a variety of instructional strategies that are designed to align with the student's particular learning styles.

State legislators have mandated that each student's progression from one grade to another, be determined, in part, upon proficiency in reading, writing, science and mathematics. In order to accomplish such goals, school districts must adopt policies that facilitate such proficiencies and further, each student and his or her parent or legal guardian be informed of his or her academic progress. For example, as set forth in Florida Statutes 232.245, the disclosure of which is hereby incorporated by reference herein, a comprehensive program for student progression typically includes standards for evaluating each student's performance including how well he or she masters approved performance standards. Specific levels of performance in reading, writing, science and mathematics for each grade level must be established, below which a student must receive remediation. The student must also be provided with additional diagnostic assessments to determine the nature of the student's difficulty in the areas of academic need. The school in which the student is enrolled must develop, in consultation with the student's parent or legal guardian, and must implement an academic improvement plan designed to assist the student in meeting any applicable state and/or district expectations for proficiency. Each such plan must include the provision of intensive remedial instruction in the areas of weakness. Each student who does not meet the minimum performance expectations in reading, writing, science or mathematics must continue remedial or supplemental instruction until the expectations are met. Reports must be provided to the parent or legal guardian of each student regarding the progress of the student towards achieving the applicable state or district expectations for proficiency in reading, writing, science and mathematics. The district must report to the parent or legal guardian the student's results on each state-wide assessment test. The evaluation of each student's progress must be based upon the student's classroom work, observations, tests, applicable district or state assessments and other relevant information. Progress reporting must be provided to the parent or legal guardian in writing in a format adopted by the applicable district school board.

Exemplary criteria for determining academic proficiency is set forth in the Commission of Education of the Department of Education Memo 00-015, which provides that students in grades K-12 must receive remediation if they meet any of the following criteria:

Score at Level 1 on FCAT SSS Reading

Score at Level 1 on FCAT SSS Mathematics

Score less than 3 on FCAT Writing Assessment Program

Score less than 25^{th} percentile on FCAT Norm Referenced Reading

Score less than 25^{th} percentile on FCAT Norm Referenced Mathematics

Score less than 25^{th} percentile on the SAT 9 Reading in Grades 1, 2

Score less than 25^{th} percentile on SAT 9 Mathematics in Grades 1, 2

Fail the HSCT in mathematics or communication for students grades 11 and 12

In addition to the foregoing, school districts may apply more stringent requirements than that mandated by the Commissioner of Education. Further, the student's teacher can initiate remediation at any time the teacher assesses that the student is not progressing at a satisfactory level.

While state legislators have begun to mandate mandatory comprehensive programs for student progression, the implementation of such programs have largely been accomplished without the aid of computer programs. As a result, the required implementation, monitoring and reporting requirements of such programs have become difficult and unduly burdensome on the school districts and their teachers. Without the aid of an appropriate computer program, remediation programs are replete with inefficiencies and inaccuracies of information that compromise the intent of the state legislators to meaningfully provide for remediation for students. Consequently, there presently exists a need for a computer program for implementing remediation programs on a cost-efficient and accurate basis so as to enhance the benefits of the remediation program to remediate a student's needs in the required developmental areas.

Therefore, it is an object of this invention to provide an improvement which overcomes the aforementioned inadequacies of the prior art programs and provides an improvement which is a significant contribution to the advancement of the art of academic achievement.

Another object of this invention is to provide a remediation computer program that facilitates student achievement.

Another object of this invention is to provide a remediation computer program that replaces labor-intensive paper forms.

Another object of this invention is to provide a remediation computer program that reduces administrative costs.

Another object of this invention is to provide a remediation computer program that increases teachers' time to teach.

Another object of this invention is to provide a remediation computer program that encourages a collaborative teaching environment.

Another object of this invention is to provide a remediation computer program that provides accurate auditing to the State.

Another object of this invention is to provide a remediation computer program that offers strategy suggestions based on past educational successes.

Another object of this invention is to provide a remediation computer program that delivers classroom and school reports through a simple web browser.

Another object of this invention is to provide a remediation computer program that presents teachers with quick access to student achievement information to help with decision making.

Another object of this invention is to provide a remediation computer program that supports teachers and administrators in the analysis of student achievement data for school improvement.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises a computer program that facilitates the academic achievement of students in the educational system. The computer program of the invention, known as the Academic Improvement Plan (“AIP”), functions to meet the requirements of Florida Statute 232.245 concerning student remediation and progression.

Functionally, the AIP of the invention documents a remediation process that includes an identification of the students eligible for remediation, the administration of diagnostic assessment for each area of developmental need, the consultation with the parent or guardian to identify intervention strategies, the implementation of intervention strategies with ongoing assessment of student progress, and the evaluation of the progress to determine if the intervention strategies need modification or if proficiency is achieved.

The AIP of the invention equips educators with the ability to custom design intervention strategies for remediation for each individual student. Facilities are provided that automatically gather, diagnose, analyze and assist in identifying intervention strategies. In addition, the AIP of the invention tracks student's progress with previously-successful intervention strategies.

The AIP of the invention accomplishes each of the objects of the invention listed above by including many features. It allows easy access to student achievement information by providing AIP tracking and analysis. It generates AIP form letters automatically. Highly mobile student populations are supported as well as tiered access to management capabilities. It provides complete management of content areas and intervention strategies and easily displays reports via web browsers. Web-enabled data may be centralized throughout a school district and accessed via the district's Intranet. It provides flexible reporting by teacher, school and district. It tracks parent, student, instructor and school interactions. Historical data is retained along with “point-in-time” information that may be readily accessed. During set-up, it may import current school, staff and student information automatically. The development areas for diagnosis and achievement strategies are customizable. Finally, it grants secured tiered-level access for instructor, schools and district administrators.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other methods for carrying out the same purposes of the present invention. It should also be realized by those skilled in the art that such equivalent methods do not depart from the spirit and scope of the invention as set forth in the appended claims.

### DETAILED DESCRIPTION OF THE PREFERRED EMBODIMENT OVERVIEW

The academic achievement business method of the invention, trademarked “A3”, provides a district wide web-enabled computerized solution to facilitate the academic achievement process using a centralized application server. The following identifies the steps involved in using A3 for facilitating student achievement within a given school district.

There are two separate processes that facilitate student achievement through A3. The load process imports necessary data to manage student achievement. The student achievement management process facilitates the education process for teachers, counselors, school administrators and district administrators.

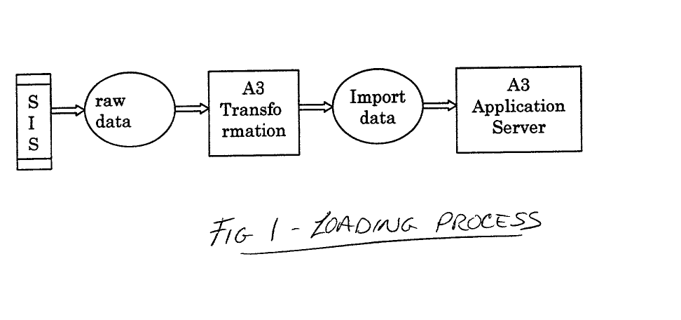

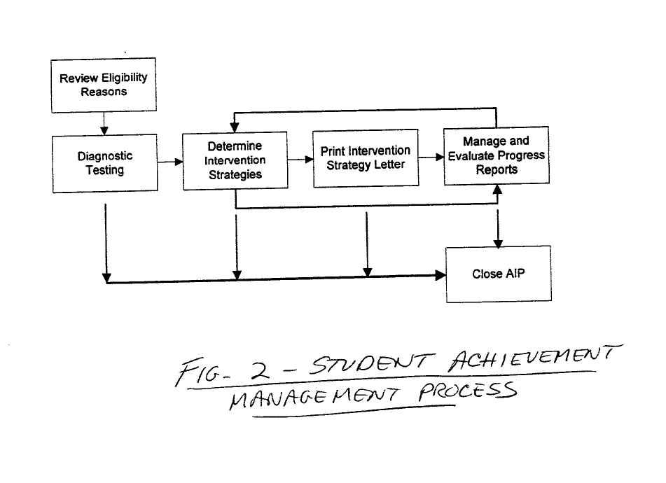

FIG. 1 depicts the import data flow for the A3 loading process of student information system (SIS) data extraction, A3 transformation, and importation of data into the A3 application server.

FIG. 2 depicts the process flow of student achievement management from an instructor's perspective as follows:

Load Process Steps (FIG. 1)

More particularly, the load process steps comprise creating a working database to build linkages between students, courses, teachers, schools, test scores and eligibility. The working database is created by:

1. From SIS system student's demographics, student's tests, student's courses, teacher's courses, teacher's demographics and school's controls:

Load the school controls into the working database.

Load teacher's demographics into the working database relating each teacher to a school.

Load teacher courses into the working database relating each teacher course to a teacher.

Load students into the working database relating the student to a school.

Load student course's into the working database relating a student to a teacher's course.

Load student test scores into the working database relating test scores to a student.

2. Create a map between courses and A3 content areas: For each content area define a set of courses.

Create a relationship for each course to the content area it is associated.

3. Identify eligible students:

Get all eligibility rules.

For each eligibility rule retrieve students from the working data base that match the query identifying students that meet the eligibility rule.

Create eligibility relationship between student, test score, content area, and eligibility reason for each student that matches the eligibility rule query criteria.

4. Create A3 import files:

Create a schools control file from the working database.

Create a teacher's course file from the working database.

Create students file from the working database.

Create a student eligibility factors file from the working database.

5. Import A3 import files:

Load schools control file into A3 database relating school to active year and district.

Load teacher's course file into A3 database creating courses, associating courses to schools, creating teachers and associating teacher's to courses.

Load students file into A3 database .

Load student eligibility factors file into A3 database.

Student Achievement Management Process (FIG. 2)

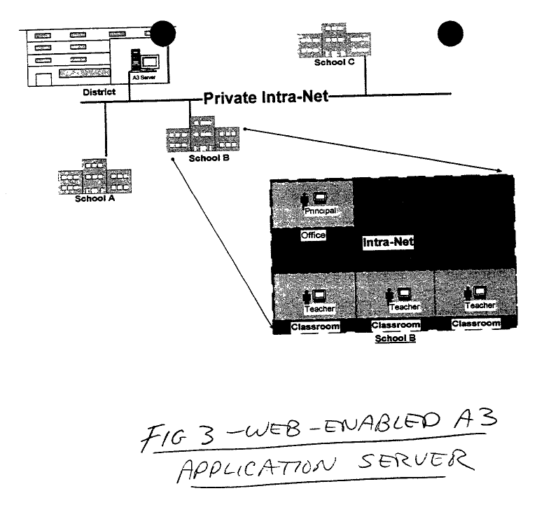

As shown in FIG. 3, the A3 application server is accessible anywhere in the district that has access to the district intra/internet by using a URL address.

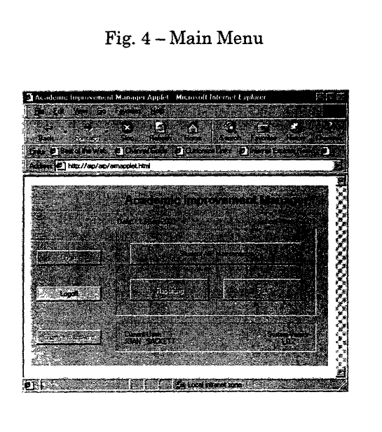

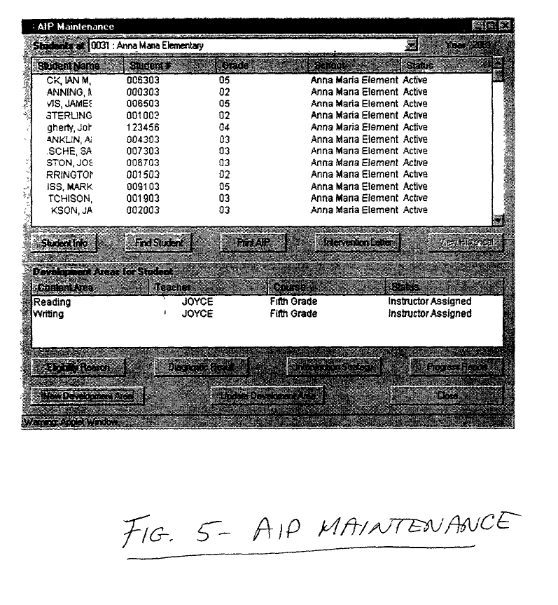

For accessing the A3 server with a Browser, specify the A3 URL address. As shown in FIG. 4, the Main Menu is displayed on the Internet browser. Once logged-on, the user may select various functions as follows:

1. Maintain Student AIP—From the Main Menu, selection of Maintain Student AIP displays AIP Maintenance. As shown in FIG. 5, the “AIP Maintenance” screen is used to find, display, print, and update student/AIP information. District Administrators and staff that work at multiple schools will use the pick-list above the student display window to select schools to work with. When a school is selected, students are automatically listed in the Student Display window. Specifically, from the “Main Menu,” enter the AIP area, select a school from the Students at: pick-list, and select a student. The Development Area(s) for this student will be listed below in the “Development Areas” display.

2. Development Area—The Development Area screen is located on the lower half of the “AIP Maintenance” screen of FIG. 5, and displays Development Areas for the student selected in the above display window. The buttons below the “Development Areas for Student” display window provide tools for working with the selected student Development Area, such as: viewing Eligibility Reasons, recording Diagnostic Results, selecting Intervention Strategies, Updating Development Area information, creating New Development Area, and working with Progress Reports. More particularly, to display the Development Area(s) for a student, from the “AIP Maintenance,” enter the School. Select a student. The Development Area(s) for this student will be listed below in the “Development Areas” display.

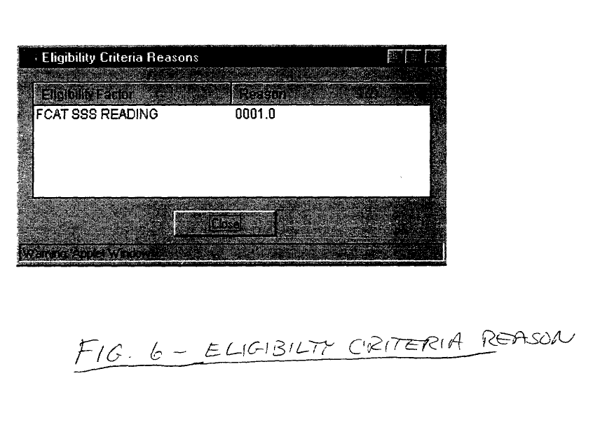

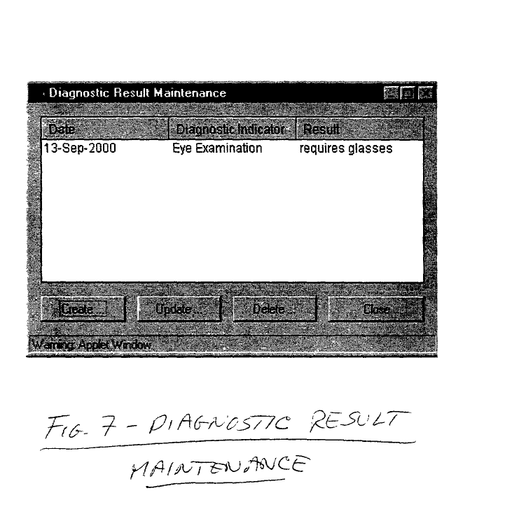

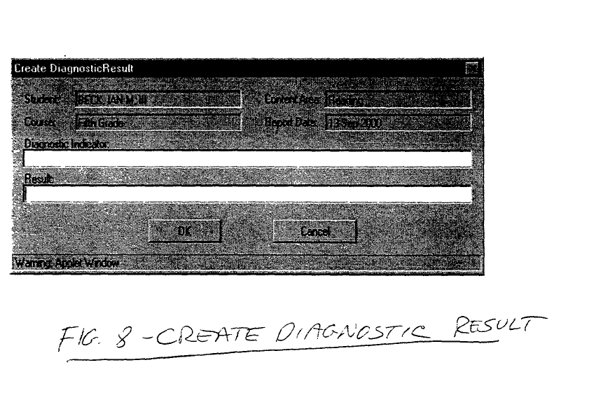

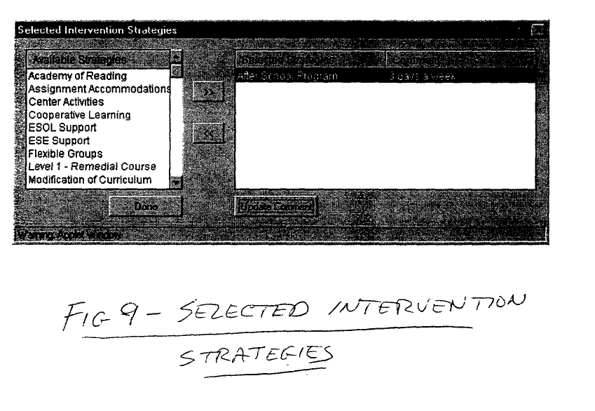

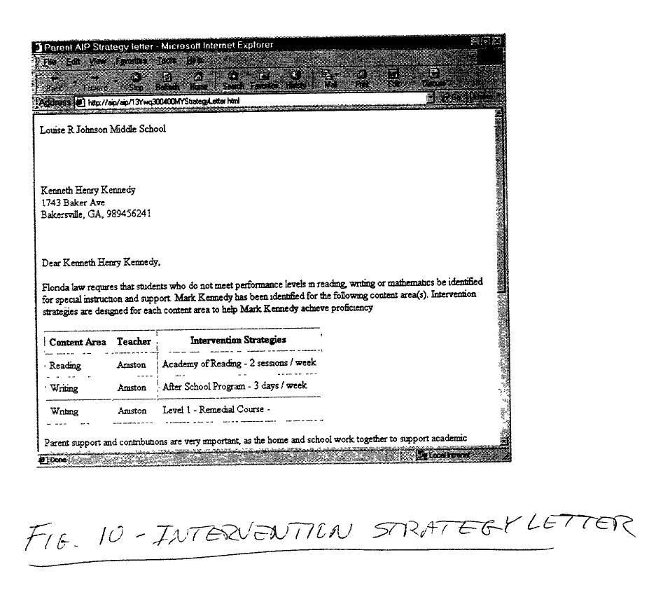

3. Review Eligibility Reasons—The A3 system is populated with the students who have qualified for an AIP. An AIP contains one or more Development Areas within the Content Areas (Reading, Writing, Math, etc.), as well as the associated Eligibility Reason that triggered the automatic generation of the AIP. More particularly, to View Eligibility Reasons, from the “Main Menu,” enter the AIP area, select a school from the Students at: pick-list, and select a student. The Development Area(s) for this student will be listed below in the “Development Areas” display. Select one of the Development Areas and click on the Eligibility Reason button (See FIG. 6). The Eligibility Reason for the Development Area will be displayed. Click on the Close button to return to the “AIP Maintenance” menu.

4. Diagnostic Testing—Instructors review the AIPs and Eligibility Reasons for each of their students. To help specify problem areas and determine appropriate intervention strategies, Diagnostic Testing is then performed for the identified Development Area. The Diagnostic Results are recorded in the A3 program. More particularly, to View Diagnostic Results for a Development Area, from the “Main Menu,” enter the AIP area. Select a school from the Students at: pick-list, and select a student. The Development Area(s) for this student will be listed below in the “Development Areas” display. Select a Development Area and click on the Diagnostic Result button to display the current Diagnostic Results for this Development Area. Click the Close button to return to the “AIP Maintenance” screen.

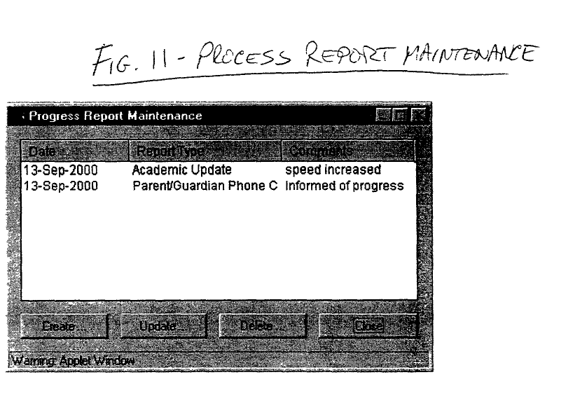

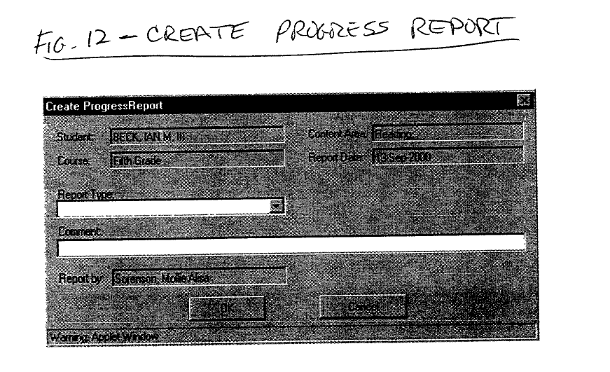

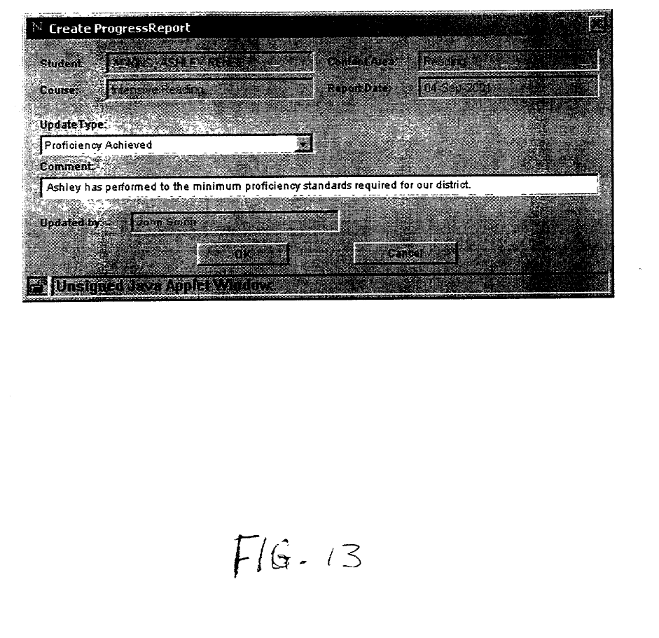

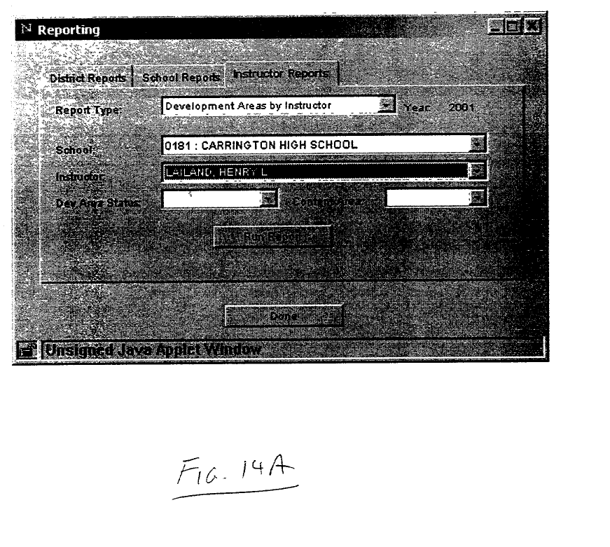

To Work with Diagnostic Results, from the “Diagnostic Result Maintenance” screen of FIG. 7, the user has the option to Create, Update, or Delete Diagnostic Results. To perform the Update or Delete functions, a Diagnostic Result must first be selected from the list. Click the Close button to return to the “AIP Maintenance” screen. For Adding Diagnostic Results to a Development Area, from the “Diagnostic Result Maintenance” screen of FIG. 7, click on the Create button. The “Create Diagnostic Results” screen will be presented (see FIG. 8). The fields for “Diagnostic Indicator” and “Result” allow free-form entry. Fill in both fields as necessary, and click the OK button. If the Cancel button is pressed, the Diagnostic Result will not be added to the Development Area. Click the Close button to return to the “AIP Maintenance” screen.

To Update a Diagnostic Result for a Development Area, from the “Diagnostic Result Maintenance” screen of FIG. 7, select a Diagnostic Result and click on the Update button. The “Update Diagnostic Results” screen will be presented. The fields for “Diagnostic Indicator” and “Result” allow free-form entry. Edit the current text as necessary and click the OK button. If the Cancel button is pressed, changes to the Diagnostic Result will not be updated. Click the Close button to return to the “AIP Maintenance” screen.

To Delete a Diagnostic Result for a Development Area, from the “Diagnostic Result Maintenance” screen, highlight the Diagnostic Result to be deleted. Click on the Delete button, and then OK to confirm that this Development Area should be deleted. Click the Close button to return to the “AIP Maintenance” screen.

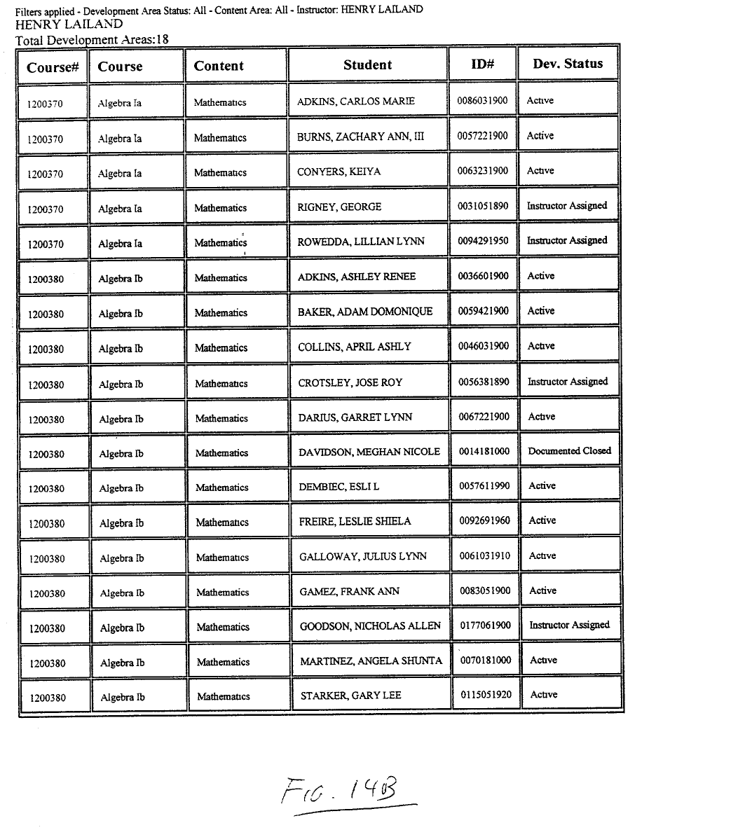

5. Determine Intervention Strategies—Based on the Diagnostic Results, interactions with the student, or discussions with the student's guardian and counselor, Intervention Strategies are identified for the student's Development Area. The instructor then selects Intervention Strategies for the student and manages them through the Intervention Strategies area of the A3 program. More particularly, to view Intervention Strategies, from the “Main Menu,” enter the AIP area. Select a school from the Students at: pick-list, and select a student. The Development Area(s) for this student will be listed below in the “Development Areas” display. Select a Development Area and click on the Intervention Strategy button to display the current Intervention Strategies for this Development Area (see FIG. 9). Click the Done button to return to the “AIP Maintenance” screen.

To Work with Intervention Strategies, the “Selected Intervention Strategies” screen is comprised of two windows. The left Available Strategies window displays strategies that can be added to the Development Area. The right Selected Strategies window displays strategies that have already been added to the Development Area. The Comments area displays any comments for each of the selected strategies.

To Create Intervention Strategy, from the “Selected Intervention Strategies” window, select an Intervention Strategy from the Available Strategies window. Click the >> button to move the strategy to the right Selected Strategies area. Highlight the selected strategy and press the Update Comment button to add a comment to the selected strategy. Click the Done button to return to the previous screen.

To Delete Intervention Strategy, select an Intervention Strategy from the Selected Strategies window. Click the << button to move the strategy back to the Available Strategies area. Click the Done button to return to the previous screen.

6. Print Intervention Strategy Letter—The Intervention Strategy Letter is created by selecting a student and clicking on the Intervention Letter button. The letter is automatically generated using the student and guardian's address information. More particularly, to view or print an Intervention Strategy Letter, from the “Main Menu,” enter the AIP area. Select a school from the Students at: pick-list, and select a student. Choose the Intervention Letter button. A web browser will be opened, and the Intervention Letter for the selected student will be displayed. To print the Intervention Letter, pull down from FILE to PRINT inside the web browser. Close the Web Browser to return to the “AIP Maintenance” screen.

7. Manage and Evaluate Progress Reports—During the entire school year, student progress is tracked and maintained in the A3 system. Instructors are able evaluate these reports to determine future courses of action through Intervention Strategies. More particularly, to view Progress Reports for a Development Area, from the “Main Menu,” enter the AIP area. Select a school from the Students at: pick-list, and select a student. The Development Area(s) for this student will be listed below in the “Development Areas” display. Select a Development Area and click on the Progress Report button to display the current Progress Reports for this Development Area. Click the Close button to return to the “AIP Maintenance” screen.

To Work with Progress Updates—from the “Progress Report Maintenance” screen (above), the user has the option to Create, Update, or Delete Progress Reports. To perform the Update or Delete functions, a Progress Report must first be selected from the list. Click the Cancel button to return to the “AIP Maintenance” screen.

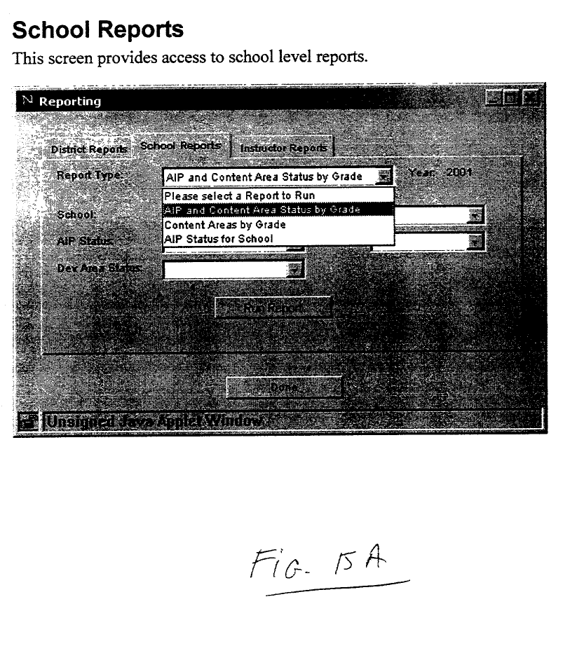

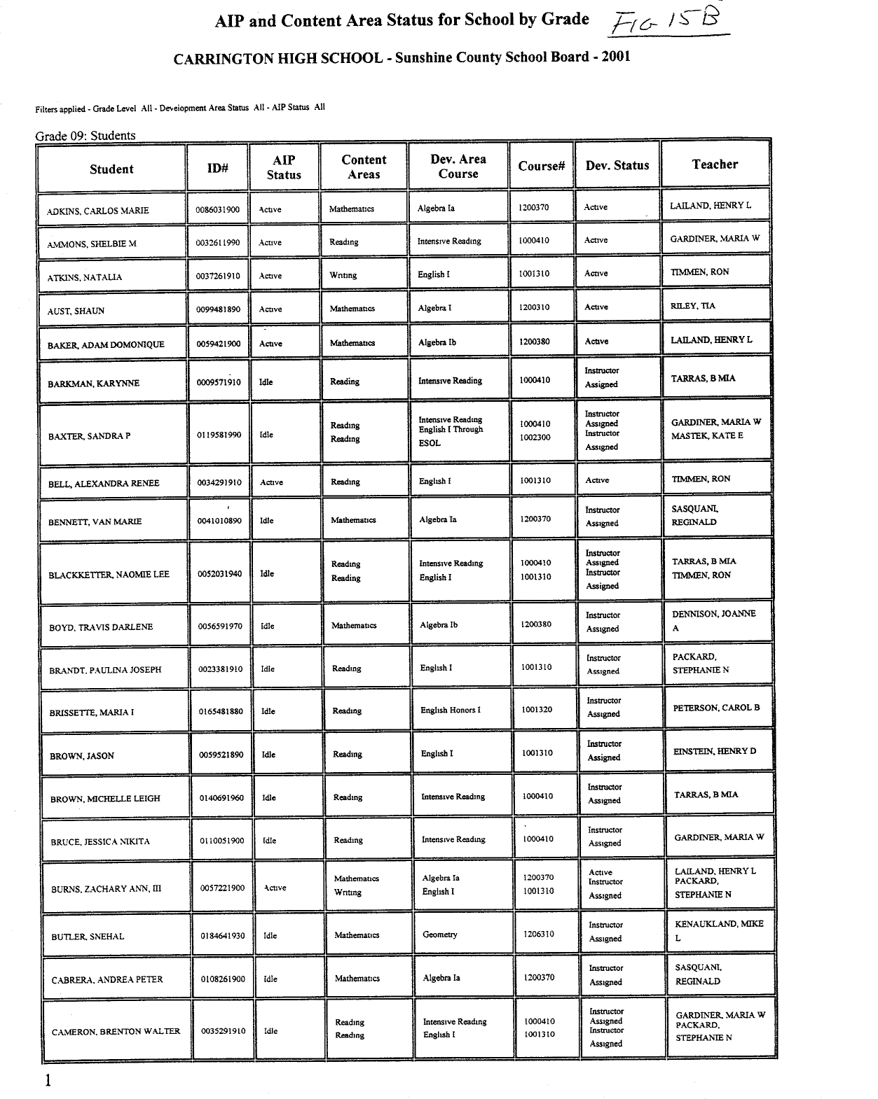

To Add a Progress Update to a Development Area, from the “Progress Updates Maintenance” screen, click on the Create button. The “Create Progress Report” screen is presented (see FIG. 12). Select a “Report Type.” The “Comments” field allows free-form entry. Fill in the field as necessary, and click the OK button. If the Cancel button is pressed, the Progress Report will not be created. Click the Close button to return to the “AIP Maintenance” screen.

To update a Progress Report for a Development Area, from the “Progress Report Maintenance” screen, select a Progress Report and click on the Update button. The “Update Progress Reports” screen will be presented. The “Comments” field allows for free-form entry. Edit the current text as necessary and click the OK button. If the Cancel button is pressed, changes to the Progress Report will not be updated. Click the Cancel button to return to the “AIP Maintenance” screen.

To Delete a Progress Report for a Development Area, from the “Progress Report Maintenance” screen, highlight the Progress Report to be deleted. Click on the Delete button, and then OK to confirm that this Progress Report should be deleted. Click the Cancel button to return to the “AIP Maintenance” screen.

8. Close Development Area—An Instructor may close a Development Area at any time based on teacher factors documented in the AIP. Each Development Area for a student may be individually closed, however until all Developmental Areas are closed, the AIP itself remains “Active.” When all Development Areas for a student are closed, then the AIP itself is automatically closed.

The “Update Development Area” screen allows the user to view and/or edit basic information for a student's Development area. Common tasks able to be performed here are: recording grades for courses relating to this Development Area, assigning teacher and/or courses.

To Close a Development Area based on proficiency achieved, from the “Main Menu,” enter the AIP area. Select a school from the Students at: pick-list, and select a student. Select a Development Area and click on the Progress Update button. Select “Proficiency Achieved” from the Report Type. Click the OK button to save the changes and return to the previous menu. In addition to document close and proficiency close, the Development Areas may be automatically closed such as at the end of the school year.

9. Reports—In addition to progress reports, many administrative reports can be generated as follows:

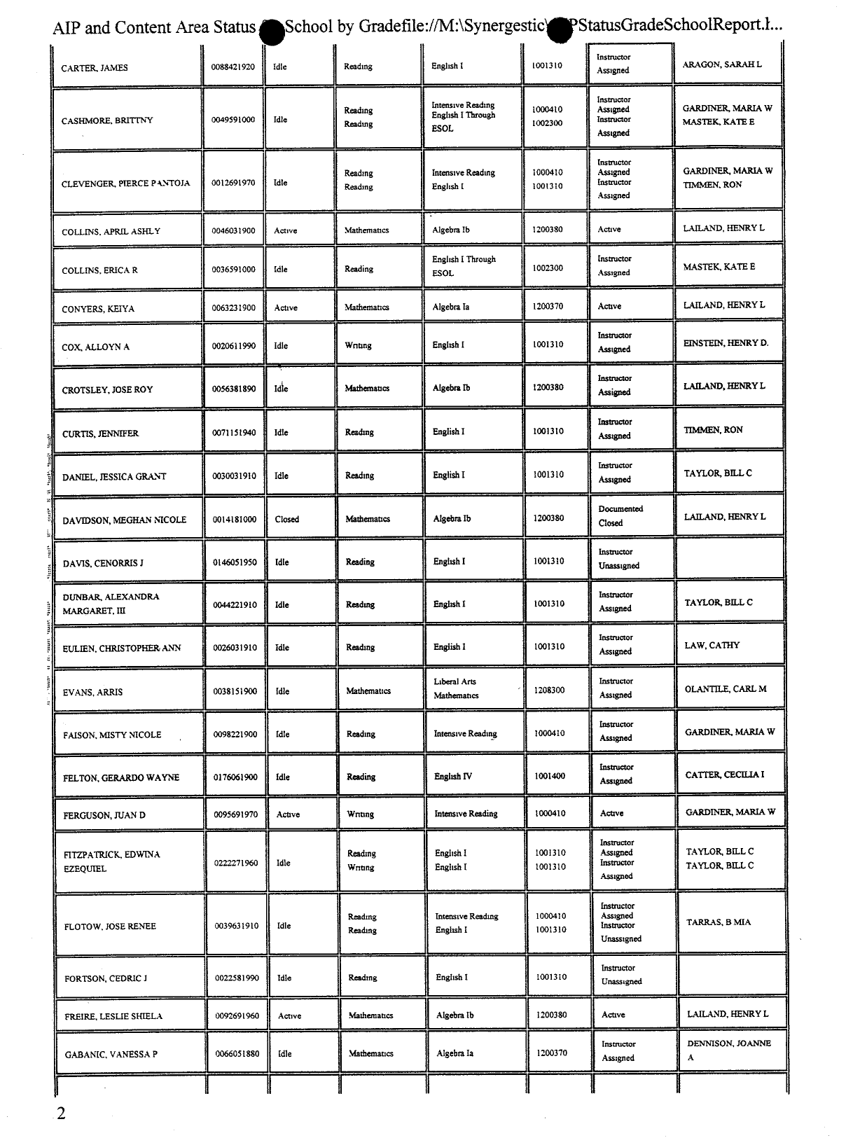

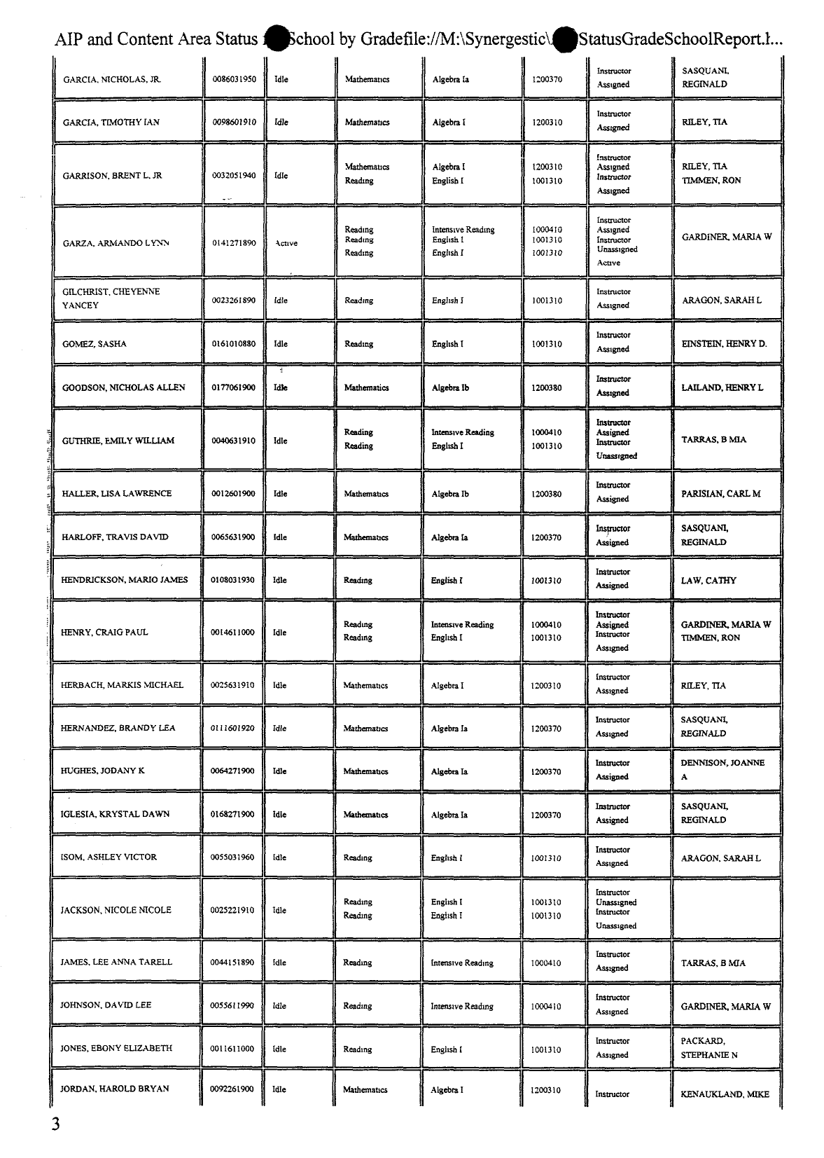

Instructor Reports—Reports by Instructors are selected by an Instruction Reports screen (FIG. 14A) and may include the Development Areas by Instructor (see sample of FIG. 14B). This report shows the individual students and development areas associated with a given instructor.

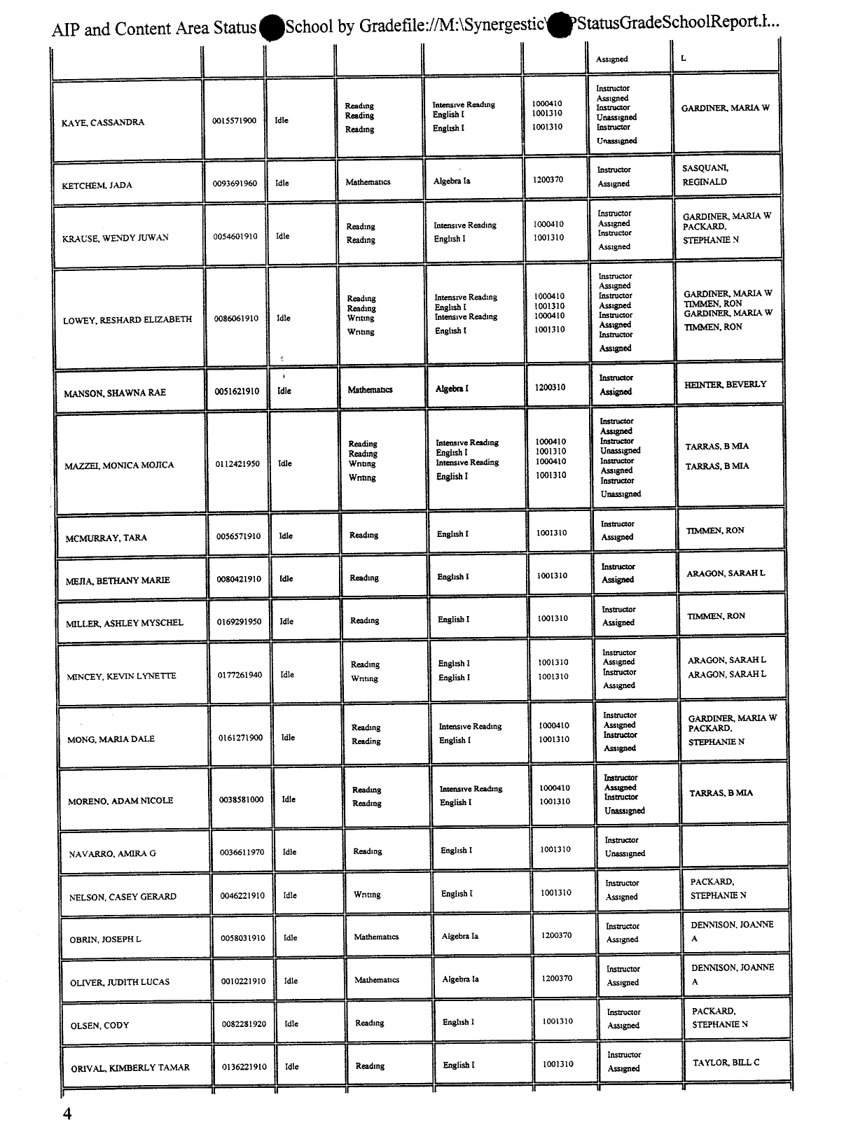

School Reports—Reports by schools are selected by a School Report screen (FIG. 15A) and may include AIP and Content Area Status by Grade (see sample of FIG. 15B). This report shows the individual students by school and grade that have an AIP, along with the development areas for each student. In addition, it provides a summary count by grade and school as to the number of AIPs and development areas by content area. This report also shows the individual students by school and grade that have an AIP, along with the development areas for each student. In addition, it provides a summary count by grade and school as to the number of development areas by content area and development area status.

AIP Status Report (see sample of FIG. 15C). This report shows the number of AIP students by AIP status and the number of development areas by development area status. This reports shows this information for the entire district, and then for the selected school(s).

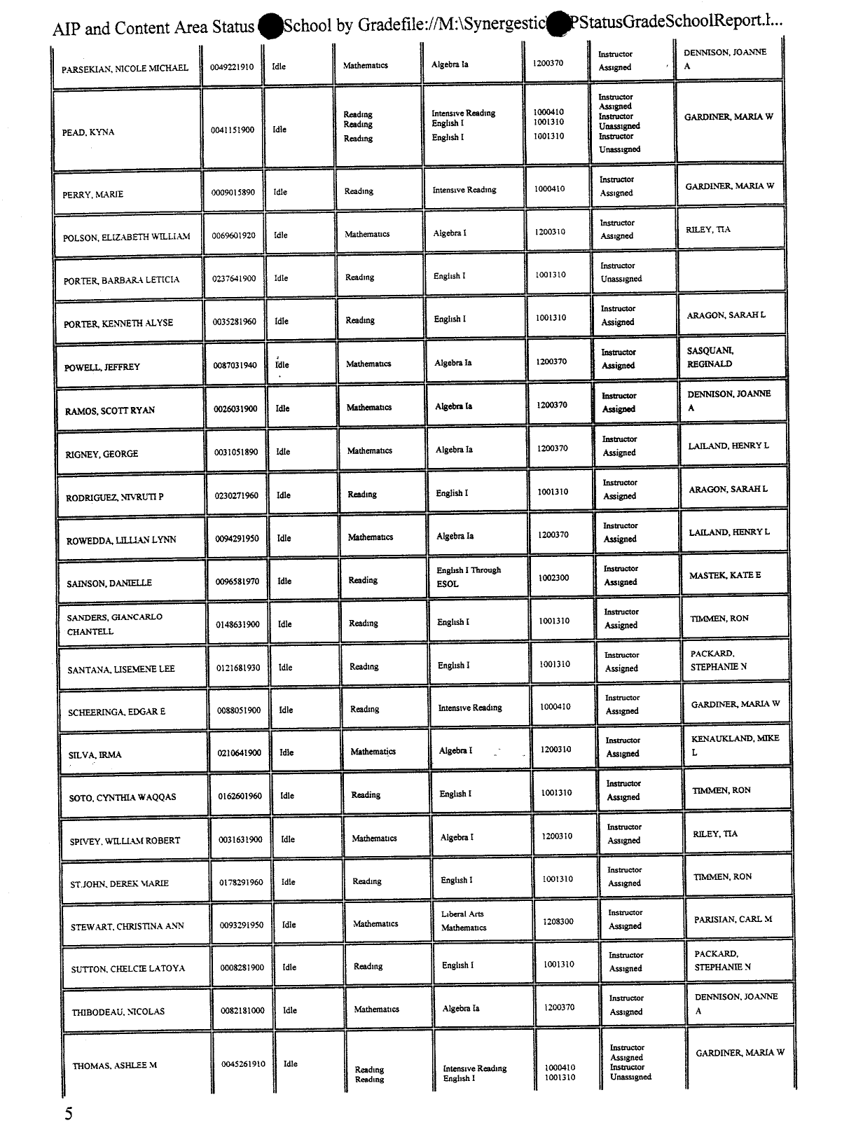

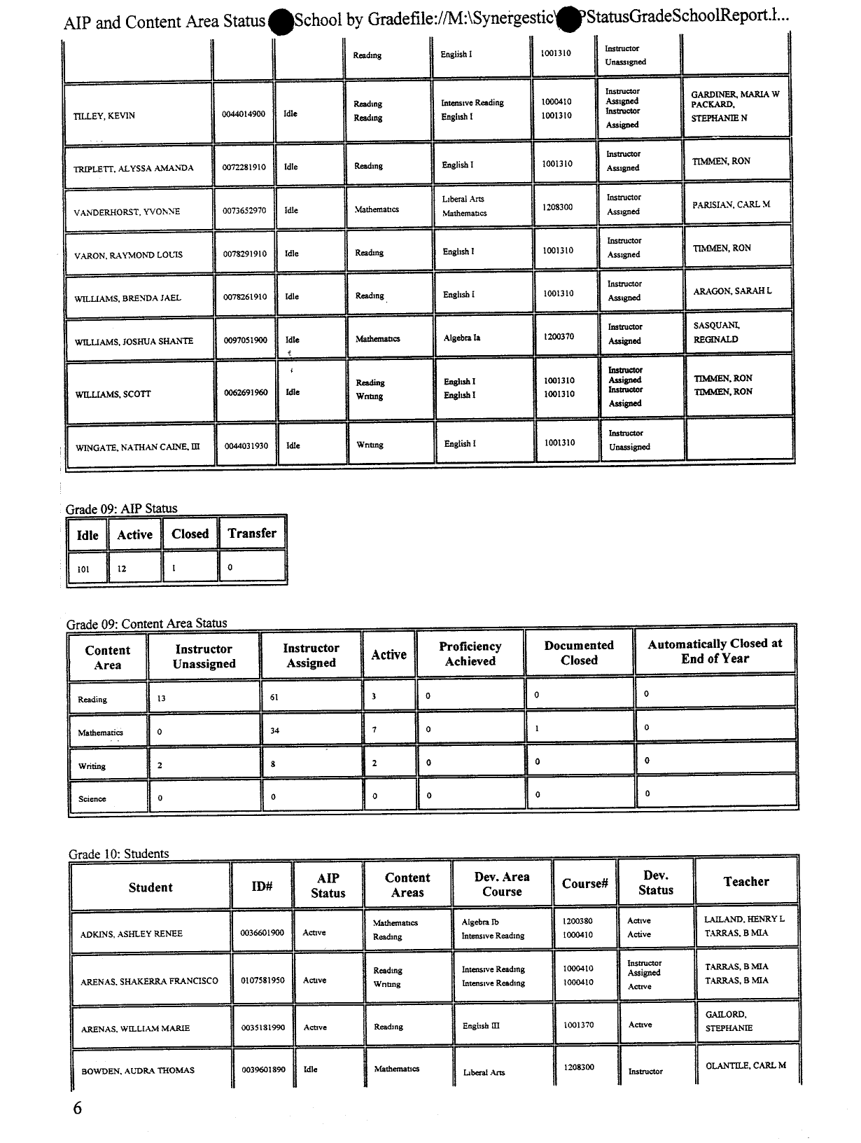

District Reports—Reports by Districts are selected by a District Report screen (FIG. 16A) and may include a District Percent Summary (see sample of FIG. 16B). This report shows the number of development areas and students by content area. This report show this information for the entire district, and then for each school. The numbers are reflected as absolute counts, as well as percentages of the district totals.

AIP Status Report (see sample of FIG. 16C). This report shows the number of AIP students by AIP status and the number of development areas by development area status. This reports shows this information for the entire district, and then all of the schools.

AIP Content Area Comparison Report (see sample of FIG. 16D). This report shows the number of AIP students by school and content area.

AIP Grade Comparison Report (see sample of FIG. 16E). This report shows the number of AIP students by school and grade for the selected content area.

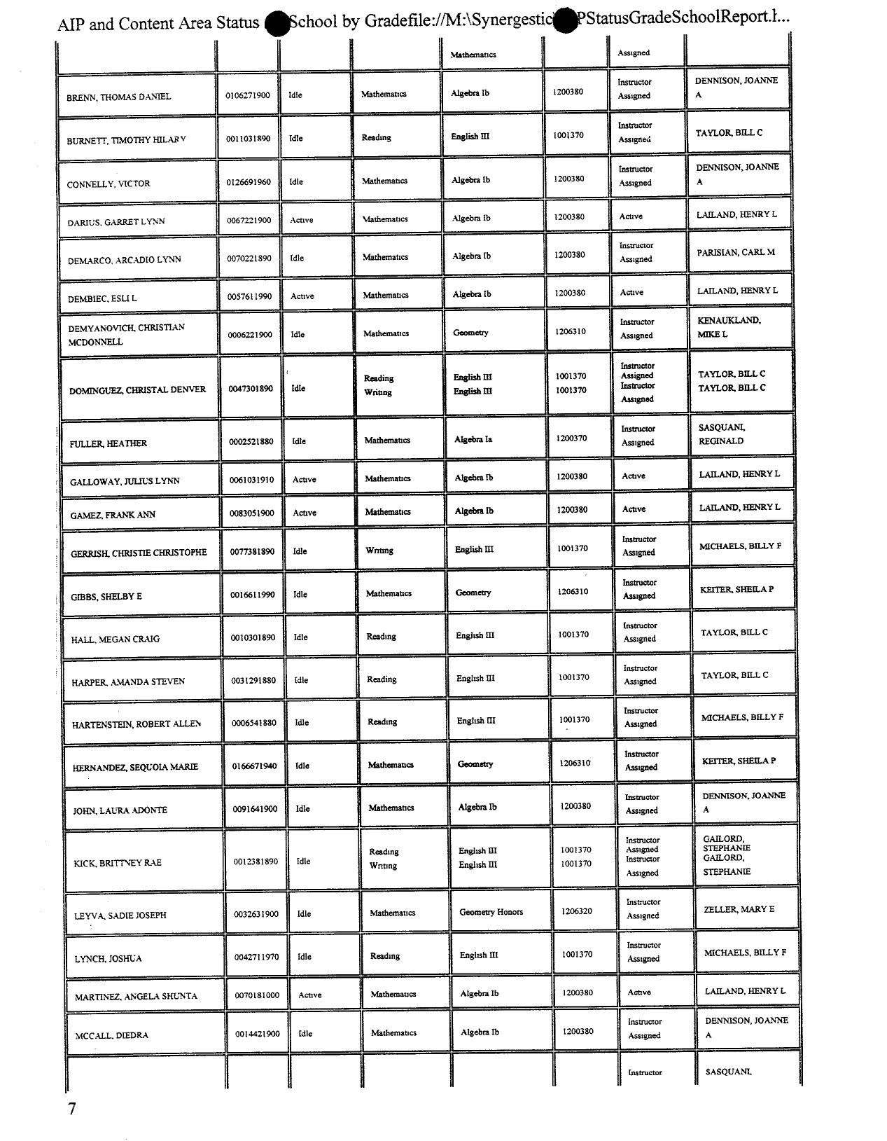

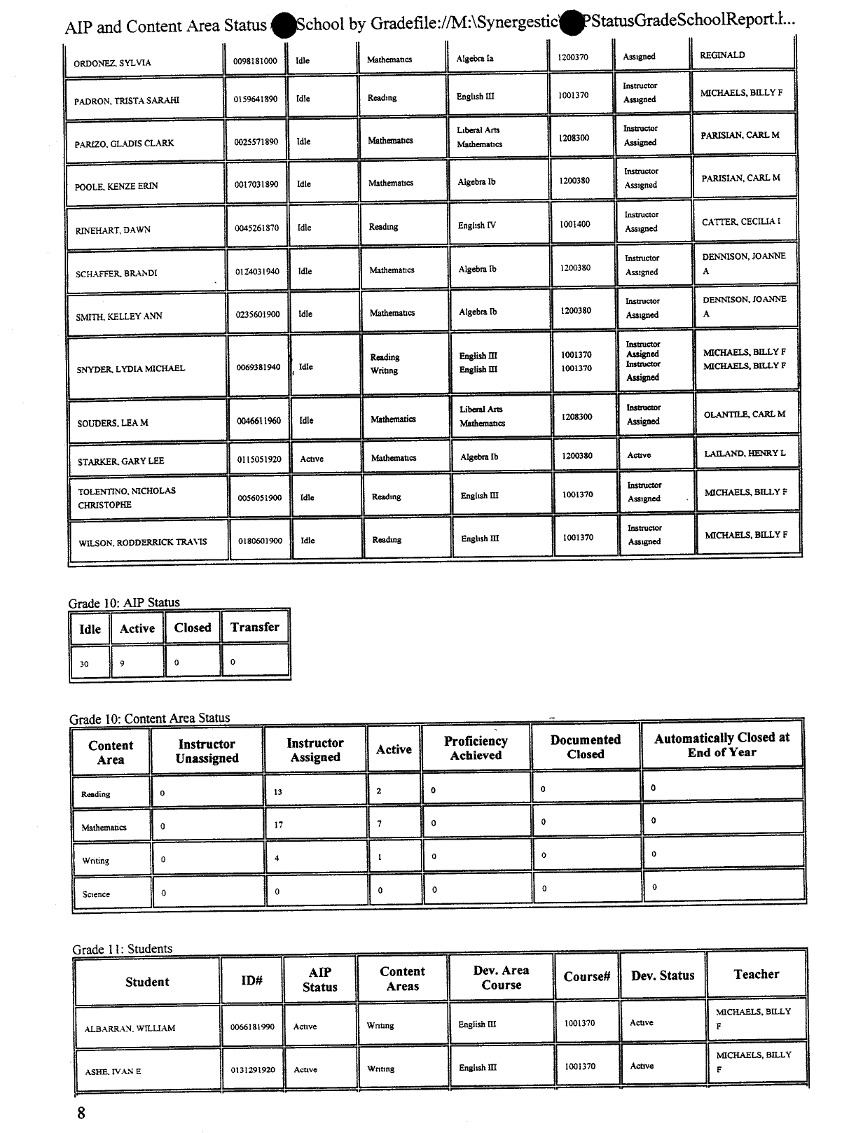

Configuration Reports—Reports based for configuration purposes may include: Progress Report Types (FIG. 17A). This report shows the configurable types of progress reports that the user can select.

Content Area Intervention Strategy (CAIS) (see sample of FIG. 17B). This report shows the configuration of the Intervention Strategies that can be selected by content area and grade level range.

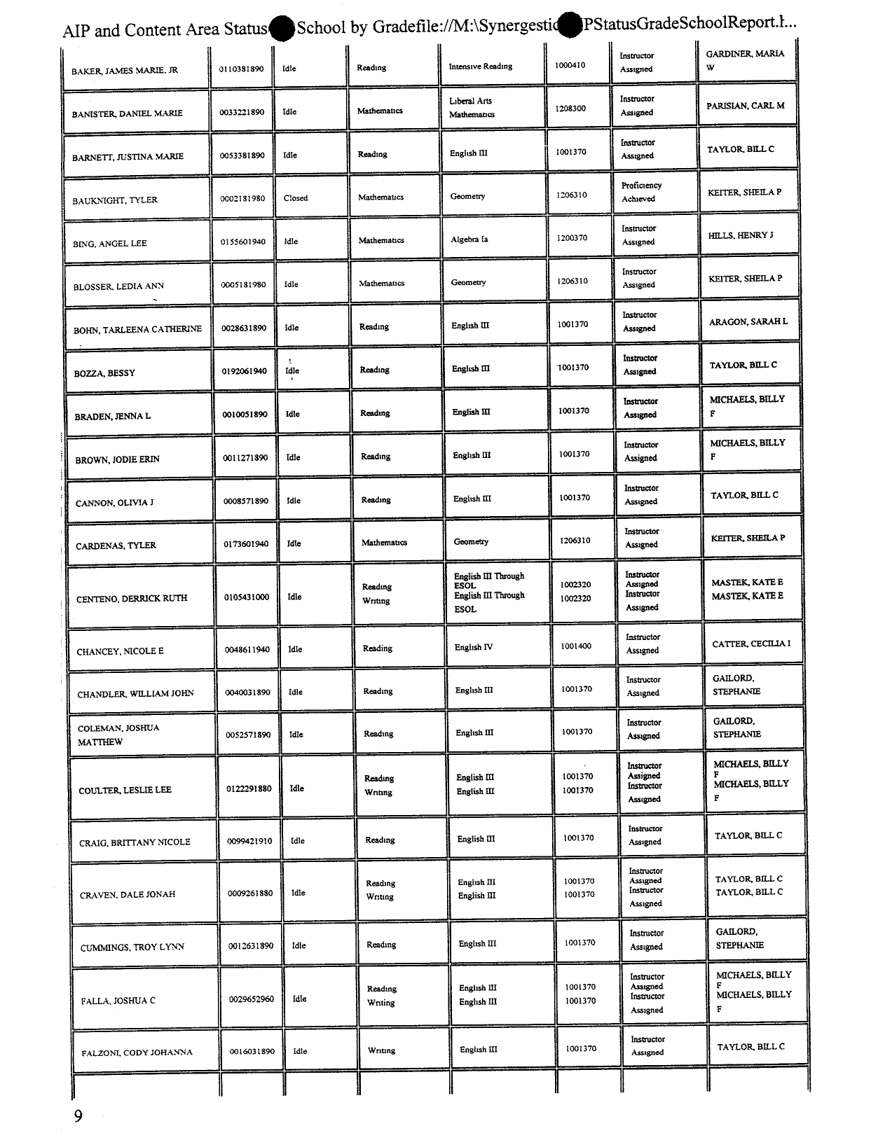

10. Maintenance Screens—Screens are provided for maintaining data for employees that have user access (FIG. 18A), District Administrators (FIG. 18B), School Administrations (FIG. 18C), Instructors (FIG. 18D), and Instructor Courses (FIG. 18E).

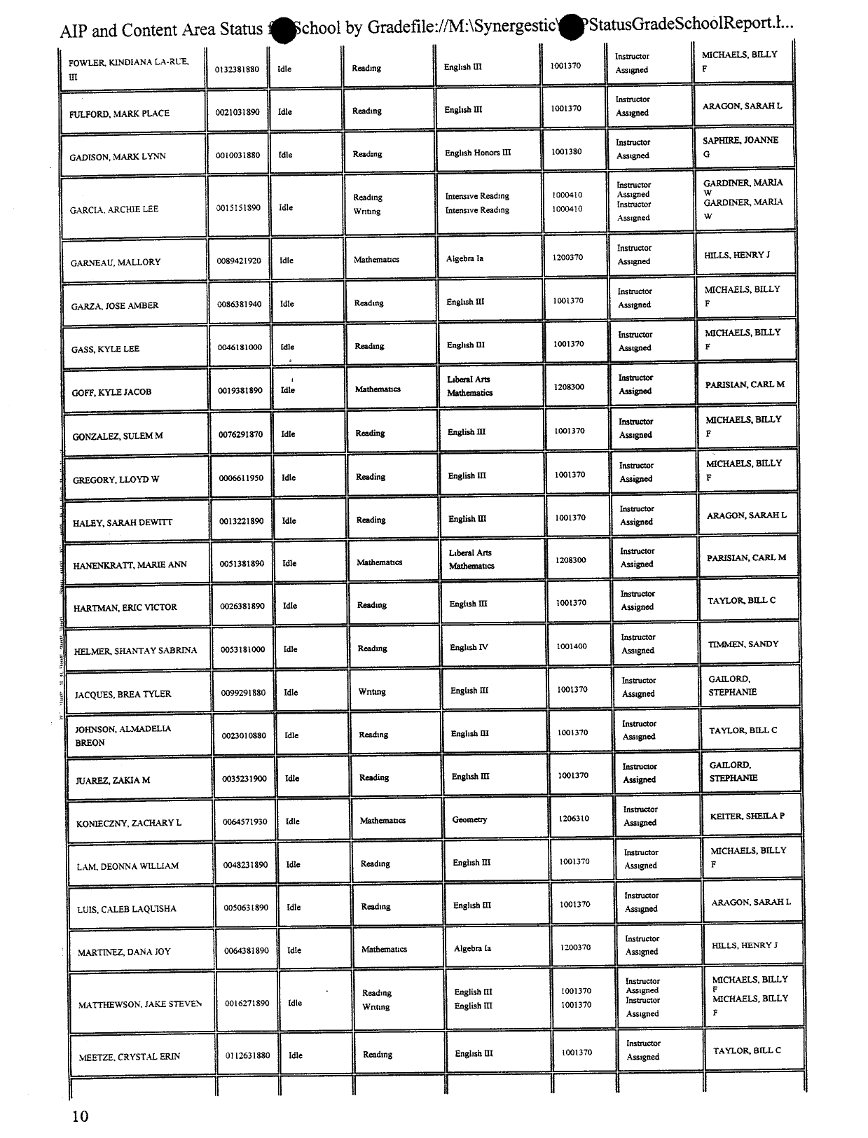

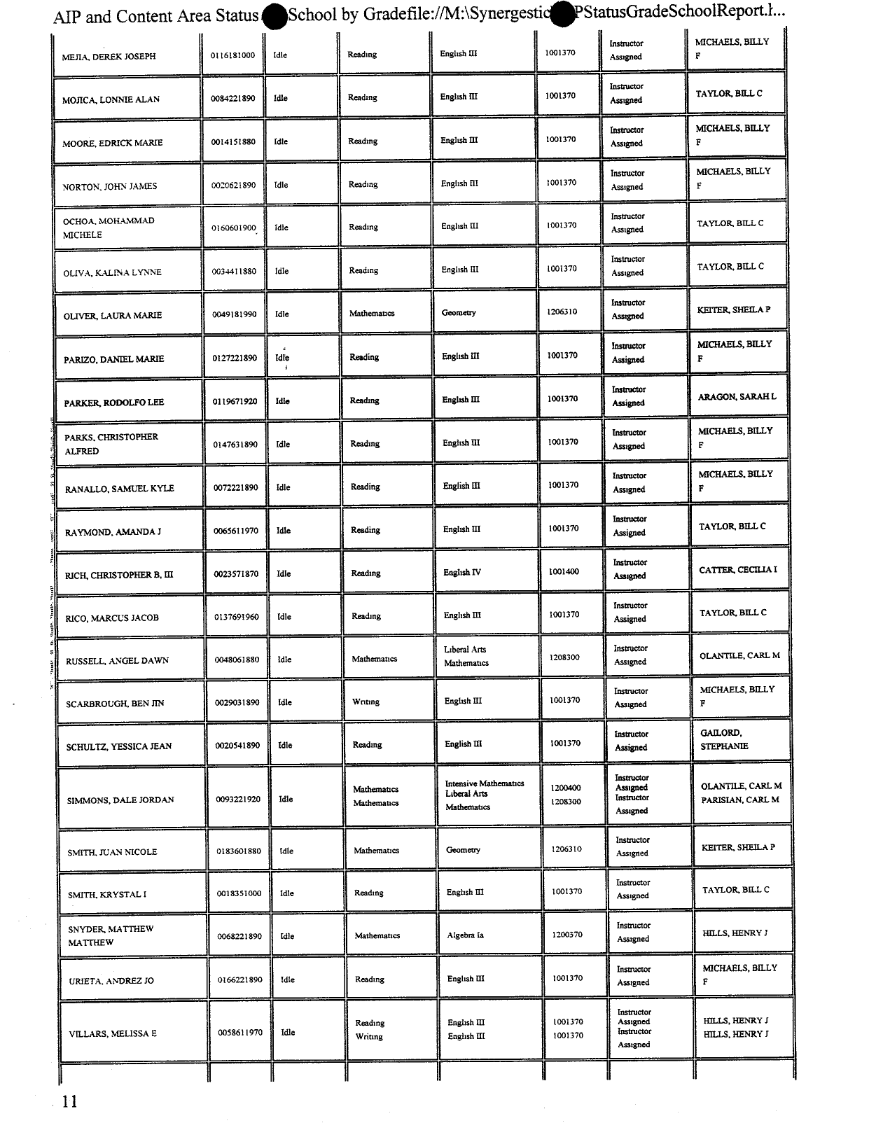

11. AIP Student Transfer—A screen (FIG. 19) allows a student to be withdrawn from one school and registered into another school.

### DETAILED BUSINESS PROCESS

The Academic Improvement Plan (AIP) is designed to satisfy state mandated programs, designed to help get students “back on track” in particular areas of study. The current paper forms for tracking AIP student participation are to be automated using electronic forms. The AIP program exists for students at both the Elementary and Secondary school levels. The legislation requires proof of remediation for each student in the program, which is done on an audit basis. The AIP process identifies students with areas of developmental need and designates intervention strategies to aid the student. AIP allows for ongoing evaluation of the participant's progress, while providing reporting and auditing capabilities to appropriate parties. Teachers have the flexibility to close a student's AIP at any time based on documented closure factors.

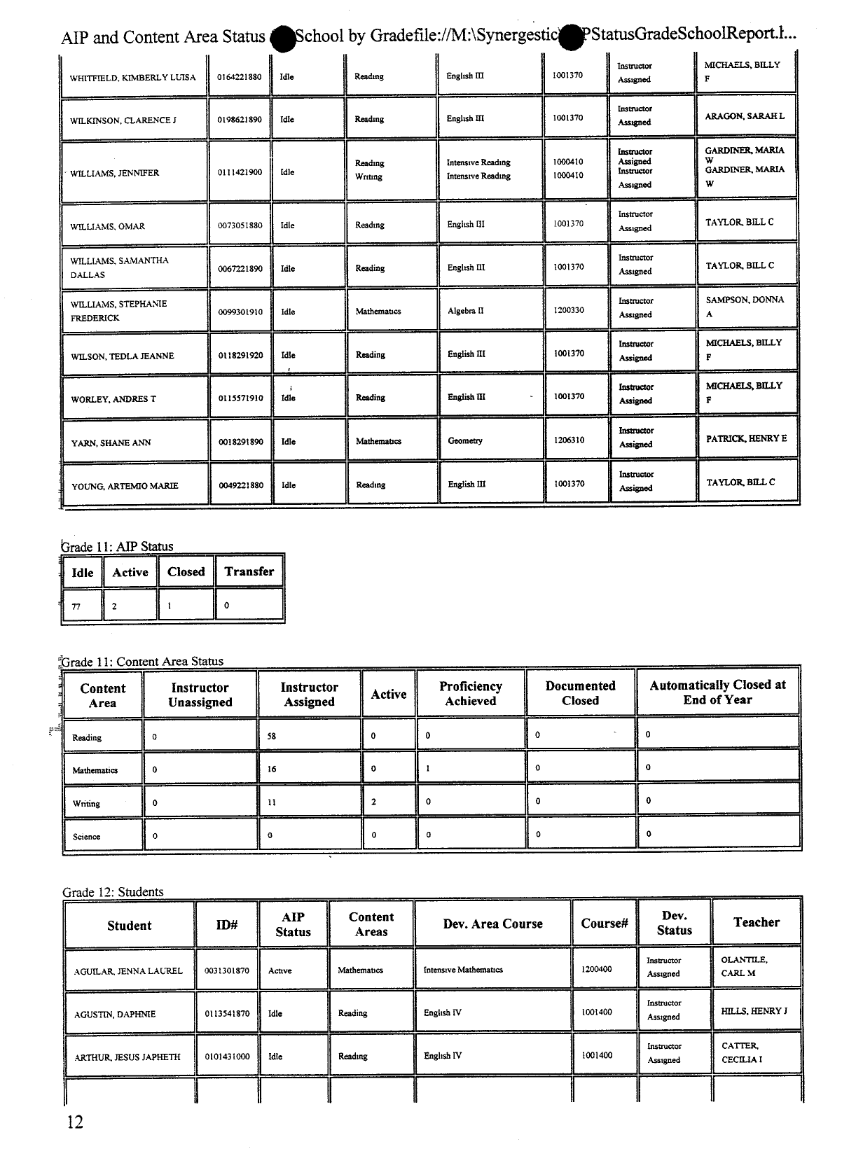

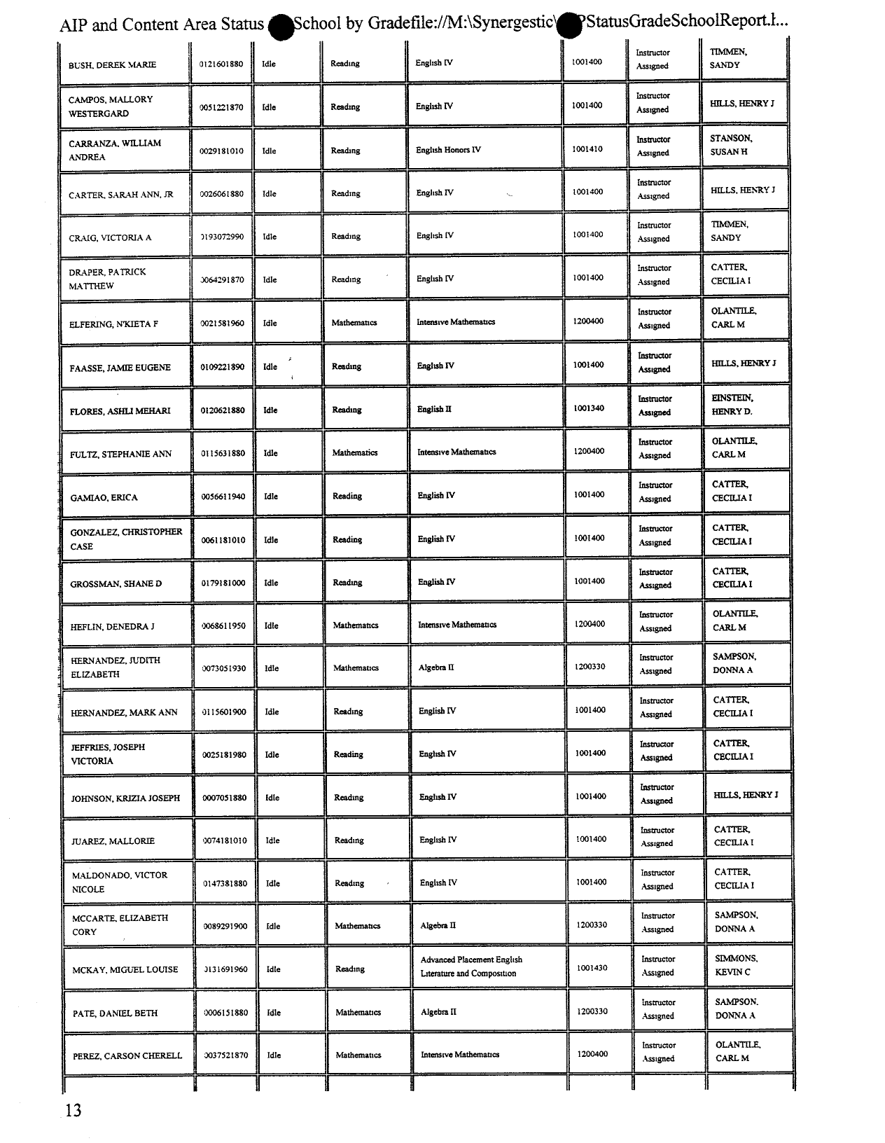

As reflected in FIG. 20, the business process of the invention is implemented in the following steps.

Batch Qualify Students—The primary mechanism for qualifying students is via an external batch process. By applying a number of factors and criteria, AIP students are identified from the Student System. The eligible students resulting from the selection process are the input to the proposed AIP system.

Qualifications occur via a number of mechanisms: FCAT, FCAT light, HST, grades, teacher identified

Qualification filtering based on factors—need for remediation

Factors fall into content areas of reading, writing, math, and in the future may include science, social studies, etc.

Qualification efforts occur in August and/or following current year testing.

Batch Create AIP—Receiving the qualified student information from the external batch qualify process, an AIP is created for each student with one or more areas of developmental need (Content area) identified. The creation of the AIP captures the qualifying data, eligibility requirements met and associated student data. The student's school administrators are notified of the AIP students in their school. If necessary, the principal can assign teachers to the student's AIP content areas. The teachers gain control of the AIP, meeting with guardians and scheduling diagnostic tests to determine appropriate intervention strategies.

Online Create AIP—As a secondary qualifying mechanism, a student's teacher, school admin or district admin may create an AIP for a student at any time. This user-initiated activity allows for online creation of an AIP area of developmental need for a student. The school administrators are informed of the creation of the AIP. The teacher schedules interactions with the guardians to determine the best intervention strategies for the AIP area of developmental need.

Diagnostic Testing—To help specify problem areas and determine appropriate intervention strategies, diagnostic testing is performed for the identified content area. The results are captured in the AIP.

Determine Plan—Based on interaction with student, guardian, counselors, and the input from the diagnostic testing, intervention strategies are identified and selected in the AIP by the teacher. The strategy and pertinent AIP information are sent to the guardian. Acceptance of the plan by involved parties (guardian, teacher, principal, counselors) is captured in the AIP.

Evaluate Progress—The teacher tracks the students progress and determines future course of action. The progress information is captured in the AIP. The teacher may close the AIP content area at any time based on teacher factors documented in the AIP, including but not limited to proficiency achieved. The teacher may also continue with strategy modifications, or discontinue AIP content area with documented alternative mechanisms.

Close AIP—The AIP content area (area of developmental need) is closed with accompanying completion disposition status. Recognition of closure is captured in the AIP. Auditing and Reporting—The AIP is a legislative mandated program requiring proof of remediation for each student. Various reports are created in-order to provide proof of remediation. In addition, AIP information may be extracted at any time and made available to qualified users.

### Analysis Object Model

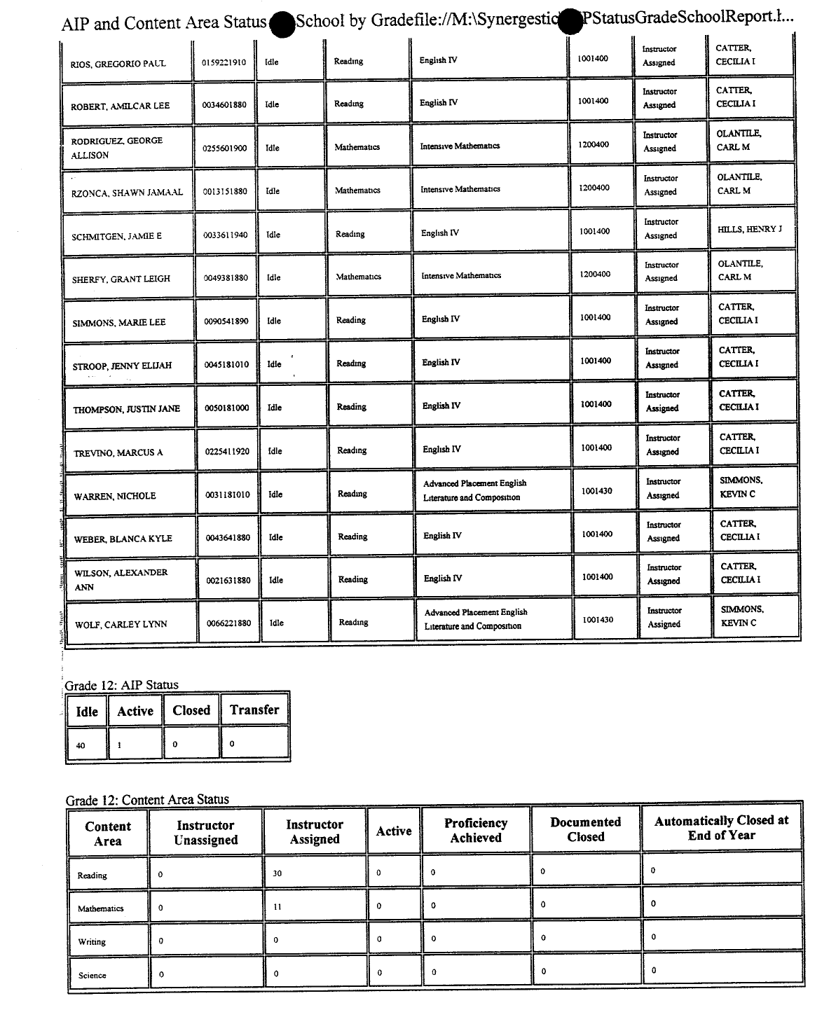

The object models for AIP Subject Area, Area of Developmental Need, Content Area Subject Area/Schools & Staff Subject Area, User & Permissions Subject Area, and Students & Guardians Subject Area are diagrammed in object-oriented methodology in FIGS. 21A-21D.

### Catalogs

For better clarity in understanding the subject areas of the object model, the following are detailed listings of the various catalogs employed within the computer program of the invention:

1. Actor Catalog

| | | | | Organizational |
|---|---|---|---|---|
| Actor | Description | Comment | Security | Title |
| Teacher | An employee of the | Each teacher has a | Each teacher | Teacher |
| | district who is | school and teacher | would only have | |
| | responsible for | number. Only | access to their | |
| | developing and | teachers | students' data. | |
| | implementing the | responsible for | | |
| | AIP for identified | math, reading, and | | |
| | students. | writing, will be | | |
| | | using the system. | | |
| Principal | Instructional leader | Some principals | Each principal | Principal |
| | responsible for all | delegate | would only have | |
| | functions at a | responsibilities for | access to data on | |
| | school. Supervises | groups of students | students at their | |
| | all school staff, | or student issues, to | school. Summer | |
| | | an assistant | school principals | |
| | | principal, | would only have | |
| | | | access to | |
| | | | summer school | |
| | | | students at their | |
| | | | school. | |
| Guidance Counselor | Responsible for | Must approve AIPs | Would only have | Guidance |
| | working with | that specify a Level | access to student | Counselor |
| | students and | I course as a | data at their | |
| | parents for | strategy. | school | |
| | counseling, | | | |
| | scheduling, and | | | |
| | meeting academic | | | |
| | goals. | | | |
| Academic | District level staff | All are in the 3000 | Would have | Examples: Asst |
| | member in the | business unit | access to all AIP | Supt for |
| | Academic Division | | data and reports | Academics, Exec |
| | who has a need to | | | Dir of Ed |
| | review AIP data. | | | programs, |
| | | | | Specialist for |
| | | | | Measurement and |
| | | | | Research |
| IT Operator | District level staff | Provides | Needs highest | Systems Analyst |
| | in Information | maintenance and | level of access | Network Analyst |
| | Services who | support functions | | |
| | assists in managing | | | |
| | the | | | |
| | hardware/software | | | |
| | system and is | | | |
| | responsible for | | | |
| | loading identified | | | |
| | student data | | | |
| Assistant Principal | School staff | May be responsible | Same access | Assistant Principal |
| | directly assisting | for a group of | level as a | |
| | the principal whose | students, or for a | principal | |
| | duties may vary at | specific function at | | |
| | the direction of the | the school. | | |
| | principal | | | |
| AIP Admin | Academic Division | Tracks legislative | Would have | TBA |
| | staff that | changes and | access to all AIP | |
| | coordinates with | changes needed by | data and reports | |
| | Info Services for | district staff. Also | | |
| | file transfers and | loads summer | | |
| | changes in the | school data | | |
| | setup. | | | |
| School Registrar | School staff | Updating the AIP | Access to | Registrar |
| | designated by the | system for new | student data at | |
| | principal, generally | students and | their school only | |
| | the Registrar | transfers | | |

2. Subject Area Catalog

| Subject Area | Description | Actors |
|---|---|---|
| Staff & Schools | The Staff & Schools subject area covers the population and | IT Operator |
| | maintenance of the school and staff information, including | Principal |
| | contact information. These activities include loading of school | Assistant |
| | year, schools, principal, and teachers from the external student | Principal |
| | system. The maintenance of staff such as principals, teachers, | School Registrar |
| | and other staff also occur in this subject area. | Teacher |
| | | Academic |
| Students & | The Students & Guardians subject area covers the population | IT Operator |
| Guardians | and maintenance of the students and guardians including | Teacher |
| | interfacing with external student system to aid in information | School Registrar |
| | population. Maintenance of students and guardian information | |
| | by teacher is included in this area. | |
| Content Area | The Content Area subject area covers maintenance of content, | Academic |
| | intervention, and eligibility factors. | |
| AIP | The AIP subject area covers processes associated with | Teacher |
| | generation and maintenance of the AIP. (The specifics of the | IT Operator |
| | content area for the student are covered in the Area of | |
| | Developmental Need.) Activities in the AIP subject area | |
| | include creating AIP with student eligibility information; both | |
| | from the external batch qualifying process or the online create | |
| | AIP process. Notification of principals, teachers, and the | |
| | parent invitations are captured in this subject area. The | |
| | interfacing with external systems is covered in this subject | |
| | area. | |
| Area of | The Area of Developmental Need subject area covers | Teacher |
| Developmental | processes associated with generation and maintenance of the | |
| Need | Area of Developmental Need specific to the student and this | |
| | content area and plan development and execution. These | |
| | activities include the capture of eligibility reasons, diagnostic | |
| | test results, intervention strategies, grades, and progress | |
| | information. Recording of the completion disposition is also | |
| | an activity of this subject area. | |
| Auditing & | The Auditing & Reporting subject area covers the presentation | Teacher |
| Reporting | of AIP information with a variety of criteria such as AIP by | Principal |
| | content area by school year by school or Popular intervention | Counselor |
| | strategy by number of successful level of proficiency achieved. | Academic |
| | | IT Operator |
| | | School Registrar |
| User & Permissions | The User & Permissions subject area covers the maintenance | All |
| | of users accessibility to AIP system. | |

3. High Level Requirements Catalog

Subject Area: School & Staff

| | | Supporting Use | |
|---|---|---|---|
| Number | Requirement | Case | Comments |
| | Load School Control | Load School | |
| | School Year - load current school year from student | Controls | |
| | system | Load School Year | |
| | Load Schools | Load Schools | |
| | Load Principals | Load Principals | |
| | Allow ability to maintain principal info | Maintain Principal | |
| | Principal | | |
| | Allow ability to maintain summer school principal info | Assign Summer | |
| | | School Principal | |
| | Load Only Teachers teaching content area for school from | Load Teacher & | |
| | student system | Content Area | |
| | Allow ability to maintain teacher info | Maintain Teacher | |

Subject Area: Students & Guardians

| Number | Requirement | Supporting Use Case | Comments |
|---|---|---|---|
| | Load the students from the student system | Load Student Biographic | |
| | teacher for content area | | |
| | Online Student update from student | Access Student System | Need load or maintain? |
| | system | | |
| | Load student guardian from student | Access Student System | Need load or maintain? |
| | system | | |
| | Maintain Student information | Maintain Student | |
| | Maintain guardian information | Maintain Student | |

Subject Area: AIP

| | | Supporting Use | |
|---|---|---|---|
| Number | Requirement | Case | Comments |
| | Create AIP for each student qualified for AIP | Load Student | |
| | | Eligibility | |
| | | Batch Create | |
| | | AIP for eligible | |
| | | Student | |
| | Teacher creates (on-line) AIP. Student information ideally | Maintain AIP | |
| | automatically populated for student | | |
| | Notify Teacher/Principal Notify Principal | | |
| | | of AIP Student | |
| | | Notify Teacher | |
| | | of AIP Student | |
| | Create Parent invite letter | Create Parent | |
| | | Invite Letter | |
| | Record diagnostic test results | Handled in Area | |
| | | of | |
| | | Developmental | |
| | | Need | |
| | Progress reporting Per area of developmental need (Content | | Handled in Area |
| | Area) | | of |
| | | | Developmental |
| | | | Need |
| | Define intervention strategy | | Content Area: |
| | | | Maintain |
| | | | Intervention |
| | | | strategies |
| | Reason for AIP completion | | |
| | End of school year - not determined | | |
| | Teacher determined | | |
| | Proficiency Level Achieved per content Area | | |
| | Lack of attendance to execute strategies | | |
| | Proficiency determines no strategy is necessary | | |
| | Update student grades per quarter | | |
| | Record free form notes, comments by teacher | | |
| | Record “Teacher Factor” reasons with comment. | | |
| | Record parent notification | | |
| | Print AIP form (web page) | | |
| | Record Principal (and guidance counselor acceptance when | | |
| | level 1 remedial class is used as a strategy at High school level | | |
| | with date, name with ability to undo | | |
| | Create parent letter describing intervention strategy | | |
| | Record AIP status (reasons for completion) | | |
| | Send AIP notification back to Student System. | | |
| | Teacher has access to last years AIP for present AIP student | | |
| | on-line | | |
| | District has access to all years of AIP records for auditing | | |
| | purposes. | | |
| | Summer School Issues | | |
| | end of 3^{rd} quarter to start of summer school | | |
| | the summer school intervention strategy is identified teacher | | |
| | summer school identified | | |
| | summer school rinci al assigned to school | | |

Subject Area: Content Area

| | | Supporting Use | |
|---|---|---|---|
| Number | Requirement | Case | Comments |
| | Maintain Content Area | Maintain Content | |
| | | Area | |
| | Maintain Intervention strategies | Maintain | |
| | | Intervention | |
| | | strategy | |
| | Load Eligibility Factor from “AIP Evaluator” | | Assign Eligibility |
| | system | | factor to Content |
| | | | Area?? |
| | Maintain Eligibility Factor | Maintain | |
| | | Eligibility Factor | |
| | Report Intervention strategy by frequency of use | | Auditing and |
| | | | reporting? |
| | Intervention strategies by number of successful level | | Auditing and |
| | of proficiency achieved | | Reporting? |
| | Students by Completion | | Auditing and |
| | | | Reporting? |

Subject Area: Area of Developmental Need

| Number | Requirement | Supporting Use Case | Comments |
|---|---|---|---|
| | Maintain Area of Development Need | | |
| | Maintain Diagnostic Result | | |
| | Maintain Selected Intervention Strategies | | |
| | Maintain Progress Review | | |
| | Maintain Eligibility Reason | | |
| | Maintain Student Grades | | |
| | Record Completion Disposition | | |

Subject Area: Auditing/Reporting

| | | | |
|---|---|---|---|
| | | Supporting Use | |
| Number | Requirement | Case | Comment |

AIPs through time for student
All AIP's by school Year/School/Teacher
AIP's for grade level for school year and/or school
AIP's by Content Area by school year/school
AIP's by Eligibility Factor + score by school
year/school/teacher
AIP's by intervention strategy

Subject Area: User & Permission

| | | | |
|---|---|---|---|
| Number | Requirement | Supporting Use Case | Comment |

Authenticate user with system via username and password

4. Use Case Catalog

Subject Area: Staff & Schools

| Use Case | Description | Actors | Priority |
|---|---|---|---|
| Load School Controls | Used to receives file of school control information which | IT Operator | 1 |
| | includes schools, school year, and principals designating either | | |
| | new load or update load. | | |
| Load School Year | Loads dates for the school year | IT Operator | 1 |
| Load Schools | Loads the schools for the school year. Each load file will contain | IT Operator | 1 |
| | all schools for the year. | | |
| Load Principals | Loads list of principals for all schools | IT Operator | 1 |
| Load Teacher & | Loads names of teachers at elementary and secondary that have | IT Operator | 1 |
| Content Area | responsibility for reading, writing, and/or math instruction. | | |
| Maintain Staff- | Abstract maintenance use case. Extended with instructor, school | | 2 |
| Abstract | admin, and district admin | | |
| Maintain Instructor | Used to create/update Instructor information | Principal | 2 |
| | | Assistant | |
| | | Principal | |
| | | School | |
| | | Registrar | |
| | | Guidance | |
| | | Counselor | |
| | | IT Operator | |
| | | AIP Admin | |
| Maintain School Admin | Used to create/update information for Principal, Assistant | AIP Admin | 2 |
| | Principal, School Registrar, and Guidance Counselor | Principal | |
| Maintain District Admin | Used to create/update information for AIP Admin and IT | AIP Admin | 2 |
| | Operator | IT Operator | |
| Assign Summer School | Defines school as a summer school and assigns | AIP Admin | 3 |
| Principal | summer school principal. | | |

Subject Area: Students & Guardians

| Use Case | Description | Actors | Priority |
|---|---|---|---|
| Load Student | Loads qualified AIP student name, ID #, grade level, with guardian | IT Operator | 1 |
| Biographic | name, address, phone number | | |
| Maintain Student | Create and Update Student name, ID #, grade level | Teacher | 1 |
| | Used to update existing student data, or to add a new student AIP | School | |
| | | Registrar | |
| Access Student | Access student information from student system to create a new | Teacher | 3 |
| System | student AIP | School | |
| | | Registrar | |

Subject Area: Content Area

| Use Case | Description | Actors | Priority |
|---|---|---|---|
| Maintain Content Area | Used to create, update and query content areas. | AIP Admin | 3 |
| Maintain Intervention | Used to create, update and query Intervention Strategy data | AIP Admin | 3 |
| strategy | | | |
| Maintain Eligibility Factor | Used to create and/or update eligibility factors | AIP Admin | 3 |
| Assign Intervention strategy | Used to create or update intervention strategies assigned to | AIP Admin | 3 |
| to Content Area | each content area | | |
| Assign Eligibility factor to | Used to add, delete, or edit eligibility factors assigned to | AIP Admin | 3 |
| Content Area | specific content areas | | |

Subject Area: AIP

| AIP | Description | Actors | Priority |
|---|---|---|---|
| Load Student | Used to create, update and query content areas. | IT Operator | 1 |
| Eligibility | | | |
| Batch Create AIP for | Used to create the file of eligible students to populate the AIP | IT Operator | 1 |
| eligible Student | system | | |
| Maintain AIP for | Used to create a new student AIP, and/or to enter/update diagnostic | Teacher | 1 |
| student | data, intervention strategies, and progress data. When actor is | Principal | |
| | Principal, a list of all AIP students at a school that will be provided. | | |
| | Teachers may add students to the list during the year. | | |
| | When actor is Instructor, a list of all AIP students at a school, by | | |
| | teacher, will be provided. | | |
| Create Parent Invite | Teacher selects an option to generate a form letter inviting parents | Teacher | 3 |
| Letter | of AIP students to initial conference | | |
| Create Parent | Teacher selects an option to generate a form letter informing parents | Teacher | 1 |
| Intervention Strategy | of AIP students about the intervention strategies by content area | Guidance | |
| Letter | selected by the teacher for their student | Counselor | |
| Print AIP Form in | Teacher selects an option to print the desired AIP form from a Web | Teacher | 1 |
| Web Page | browser menu. | | |
| Create Student | Used to edit the student system when teachers create a new student | IT Operator | 3 |
| System Feed of | AIP after the initial yearly batch load from the student system. | | |
| Teacher created AIP | | | |
| View historical AIP | Staff selects an option to view a specific student AIP from a Web | All actors | 2 |
| for Student | browser menu. | | |
| Send student to | Teacher sends student to summer school - identifying summer | Teacher | 3 |
| summer school | school for AIP | | |

Subject Area: Area of Developmental Need

| Use Case | Description | Actors | Priority |
|---|---|---|---|
| Maintain Area of | Used to create, update and query Area of Developmental Need after | Teacher | 1 |
| Developmental Need | initial batch load | | |
| Maintain Diagnostic | Used to create and update Diagnostic Results for each content Area of | Teacher | 1 |
| Result | Need | | |
| Maintain Selected | Used to create, update and query Intervention Strategies for each Area | Teacher | 1 |
| Intervention | of Need | | |
| Strategies | | | |
| Maintain Progress | Used to update the AIP concerning student progress | Teacher | 1 |
| Report | | | |
| Maintain Eligibility | Used to add an Area of Need in the AIP based on new eligibility data | Teacher | 1 |
| Reason | | | |
| Maintain Student | Used to update student grade data in the AIP throughout the year | Teacher | 1 |
| Grades | | | |
| Record Completion | Used to indicate the status of the AIP (proficiency achieved, | Teacher | 1 |
| Disposition | remediation continues, or teacher override) | | |
| Manually assign | Manually assign summer school instructor for Area of Developmental | Principal | 3 |
| summer school | Need | Teacher | |
| Instructor | | | |
| Automatically assign | Automatically assign summer school instructor for Area of | Principal | 3 |
| summer school | Developmental Need | AIP Admin | |
| Instructor | | School | |
| | | Registrar | |

Subject Area: Auditing & Reporting

| Use Case | Description | Actors | Priority |
|---|---|---|---|
| AIP details through time | For a particular student Review their AIP Detail for a range of time | Teacher | 3 |
| for student | including access to AIP data for their entire academic history in the | Principal | |
| | district. When students leave the district for whatever reason, their | Counselor | |
| | records should be archived for later access as needed. | Academic | |
| | | IT Operator | |
| | | School | |
| | | Registrar | |
| All AIP students by | Provide a count and a list of students (name and number) that have | Principal | 1 |
| school | AIPs, by Year/School/Teacher. | Counselor | |
| Year/School/Teacher | | Academic | |
| | | IT Operator | |
| | | School | |
| | | Registrar | |
| All AIP students for grade | Provide a count and a list of students (name and number) that have | Principal | 3 |
| level for school year | AIPs, by Year/School/Grade Level. | Counselor | |
| and/or school | | Academic | |
| | | IT Operator | |
| | | School | |
| | | Registrar | |
| All AIP students by | Provide a count and a list of students (name and number) that have | Principal | 2 |
| Content Area by school | AIPs, by Year/School/Content Area. | Counselor | |
| year/school | | Academic | |
| | | IT Operator | |
| | | School | |
| | | Registrar | |
| All AIP students by | Provide a count and a list of students (name and number) that have | Principal | 3 |
| Eligibility Factor + score | AIPs, by Year/School/Eligibility Factor. | Counselor | |
| by school | | Academic | |
| year/school/teacher | | IT Operator | |
| | | School | |
| | | Registrar | |
| All AIP students by | Provide a count and a list of students (name and number) that have | Principal | 3 |
| school year/school content | AIPs, by Year/School/Content Area/Intervention Strategy. | Counselor | |
| area/intervention strategy | | Academic | |
| | | IT Operator | |
| | | School | |
| | | Registrar | |
| Content Area/Intervention | Provide a count and a list of students (name and number) that have | Teacher | 3 |
| strategies by number of | achieved a successful level of proficiency, by Content | Principal | |
| successful level of | Area/Intervention strategies. | Counselor | |
| proficiency achieved | | Academic | |
| | | IT Operator | |
| | | School | |
| | | Registrar | |
| Students by Completion | Provide a count and a list of students (name and number) by | Principal | 2 |
| status/School year | Year/School/Completion Status | Counselor | |
| | | Academic | |
| | | IT Operator | |
| | | School | |
| | | Registrar | |

Subject Area: User & Permissions

| Use Case | Description | Actors | Priority |
|---|---|---|---|
| Maintain System | Abstract use case to create and update system user name and password | <ALL> | 2 |
| User | | | |
| Authenticate User | Used to authenticate user to system through username and password validation | <ALL> | 1 |
| | -dependent on time of year and summer school | | |
| Change Password | User has ability to change their own password. If the user is the AIP Admin, | <ALL> | 2 |
| | then the username/password may be defined. | | |

More detailed information regarding several of the above Use Cases is set forth as follows:

4(a). Use Case: AIP Content Area District Report

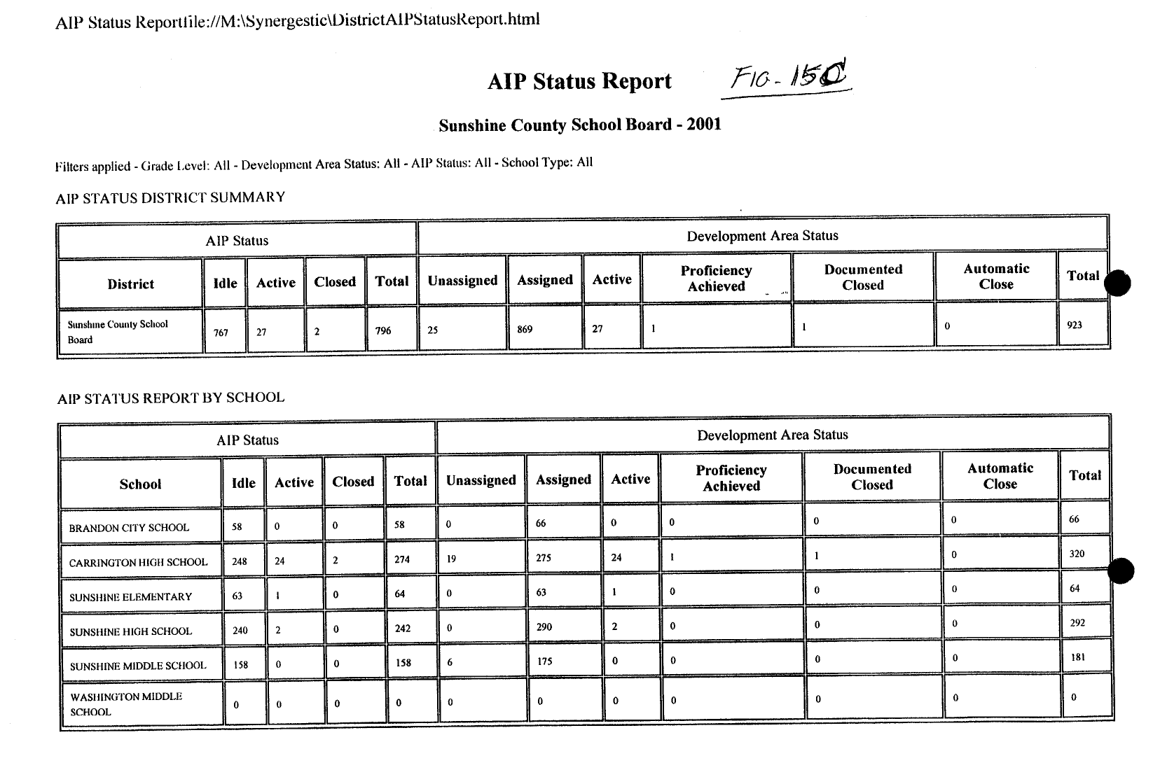

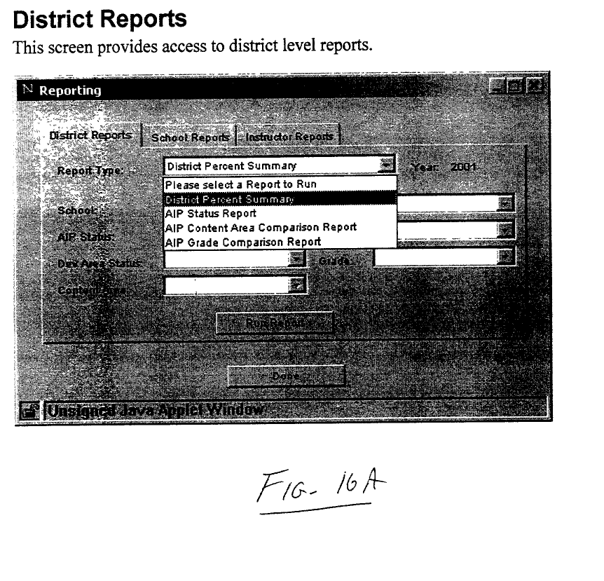

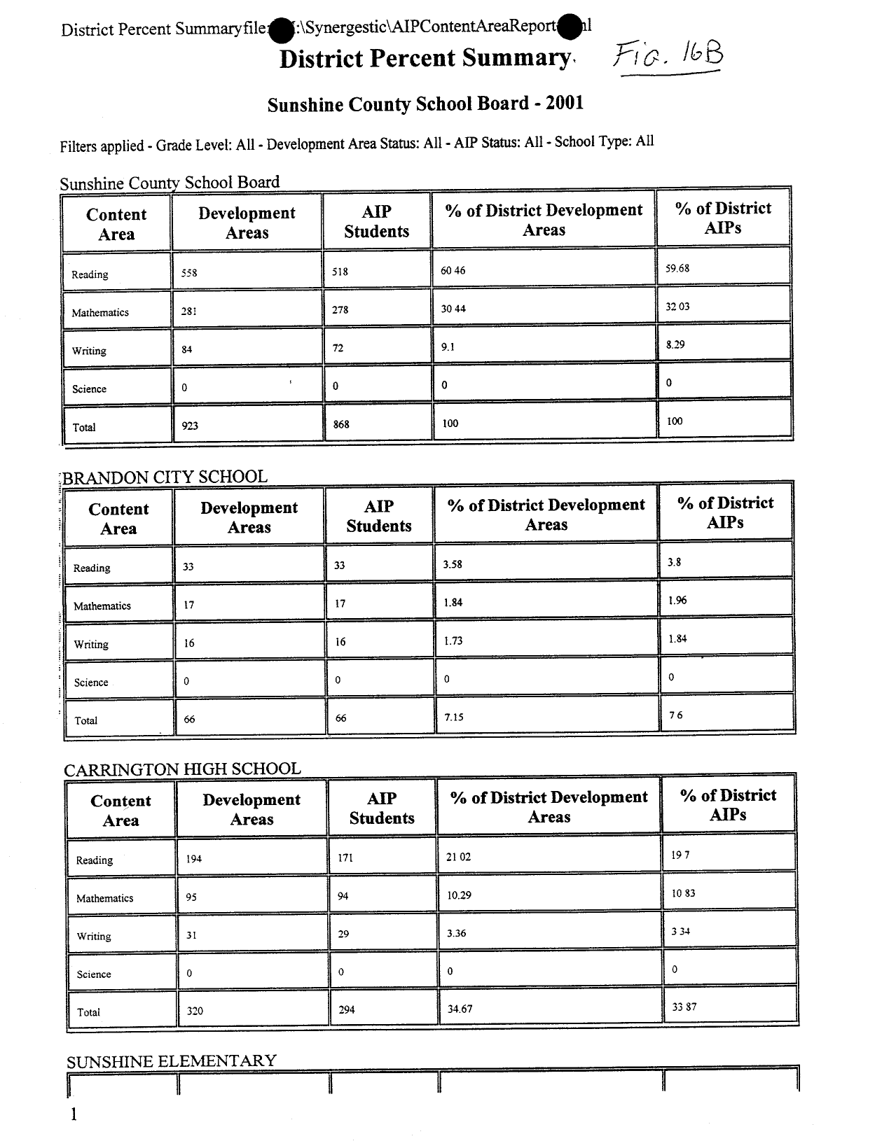

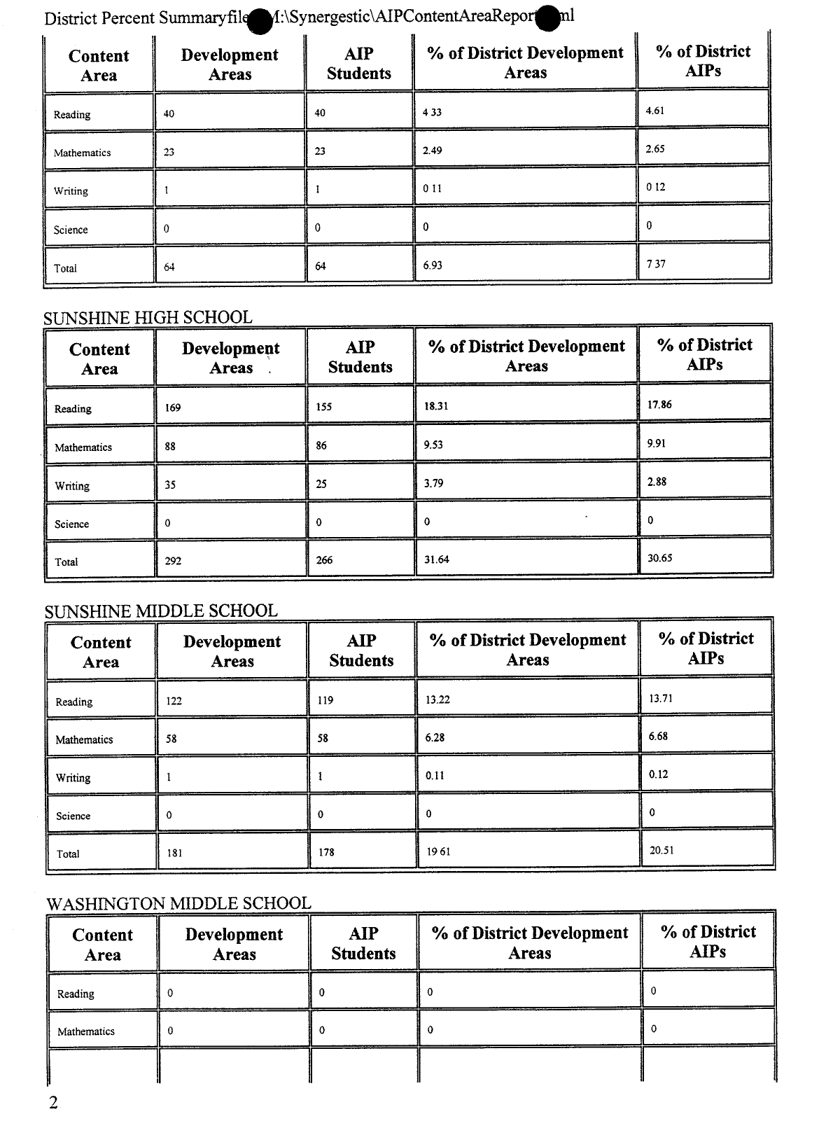

This use case describes the “AIP Content Area District Report” Use Case, which allows the user to choose from report options, and display the results of the report in a Web Browser. The user may then print the Report from within the Web Browser. See FIG. 22 and screen of FIG. 23.

Actors include Principal, Counselor, Academic, IT Operator and School Registrar.

Choosing Report Options include:

The user may make a selection from each pick-list from the “Report Maintenance” screen to provide report-filtering criteria.

Every field modified by the user will narrow the report parameters further.

To view the report in a web browser, the user presses the Run Report button.

If the user pulls down from the FILE menu to PRINT, the report will be printed on a printer.

When the user closes the Web Browser, the user is returned to the “Reporting Maintenance” screen.

If the user selects the Done button, the user will be returned to the previous screen.

Field Mapping includes:

| Field Name | Create | Update | Default Value | Validation Rule | Attribute in Model |
|---|---|---|---|---|---|
| Reporting Maintenance | | | | | |
| Report Filters: | | | | | |
| Select a School: | No | No | (ALL Schools) | In Pick List | School:Name |
| | | | | Select all or one | |
| Select a Teacher: | No | No | (ALL Teachers) | In Pick List | Staff:lastname |
| | | | | Select all or one | Staff:firstname |
| Select a Grade Level: | No | No | (ALL Grades) | In Pick List | Grade:description |
| | | | | Select all or one | |
| Select a Content Area: | No | No | (ALL Content | In Pick List | ContentArea:description |
| | | | Areas) | Select all or one | |
| Select an Area Status | No | No | (Select from | In Pick List | DevelopmentAreaStatus: |
| | | | List) | Select all or one | description |
| Select a School Type: | No | No | (ALL School | In Pick List | |
| | | | Types) | Select all or one | |
| AIP Content Area | | | | | |
| District Report: | | | | | |
| Grade: | No | No | | | Grade:description |
| Content Areas: | No | No | | | ContentArea:description |
| AIP Status: | No | No | | | |
| Development Areas | No | No | | | |
| Development Area | No | No | | | DevelopmentAreaStatus: |
| Status: | | | | | description |

4(b) Use Case: AIP Status District Report

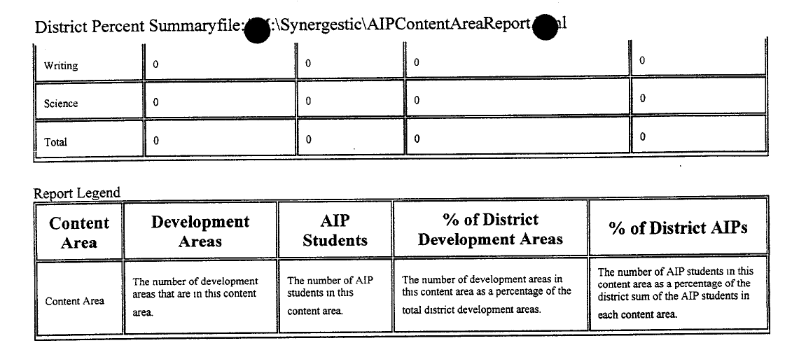

This use case describes the “AIP Status District Report” Use Case, which allows the user to choose from report options, and display the results of the report in a Web Browser. The user may then print the Report from within the Web Browser. See FIG. 22 and screen of FIG. 24.

Actors include: Principal, Counselor, Academic,. IT Operator and School Registrar.

Choosing Report Options includes:

The user may make a selection from each pick-list from the “Report Maintenance” screen to provide report-filtering criteria.

Every field modified by the user will narrow the report parameters further.

To view the report in a web browser, the user presses the Run Report button.

If the user pulls down from the FILE menu to PRINT, the report will be printed on a printer.

When the user closes the Web Browser, the user is returned to the “Reporting Maintenance” screen.

If the user selects the Done button, the user will be returned to the previous screen.

Field Mapping Includes:

| Field Name | Create | Update | Default Value | Validation Rule | Attribute in Model |
|---|---|---|---|---|---|
| Reporting Maintenance | | | | | |
| Report Filters: | | | | | |
| Select a School: | No | No | (ALL Schools) | In Pick List | School:Name |
| | | | | Select all or one | |
| Select a Teacher: | No | No | (ALL Teachers) | In Pick List | Staff:lastname |
| | | | | Select all or one | Staff:firstname |
| Select a Grade Level: | No | No | (ALL Grades) | In Pick List | Grade:description |
| | | | | Select all or one | |
| Select a Content Area: | No | No | (ALL Content | In Pick List | ContentArea:description |
| | | | Areas) | Select all or one | |
| Select an Area Status | No | No | (Select from | In Pick List | DevelopmentAreaStatus: |
| | | | List) | Select all or one | description |
| Select a School Type: | No | No | (ALL School | In Pick List | |
| | | | Types) | Select all or one | |
| AIP Content Area | | | | | |
| District Report: | | | | | |
| School | | | | | School:Name |
| AIP Status: | No | No | | | |
| Development Area | No | No | | | DevelopmentAreaStatus: |
| Status: | | | | | description |

4(c). Use Case: Change Password

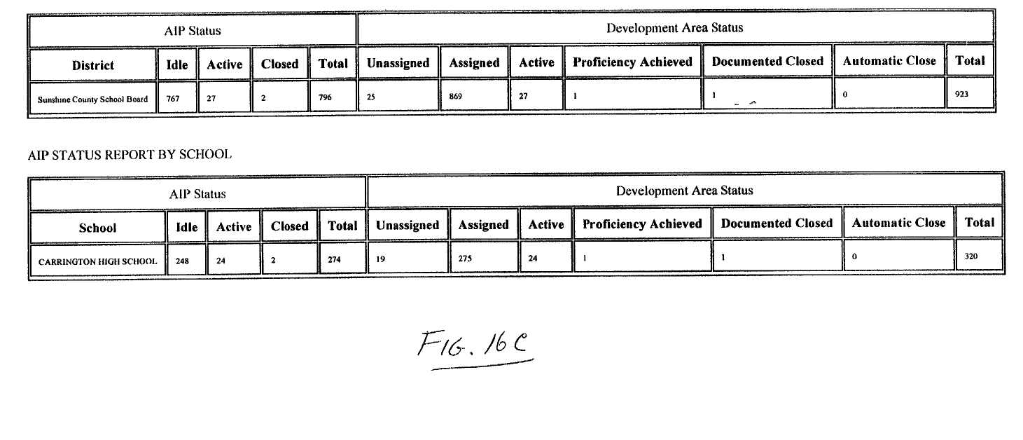

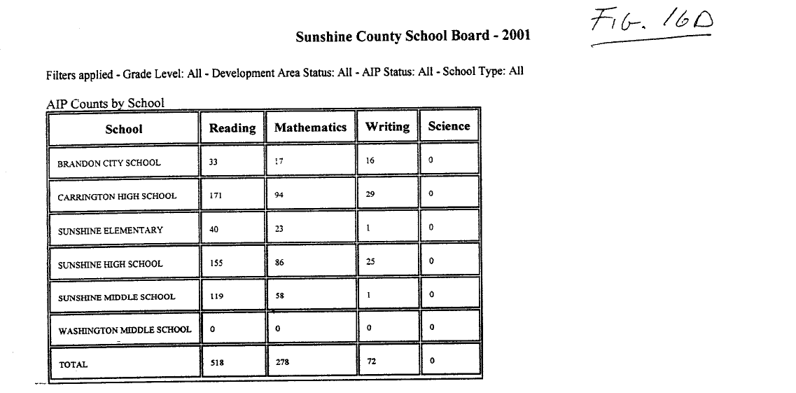

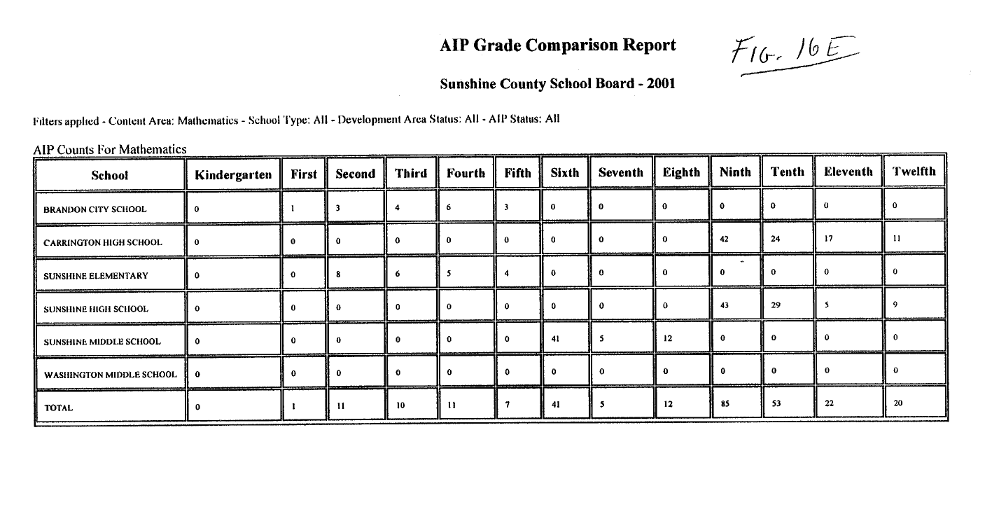

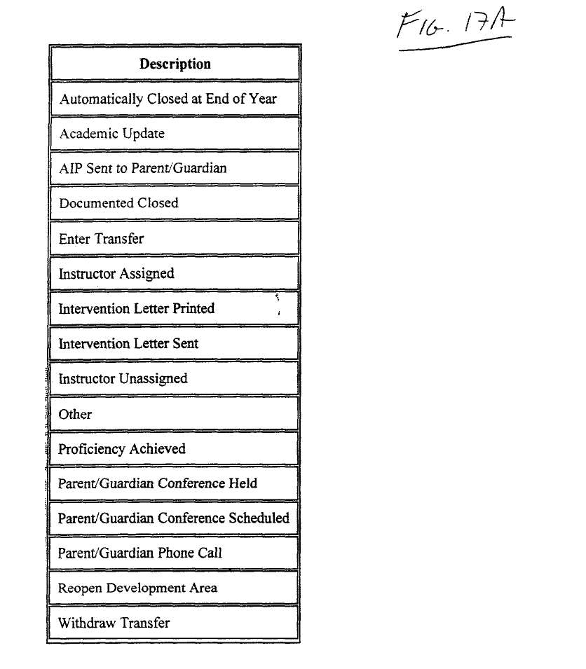

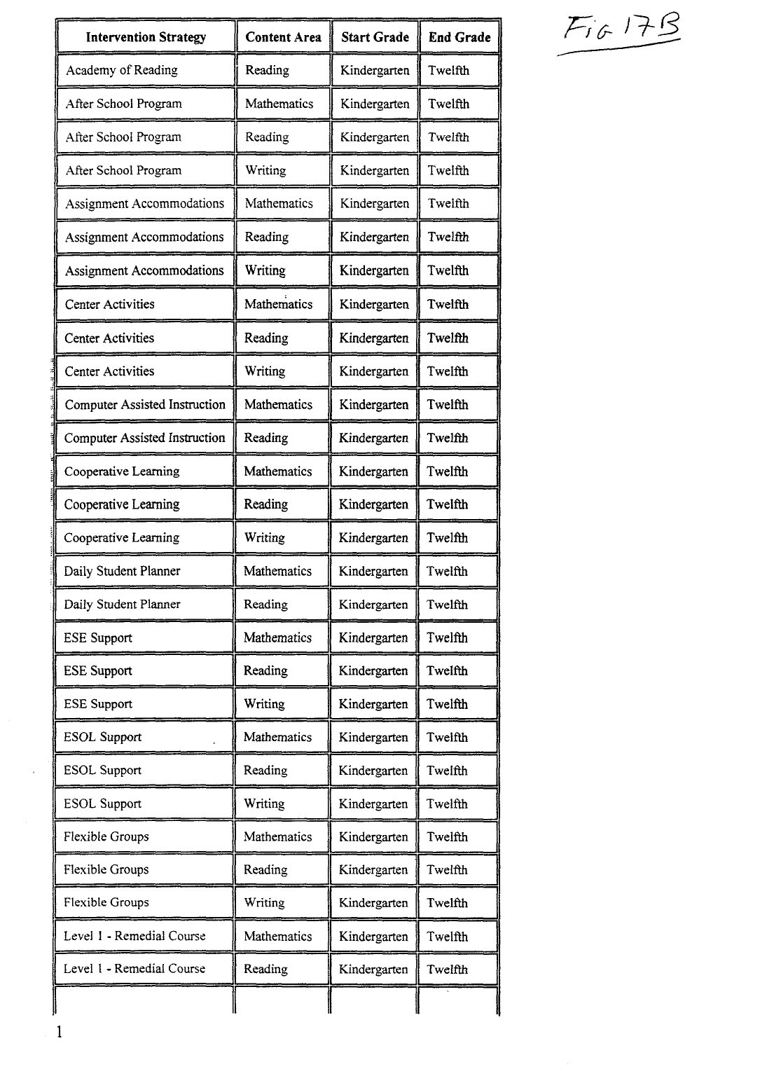

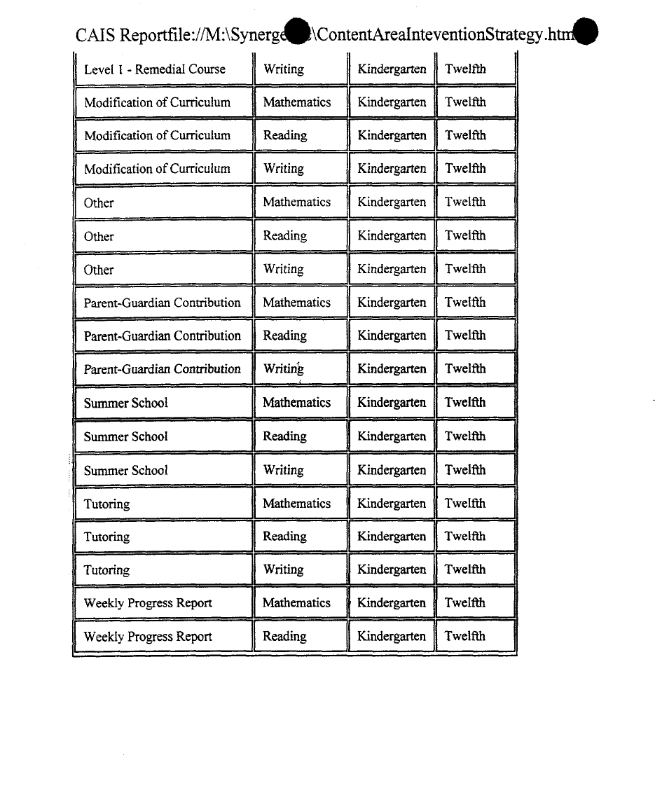

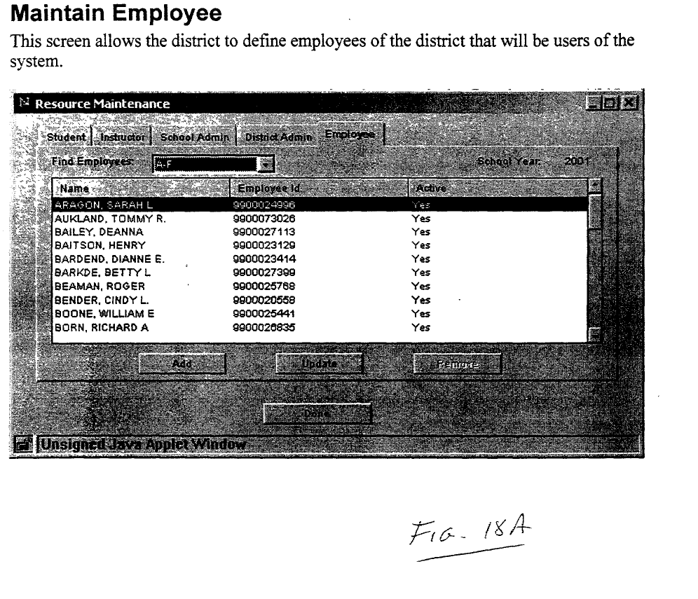

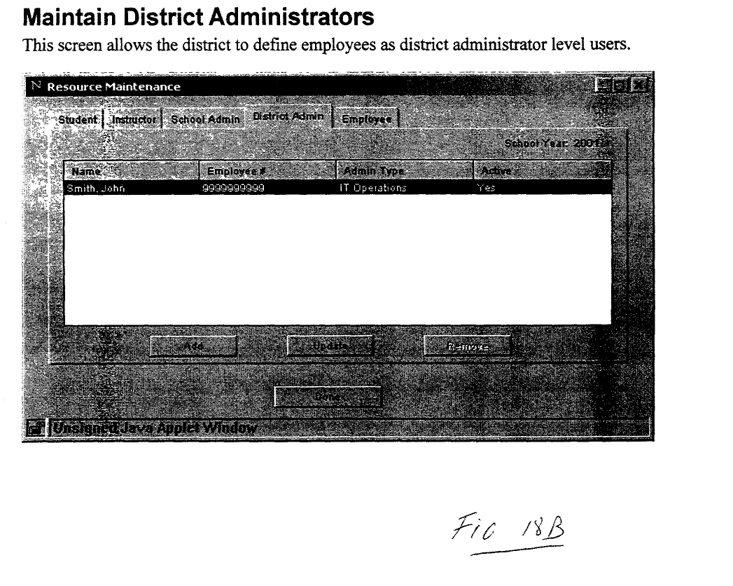

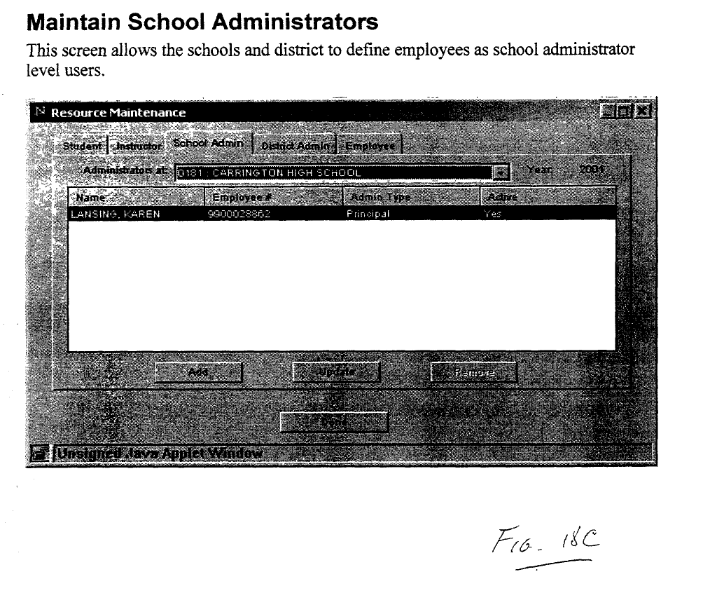

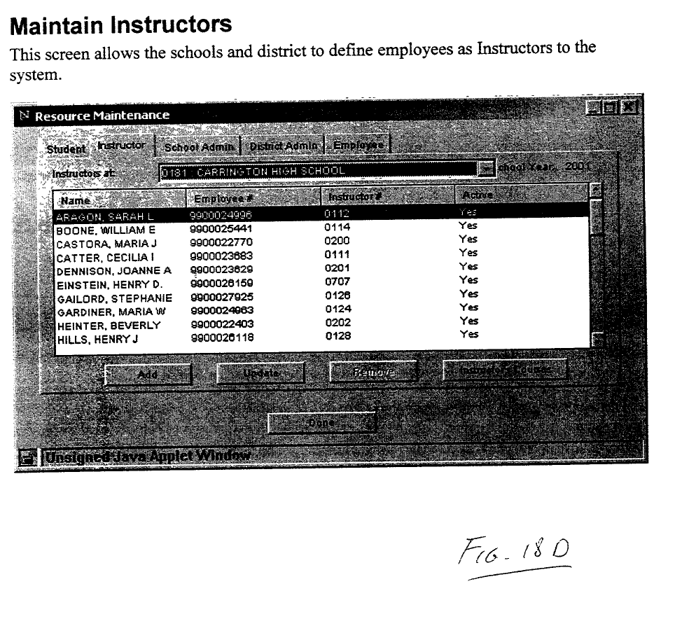

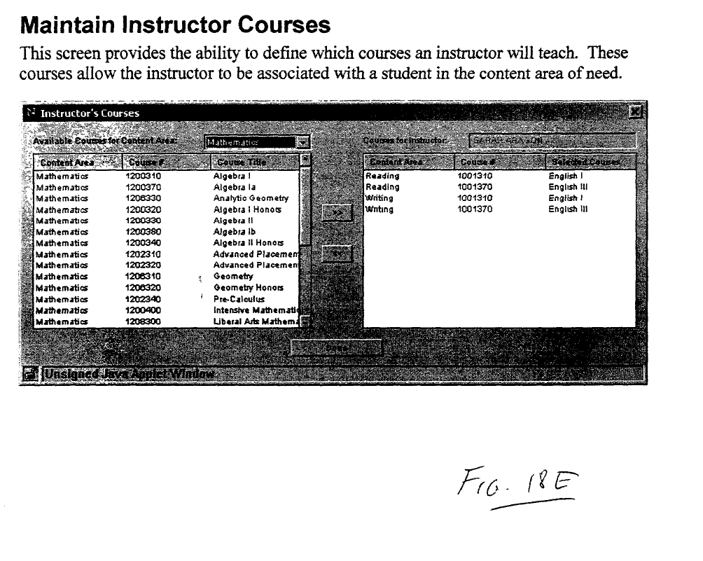

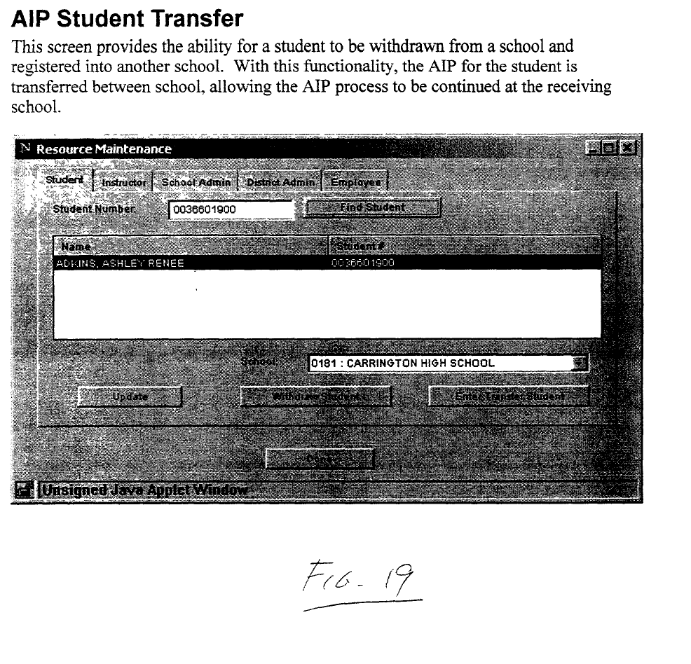

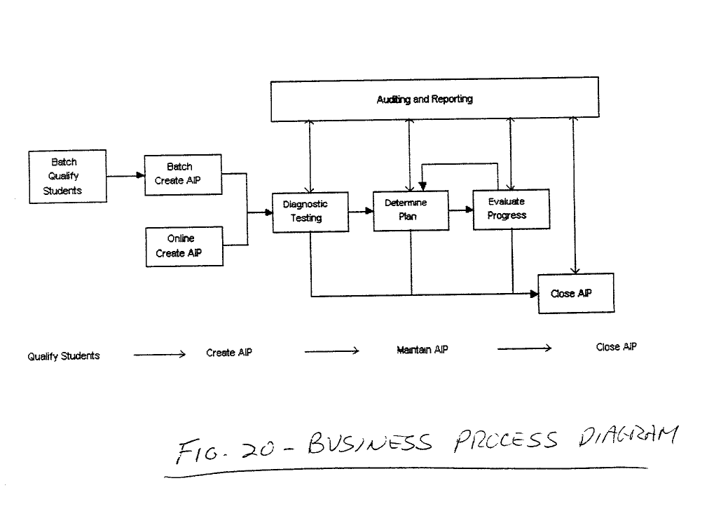

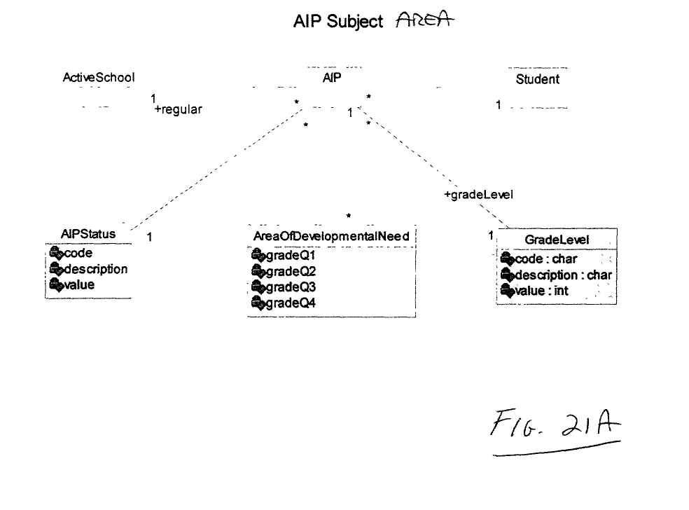

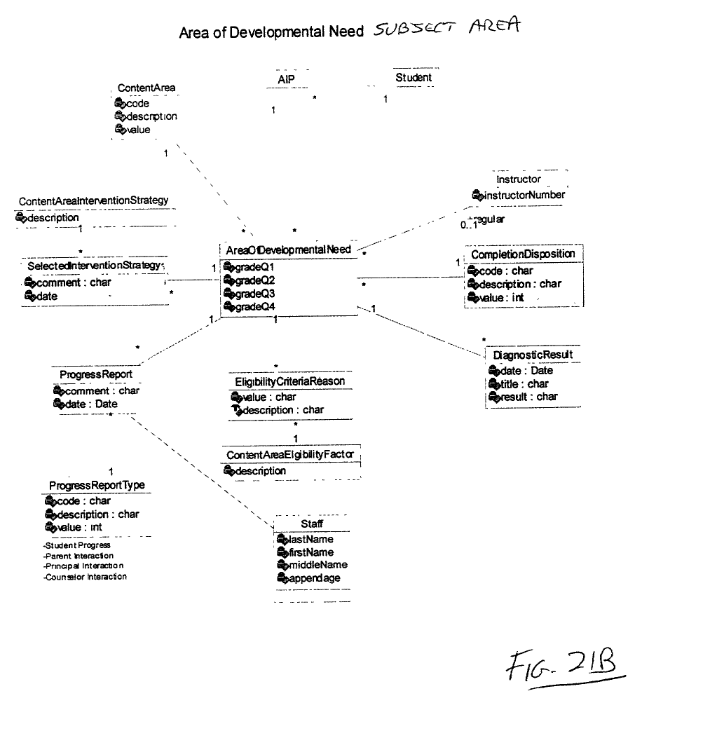

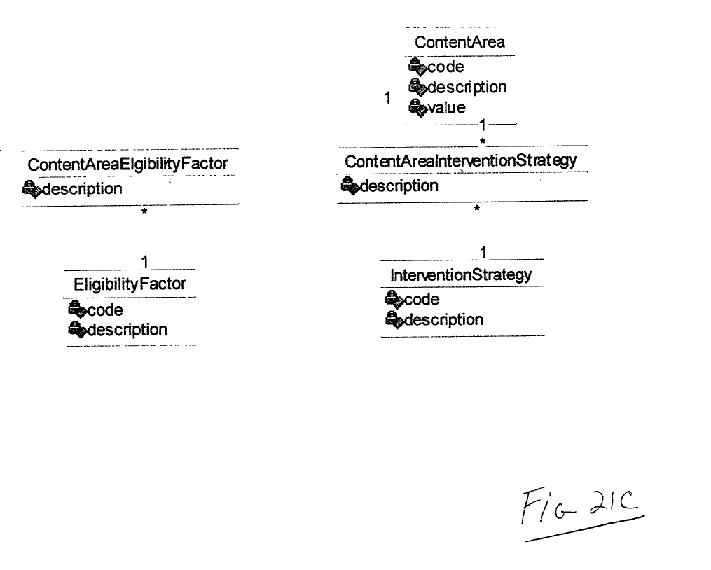

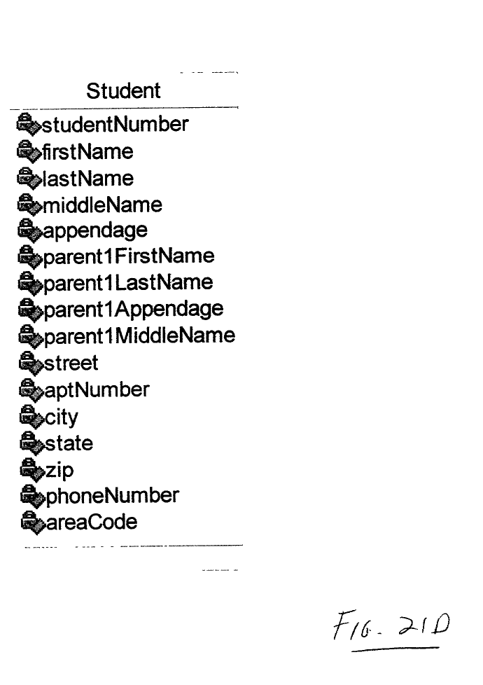

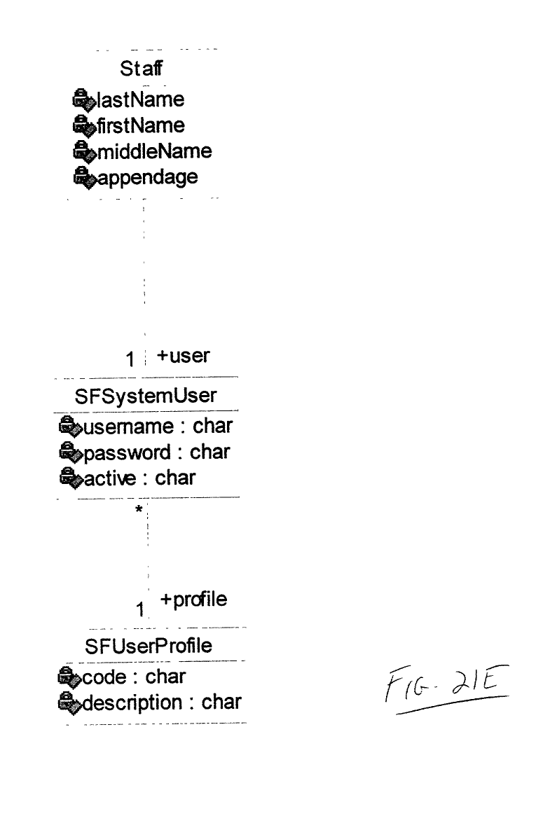

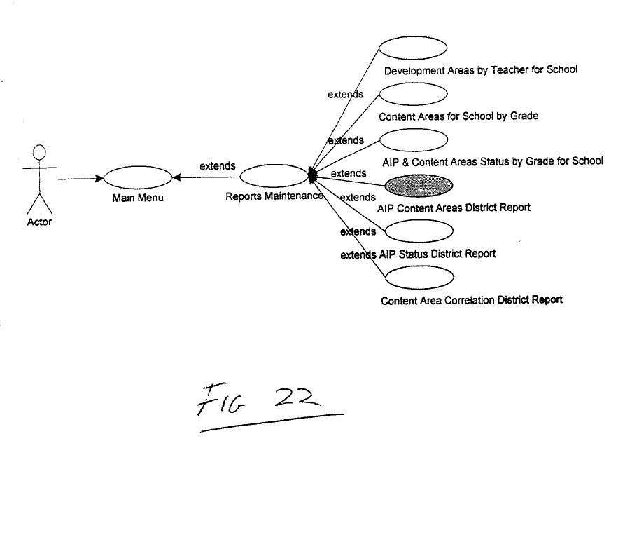

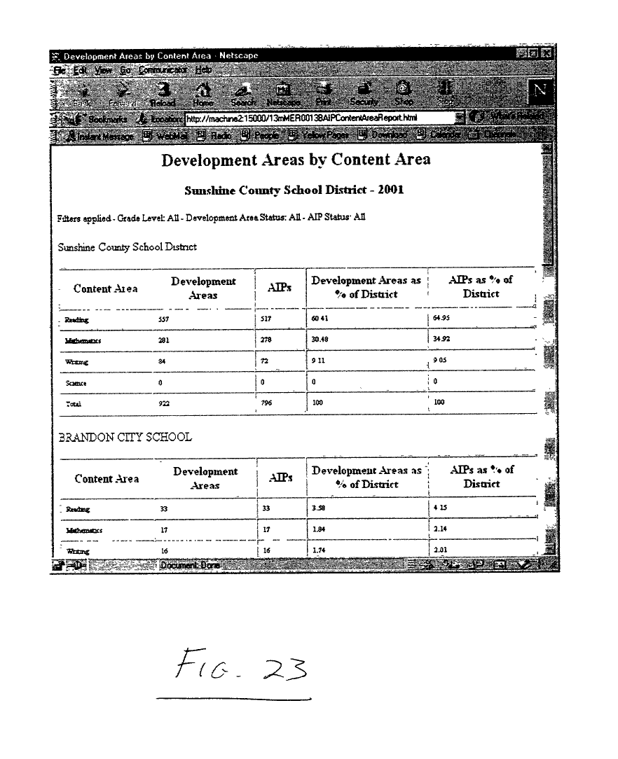

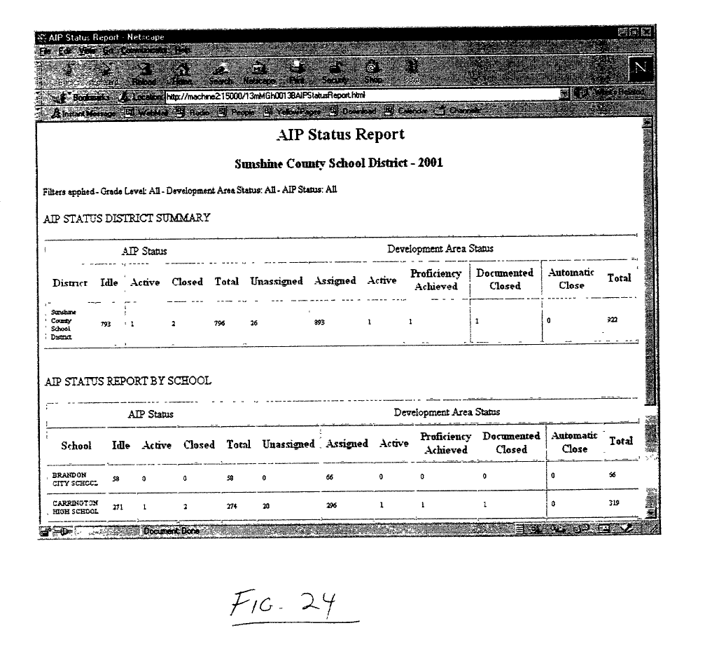

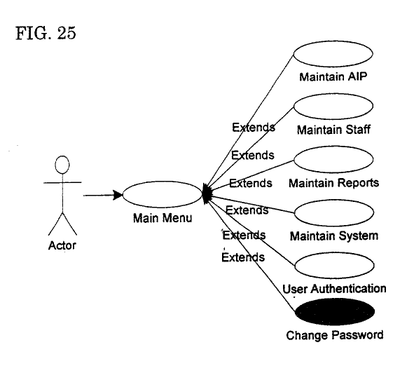

This use case describes the ability for a user to change their password in the AIP system. The user must be logged onto the system already to be able to perform this function, and for security reasons, they must supply the old password before being able to change to a new password. (See FIG. 25).

Actors include all users.

Pre-Conditions include: User must be logged into the system.

Change Password Includes:

The user selects the Change Password button to change their password.

The “Change Password” screen is displayed.

The user enters old and new password information, as per field definitions.

The user selects OK to update their password. If all necessary data has been completed (see Mappings), and passes validation, then the password is updated.

If a validation rules is not met, a warning message is displayed (see Error/Warning Exception#2).

The user is returned to the “Main Menu” screen.

If the user selects Cancel, then no modifications are made to the system, and the user is returned to the “Main Menu” screen.

Field Mapping Includes:

| Field Name | Create | Update | Default Value | Validation Rule | Attribute in Model |
|---|---|---|---|---|---|
| Password | n | y | None | Not null | SFSystemUser:password |
| | | | | Password echoed as * | |
| | | | | characters | |
| | | | | Case sensitive | |
| UserName | N | N | | Not editable | SFSystemUser:username |

Post-Conditions Include: The password information for the user may exist in a new state if the use has changed passwords.

Error/Warning Exceptions Include:

If the user does not make a selection before pressing the OK button, the following message will be displayed: “Please make a selection before proceeding.”

If a user attempts to press the OK button, but a validation rule is not met (see Field Mappings), an error message will be displayed which prompts the user to: “Please enter all data correctly in the required fields.” The user is then able to press the OK button to retry entering the proper data.

Related Use Cases Includes: User Authentication

4(d). Use Case: Create Development Area Wizard

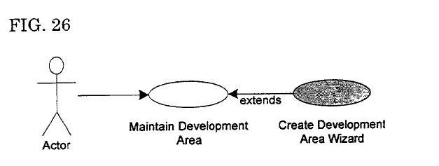

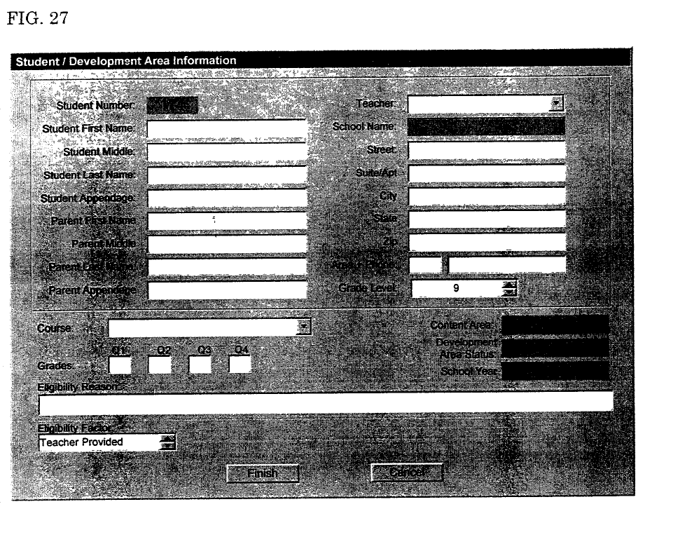

The Create Development Area Wizard use case is used to lead the user through screens, which ultimately may result in the creation of: a student, an AIP, and Development Area, and an eligibility reason. All four of these functions are not necessarily created however, as information about the student may be available in the system already. See FIG. 26 and screen of FIG. 27.

Actors include: Teacher, Guidance Counselor and Principal Create Development Area Wizard includes:

The “Create Development Area” screen is presented, prompting the user to enter the appropriate information for student number and content area. The “Tree View” displays the context for the operation. If the user does not wish to create a Development Area in the current context location, the user may navigate through the “Tree View” to locate the school location before proceeding. The user must select a school to continue with the wizard, and they may select a student within that school if the student is already known to the system (active or inactive AIP's are displayed). If a student is selected, then the following “Student Information” screen will be filled in with the student's number automatically.

The user selects the OK button to submit the information and progress to the “Student Information” screen. If all necessary data has been completed (see Field Mappings), and passes validation, then the user continues through the wizard screens. If a validation rule is not met, a warning message is displayed (see Error/Warning Exception#2).

If the Content Area already exits for the student, then a “Caution! Content Area Exists” screen is displayed to the user. If the user wishes to add a new Development Area to the Content Area, then the user selects the OK button. If the user presses the Cancel button, no data is changed in the system, and the user is returned to the “Create Development Area” screen.

If the student was not found in the system, then a “Caution! Student not found” screen is displayed to the user. If the user wishes to create a new student, then the user selects the OK button. If the user presses the Cancel button, no data is changed in the system, and the user is returned to the “Create Development Area” screen.

The user modifies Student and Development Area information as per each field definition and presses the Finish button to save the Development Area information, and return to the “Maintain AIP” screen. If all necessary data has been completed (see Field Mappings), and passes validation, then the system is updated with the new information. If a validation rule is not met, a warning message is displayed (see Error/Warning Exception#2). If the user selects Cancel, then no modifications are made to the system, and the user is returned to the previous “Create Development Area” screen.

The system will create a Student (if needed), create an AIP (if needed), and will always create a Development Area and Eligibility Reason.

Field Mapping Includes:

| Field Name | Create | Update | Default Value | Validation Rule | Attribute in Model |
|---|---|---|---|---|---|
| Dev Area | | | | | |
| Wizard: | | | | | |
| Student Number | Y | N | | | Student:studentNumber |
| Content Area | N | N | | | ContentArea:description |
| Student/Dev | | | | | |
| Area: | | | | | |
| Student Number | Y | N | | | Student:studentNumber |
| Content Area | N | N | | | ContentArea:description |
| Teacher | N | N | | If actor is | Instructor:InstructorName |
| | | | | Teacher - not | |
| | | | | editable and it | |
| | | | | is automatically | |
| | | | | populated with | |
| | | | | the teacher's | |
| | | | | name. | |
| | | | | If Guidance | |
| | | | | Counselor - In | |
| | | | | pick list, and | |
| | | | | field is editable, | |
| | | | | and the user may | |
| | | | | choose from | |
| | | | | teachers who teach | |
| | | | | courses in the | |
| | | | | content area. | |
| Student Number | Y | N | | | Student:studentNumber |
| Course Title | Y | Y | | In Pick list | InstructorContentArea:courseTitle |
| | | | | If actor is | |
| | | | | teacher - may | |
| | | | | choose from | |
| | | | | courses taught | |
| | | | | by the teacher in | |
| | | | | this content area. | |
| | | | | If actor is | |
| | | | | Guidance | |
| | | | | Counselor - | |
| | | | | may choose from | |
| | | | | instructors at | |
| | | | | school for a | |
| | | | | content area. | |
| Development | N | N | Active | In pick list | CompletionDisposition:description |
| Area Status | | | | | |
| GradeQ1 | N | Y | | | Development Area:gradeQ1 |
| GradeQ2 | N | Y | | | Development Area:gradeQ2 |
| GradeQ3 | N | Y | | | Development Area:gradeQ3 |
| GradeQ4 | N | Y | | | Development Area:gradeQ4 |
| Student First | Y | Y | | If student is | Student:firstName |
| Name | | | | known to the | |
| | | | | system - System | |
| | | | | Provided | |
| | | | | information & | |
| | | | | not editable. | |
| | | | | If new student - | |
| | | | | editable field. | |
| Student Middle | Y | Y | | If student is | Student:middleName |
| | | | | known to the | |
| | | | | system - System | |
| | | | | Provided | |
| | | | | information & | |
| | | | | not editable. | |
| | | | | If new student - | |
| | | | | editable field | |
| Student Last | Y | Y | | If student is | Student:lastName |
| Name | | | | known to the | |
| | | | | system - System | |
| | | | | Provided | |
| | | | | information & | |
| | | | | not editable. | |
| | | | | If new student - | |
| | | | | editable field | |
| Student | Y | Y | | If student is | Student:appendage |
| Appendage | | | | known to the | |
| | | | | system - System | |
| | | | | Provided | |
| | | | | information & | |
| | | | | not editable. | |
| | | | | If new student - | |
| | | | | editable field | |
| Parent First | Y | Y | | If student is | Student:parent1FirstName |
| Name | | | | known to the | |
| | | | | system - System | |
| | | | | Provided | |
| | | | | information & | |
| | | | | not editable. | |
| | | | | If new student - | |
| | | | | editable field | |
| Parent Middle | Y | Y | | If student is | Student:parent1MiddleName |
| | | | | known to the | |
| | | | | system - System | |
| | | | | Provided | |
| | | | | information & | |
| | | | | not editable. | |
| | | | | If new student - | |
| | | | | editable field | |
| Parent Last Name | Y | Y | | If student is | Student:parent1lastName |
| | | | | known to the | |
| | | | | system - System | |
| | | | | Provided | |
| | | | | information & | |
| | | | | not editable. | |
| | | | | If new student - | |
| | | | | editable field | |
| Parent | Y | Y | | If student is | Student:parent1Appendage |
| Appendage | | | | known to the | |
| | | | | system - System | |
| | | | | Provided | |
| | | | | information & | |
| | | | | not editable. | |
| | | | | If new student - | |
| | | | | editable field | |
| School Name | N | N | Tree Value | | School:name |
| School Year | N | N | Current Year | | SchoolYear:name |
| Grade Level | N | Y | | | Grade Level:value |
| Street | Y | Y | | If student is | Student:street |
| | | | | known to the | |
| | | | | system - System | |
| | | | | Provided | |
| | | | | information & | |
| | | | | not editable. | |
| | | | | If new student - | |
| | | | | editable field | |
| Suite/Apt | Y | Y | | If student is | Student:aptNumber |
| | | | | known to the | |
| | | | | system - System | |
| | | | | Provided | |
| | | | | information & | |
| | | | | not editable. | |
| | | | | If new student - | |
| | | | | editable field | |
| City | Y | Y | | If student is | Student:city |
| | | | | known to the | |
| | | | | system - System | |
| | | | | Provided | |
| | | | | information & | |
| | | | | not editable. | |
| | | | | If new student - | |
| | | | | editable field | |
| State | Y | Y | | If student is | Student:state |
| | | | | known to the | |
| | | | | system - System | |
| | | | | Provided | |
| | | | | information & | |
| | | | | not editable. | |
| | | | | If new student - | |
| | | | | editable field | |
| Zip | Y | Y | | If student is | Student:zip |
| | | | | known to the | |
| | | | | system - System | |
| | | | | Provided | |
| | | | | information & | |
| | | | | not editable. | |
| | | | | If new student - | |
| | | | | editable field | |
| Area | Y | Y | | If student is | Student:areaCode |
| | | | | known to the | |
| | | | | system - System | |
| | | | | Provided | |
| | | | | information & | |
| | | | | not editable. | |
| | | | | If new student - | |
| | | | | editable field | |
| Phone | Y | Y | | If student is | Student:phoneNumber |
| | | | | known to the | |
| | | | | system - System | |
| | | | | Provided | |
| | | | | information & | |
| | | | | not editable. | |
| | | | | If new student - | |
| | | | | editable field | |
| Eligibility Reason | Y | Y | | | EligibilityCriteriaReason:value |
| Eligibility Factor | N | Y | Teacher | In Pick List | EligibilityFactor:description |
| | | | Provided | | |

Post-Conditions Include: The database may exist in a new state if the user has added or updated Student and/or Development Area data.

Error/Warning Exceptions Include:

If the user does not make a selection before pressing the OK button, the following message will be displayed: “Please make a selection before proceeding.”

If a user attempts to press the OK button, but a validation rule is not met (see Field Mappings), an error message will be displayed which prompts the user to: “Please enter all data correctly in the required fields.” The user is then able to press the OK button to retry entering the proper data.

4(e). Use Case: Enter Transfer

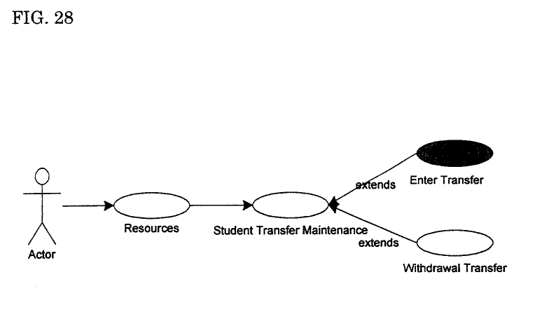

This use case describes the “Enter Transfer” Use Case, which allowed a user to transfer a student from the “Transfer” state into a school. See FIG. 28.

Actors: School Administrators

To Enter a Transfer, the user is presented with the “Student ID” dialog box, and enters the Student ID and presses the OK button. If the user presses the Cancel button, the user is returned to the previous menu.

The “Enter Transfer Student” screen is presented, and the user may edit Student Information and press the Transfer button. If the Cancel button is pressed, the user is returned to the previous screen. The “Success!” screen appears, indicating a successful student transfer. The user is also asked whether to update the Development Areas for the student “Now” or “Later”. If the user presses the Now button, the “AIP Maintenance” screen is presented with the student highlighted. If the user presses the Later button, the user is returned to the “Maintain Resources” screen.

Field Mapping includes:

| Field Name | Create | Update | Default Value | Validation Rule | Attribute in Model |
|---|---|---|---|---|---|
| Number | N | N | | editable | Student:studentNumber |
| First Name | N | Y | | editable | Student:firstName |
| Middle Name | N | Y | | editable | Student:middleName |
| Last Name | N | Y | | editable | Student:lastName |
| Appendage | N | Y | | editable | Student:appendage |
| Parent First Name | N | Y | | editable | Student:parent1FirstName |
| Parent Middle | N | Y | | editable | Student:parent1MiddleName |
| Parent Last Name | N | Y | | editable | Student:parent1lastName |
| Parent Appendage | N | Y | | editable | Student:parent1Appendage |
| Street | N | Y | | editable | Student:street |
| Suite/Apt | N | Y | | editable | Student:aptNumber |
| City | N | Y | | editable | Student:city |
| State | N | Y | | editable | Student:state |
| Zip | N | Y | | editable | Student:zip |
| Area | N | Y | | editable | Student:areaCode |
| Phone | N | Y | | editable | Student:phoneNumber |

4(f). Use Case: Find AIP Student

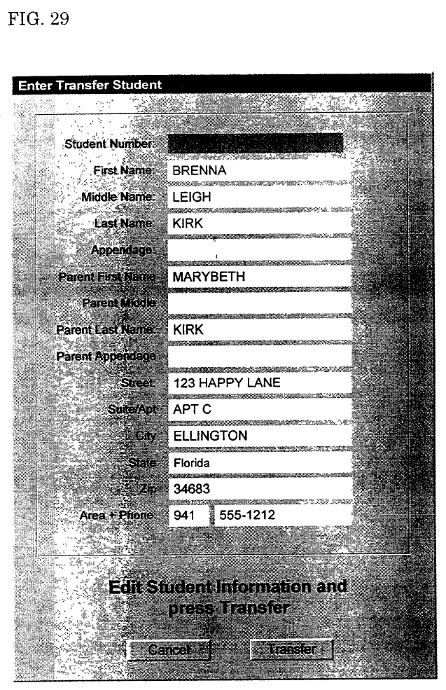

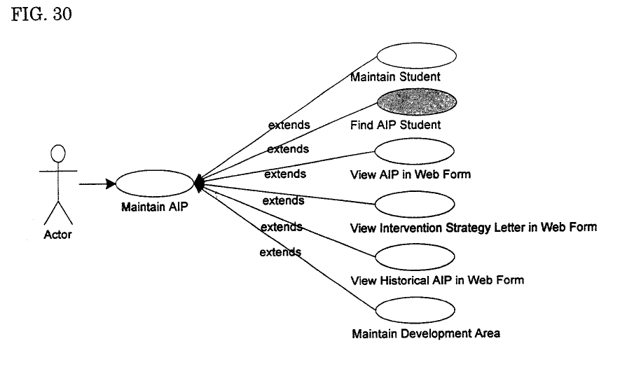

The Find AIP Student Use Case is used to search for AIP students. The User is able to search for a student based on filters, and the search is restricted within the parameters of the User's access to student information. The Maintain AIP display window is populated with the results of the search, and the “Students At” pick list changes to reflect the school in which the search was initiated. See FIG. 30.

Actors Include: Instructor, School Admin and District Admin. Find AIP Includes:

The user modifies a field (or fields) to match search criteria and presses the Find button to begin the search. Every field modified by the user will narrow the search further.

The user may leave a field blank to avoid narrowing the search in that field's area.

The search will only find students available to the user as defined by the user's access level and their association to the students.

If the user presses the Cancel button, no search is initiated, and the user is returned to the previous screen.

A list of possible Student AIP matches is displayed to the user in the “Maintain AIP” screen.

Field Mapping includes:

| Field Name | Create | Update | Default Value | Validation Rule | Attribute in Model |
|---|---|---|---|---|---|
| First Name | N | N | None | | Student:firstName |
| Last Name | N | N | None | | Student:lastName |
| Student Number | N | N | None | | Student:studentNumber |
| AIP Status | N | N | Active | | AIPStatus:description |
| Dev Area Status | N | N | None | | |
| School Name | N | N | User's Current School | | School:name |
| Content Area: | N | N | None | | ContentArea:description |
| Grade Level | N | N | None | | Grade:value |
| Instructor: | N | N | None | | |

Post-Conditions includes: The Maintain AIP display window will be populated with the results of the Find AIP Student query.

Related Use Cases: Maintain AIP.

4(g). Use Case: Load Development Area

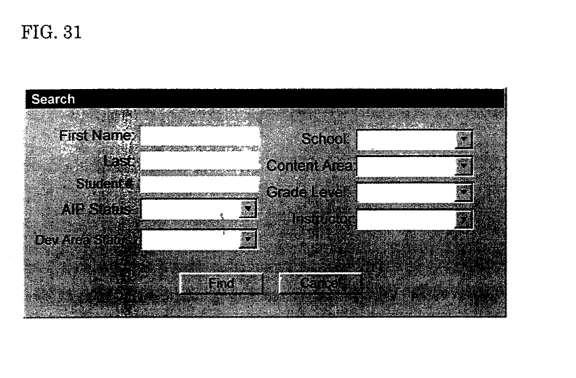

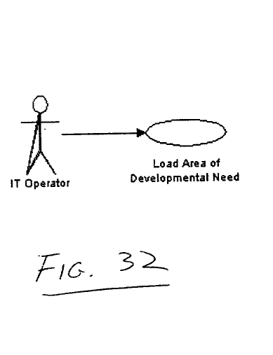

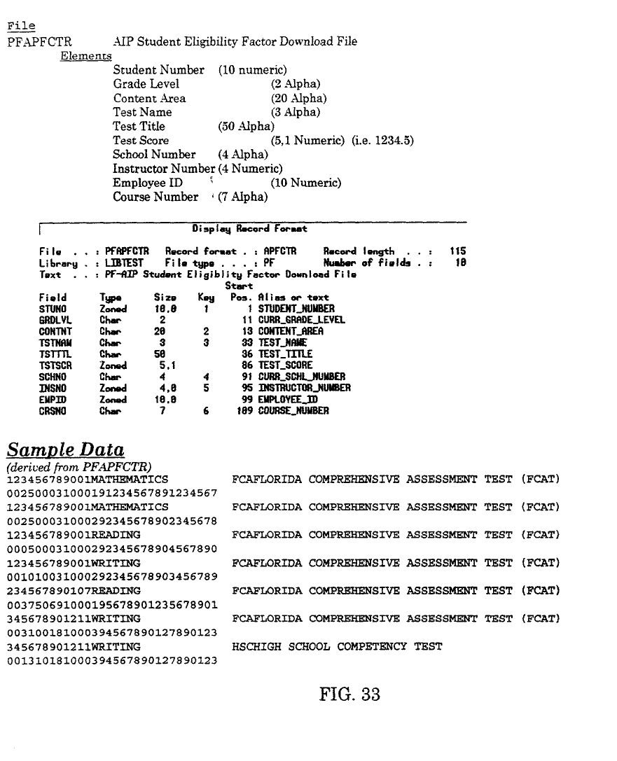

The purpose of this use case is to populate or update AIP Development Area information for a Student in a District School for a particular School Year. An IT operator performs this activity primarily once per school year, in order to import the Student AIP Development Area information for that particular year. This use case represents the final step in a four-step process to populate the AIP system for a particular school district year. See FIG. 32 and file format, Record Format and Sample Data of FIG. 33.

Actors: IT Operator

Pre-Conditions Include:

The Load AIP School Controls use case has been run for the corresponding district and school year. This is necessary to ensure the establishment of the district schools for the school year. If the district school has not been established for the school year, then an error message is displayed to the user: “District school for school year has not been established. Please load school controls for the requested school year.”

The Load Student use case has been performed to ensure students have been entered into the system for the school year

The Load Instructors use case has been performed to ensure instructors have been entered into the system for the school year.

The AIP Student Eligibility Factor Download File (PFAPFCTR.txt) exists for the appropriate year, and is accessible from the local (server) file system. If the file is not available, system displays error “File not found for defined year. Please contact operations and have them generate the appropriate file for the load.”

Loading includes:

1. User identifies District to which the file pertains.

2. User identifies School Year for which load pertains. Default is pulled from systems active school year. (See administrative use case . . . set system active year.)

3. User identifies qualified filename.

4. User selects OK or Cancel. If Cancel nothing happens, Use Case ends.

5. System opens file and confirms District School for desired Year of first record. If district school for identified school year is not found then message presented as in pre-condition.

6. If file matches, system prompts for confirmation, otherwise, file not found error is displayed.

7. On OK, system proceeds with load operation.

8. AIP System Log file is appended to with Log of file load activity including Username, date time, file info (name, datetime, size), username. (ie.ITUSER01, Sep. 1, 2000 23:20:15, Load Development Area, STARTED, PFAPFCTR.txt, Aug. 25, 2000 01:09:03, 25256)

9. The system Loops through the download file line by line. Each record in file is a fixed length format.

10. System validates identified Student for each line of data entry. If the Student is not found then the line is not processed. Load is terminated and errors written to log as in Exception 1 with message.

11. System validates identified district school for school year for each line of data entry. If the Active School is not found then the line is not processed. Load is terminated and errors written to log as in Exception 1 with message.

12. The records are processed according to rules defined in additional algorithm section and field mappings. If validation errors are encountered, then AIP System Log file is appended to with the message in Error Log of file load activity including USERNAME, date time, Activity, STATUS, file info (name, datetime, size). (i.e. ITUSER01, Sep. 1, 2000 23:22:49, Load Development Area, REFRESH ERROR, PFAPFCTR.txt, Aug. 25, 2000 01:09:03, 25256, ERROR DESCRIPTION: school->businessUnit may not be blank.) The detail error information plus the original record are recorded in the Load Exception file.

13. When Load completes, AIP System Log file is appended to with Log of file load activity including USERNAME, date time, Activity, STATUS, file info (name, datetime, size). (i.e. ITUSER01, Sep. 1, 2000 23:22:49, Load Development Area, REFRESH COMPLETED, PFAPFCTR.txt, Aug. 25, 2000 01:09:03, 25256)

Field Mapping:

| Field Name | Create | Update | Validation Rule | Attribute in Model | Relative path |
|---|---|---|---|---|---|
| Student Number | N | N | ● Not Blank | Student::studentNumber | AIP−>student−>studentNumber |
| Grade Level | N | Y | ● Not Blank | AIP−>gradeLevel | AIP−>gradeLevel |
| Content Area | N | Y | ● Not Blank | ContentArea::code | AIP−>developmentArea−> |
| | | | | | contentArea−>code |
| Test Name | N | Y | ● | | AIP−>development area−> |
| | | | | | eligibilityCriteriaReason−> |
| | | | | | contentAreaEligibilityFactor−> |
| | | | | | eligibilityFactor−>code |
| Test Title | Y | Y | ● | | AIP−>developmentArea−> |
| | | | | | eligibilityCriteriaReason−> |
| | | | | | eligibilityFactor−>description |
| Test Score | Y | Y | ● | | AIP−>developmentArea−> |
| | | | | | eligibilityCriteriaReason−>value |
| School Number | N | N | ● Not Blank | School::businessUnit | AIP−>activeSchool−>school−> |
| | | | | | business Unit |
| Instructor Number | N | N | ● Not Blank | Instructor::instructorNumber | AIP−>instructor−> |
| | | | | | instructorNumber |
| EmployeeId | N | N | ● Not Blank | Staff::employeeId | AIP->instructor->teacher−> |
| | | | | | employeeId |
| Course Number | Y | Y | ● Not Blank | Course::courseNumber | AIP->developmentArea−> |
| | | | | | course−>courseNumber |

Post-Conditions Include:

Load Development Area has populated persistent data for AIP's and Development Area. The system log file has been updated recording the activity. If no errors were encountered the system is prepared to run the Load Students use case. If errors were encountered the load may or may not have been terminated.

Error/Warning Exceptions: The following logging actions of activity, exceptions, and errors may occur during the load use case as referenced in this document:

1. AIP System Log file is appended to with Log of file load activity including Username, date time, and passed information including activity, state, file info (name, datetime, size).

Example:

ITUSER01, Sep. 1, 2000 23:20:15, Load Development Area, <PASSED ACTIVITY>, PFAPFCTR.txt, Aug. 25, 2000 01:09:03, 25256)

2. If exceptions are encountered during database activity, then AIP System Log file is appended to with the message in Error Log of file load activity including USERNAME, date time, Activity, STATUS, file info (name, datetime, size).

Example:

ITUSER01, Sep. 1, 2000 23:22:49, Load Development Area, REFRESH ERROR, PFAPFCTR.txt, Aug. 25, 2000 01:09:03, 25256, ERROR DESCRIPTION:<passed error description.)

The detail error information and the original record on a new line are recorded in the Load Exception file.

Security Exceptions: Only users with the role of IT Operator may perform loading functionality.

Additional Algorithm Detail includes:

The system loops through the AIP Student Eligibility Factor Download file line by line. The record is fixed length format defined in the attachment section.

System extracts School number from the record and queries for pre-existing district school for designated school year (Active School). If the active school does not exist then system outputs exception error 1 with message “No ActiveSchool for school year. Please load school controls. Terminating load.” Load processing is terminated.

Establish AIP includes:

System extracts student number, school number, and grade level from record.

System queries for existing AIP for student.

If not found, system creates a new AIP for the student. If validation errors are encountered in mapping of data, then Exception 2 processing occurs.

If found or created without error then proceed. If error occurred then skip record—logging via Exception 1 with message of AIP not created for school and student number.

Establish Development Area includes:

System extracts Content Area, Instructor Number, and Course Number from record and queries for existing Development Area.

If not found then create Development Area for student with extracted information from record. If validation errors are encountered in mapping of data, then Exception 2 processing occurs.

If Development Area is found then system queries Eligibility Criteria Reason where Content Area Eligibility Factor matches test name from record.

If found then system checks values from record of Eligibility Criteria Reason (Test Score) with stored values and updates if different.

If not found then create and add ElgibilityCriteriaReason with Test Title, Test Score, and selected Content AreaElgibilityFactor (Test Name-3char code).

4(h). Use Case: Load Instructors

The purpose of this use case is to populate or update Instructor information for a district for a particular School Year. An IT operator performs this activity primarily once per school year, in order to import the instructor and instructor content area information for that particular year. This use case represents the second step in a four step process to populate the AIP system for a particular school district year. See FIG. 34 and file format, Record Format and Sample Data of FIG. 35.

Actors: IT Operator

Pre-Conditions: The School Year has been entered in the system via the Maintain School Year use case. The Load AIP School Controls use case has been run for the corresponding district and school year. This is necessary to ensure the establishment of the district schools for the school year. If the district school has not been established for the school year, then an error message is displayed to the user: “District school for school year has not been established. Please load school controls for the requested school year.” The AIP Instructor Download File (PFAPINST.txt) exists for the appropriate year, and is accessible from the local (server) file system. If the file is not available, system displays error “File not found for defined year. Please contact operations and have them generate the appropriate file for the load.”

Loading Instructions Include:

User identifies District to which the file pertains.

User identifies School Year for which load pertains. Default is pulled from activeSchoolYear.

User identifies qualified filename

User selects OK or Cancel. If Cancel nothing happens, Use Case ends.

System opens file and confirms District and Year and School of first record. If district school for identified school year is not found then message presented as in pre-condition.

If file matches, system prompts for confirmation, otherwise, file not found error is displayed.

On OK, system proceeds with load operation.

AIP System Log file is appended to with Log of file load activity including Username, date time, file info (name, datetime, size), username. (ie.ITUSER01, Sep. 9, 2000 23:20:15, Load Instructors, STARTED, PFAPINST.txt, Aug. 25, 2000 01:09:03, 25256)

The system Loops through the download file line by line. Each record in file is a fixed length format.

System validates identified district school for school year for each line of data entry. If the Active School is not found then the line is not processed. Load is terminated and errors written to log as in Exception 1 with message.

The records are processed according to rules defined in additional algorithm section and field mappings. If validation errors are encountered, then AIP System Log file is appended to with the message in Error Log of file load activity including USERNAME, date time, Activity, STATUS, file info (name, datetime, size). (i.e. ITUSER01, Sep. 1, 2000 23:22:49, Load Instructors, REFRESH ERROR, PFAPINST.txt, Aug. 25, 2000 01:09:03, 25256, ERROR DESCRIPTION: school->businessUnit may not be blank.) The detail error information plus the original record are recorded in the Load Exception file.

When Load completes, AIP System Log file is appended to with Log of file load activity including USERNAME, date time, Activity, STATUS, file info (name, datetime, size). (i.e. ITUSER01, Sep. 1, 2000 23:22:49, Load Instructors, REFRESH COMPLETED, PFAPINST.txt, Aug. 25, 2000 01:09:03, 25256)

Field Mapping:

| Field Name | Create | Update | Validation Rule | Attribute in Model | Relative path |
|---|---|---|---|---|---|
| School Number | N | N | ● Not Blank | School::businessUnit | ActiveSchool−>school−> |
| | | | | | businessUnit |
| Instructor Number | Y | N | ● Not Blank | Instructor::instructorNumber | ActiveSchool−>instructor−> |
| | | | | | instructorNumber |
| Instructor | Y | N | ● Not Blank | Staff::employeeId | ActiveSchool−>instructor−> |
| Employee Id | | | | | teacher−>employeeId |
| Instructor First | Y | Y | ● Not Blank | Staff::firstName | ActiveSchool−>instructor−> |
| Name | | | | | teacher−>firstName |
| Instructor Middle | Y | Y | ● | Staff::middleName | ActiveSchool−>instructor−> |
| Name | | | | | teacher−>middleName |
| Instructor Last | Y | Y | ● Not Blank | Staff::lastName | ActiveSchool−>instructor−> |
| Name | | | | | teacher−>lastName |
| Instructor | Y | Y | ● | Staff::appendage | ActiveSchool−>instructor−> |
| Appendage | | | | | teacher−>appendage |
| Content Area | N | N | ● Not Blank | ContentArea::code | ActiveSchool−>instructor−> |
| | | | | | instructorContentArea−> |
| | | | | | contentArea−>code |
| Course Title | Y | Y | ● | InstructorContentArea:courseTitle | ActiveSchool−>instructor−> |
| | | | | | instructorContentArea−> |
| | | | | | courseTitle |
| Course Number | Y | N | ● | InstructorContentArea::courseNumber | ActiveSchool−>instructor−> |
| | | | | | instructorContentArea−> |
| | | | | | courseNumber |

Post-Conditions:

Load Instructors has populated persistent data for Instructors and Instructor Content Area. The system log file has been updated recording the activity. If no errors were encountered the system is prepared to run the Load Students use case. If errors were encountered the load may or may not have been terminated.

Error/Warning Exceptions:

The following logging actions of activity, exceptions, and errors may occur during the load use case as referenced in this document: AIP System Log file is appended to with Log of file load activity including Username, date time, and passed information including activity, state, file info (name, datetime, size).

Example:

ITUSER01, Sep. 1, 2000 23:20:15, Load Instructors,<PASSED ACTIVITY>, PFAPINST.txt, Aug. 25, 2000 01:09:03, 25256)

If exceptions are encountered during database activity, then AIP System Log file is appended to with the message in Error Log of file load activity including USERNAME, date time, Activity, STATUS, file info (name, datetime, size).

Example:

ITUSER01, Sep. 1, 2000 23:22:49, Load Instructors, REFRESH ERROR, PFAPINST.txt, Aug. 25, 2000 01:09:03, 25256, ERROR DESCRIPTION:<passed error description.)

The detail error information and the original record on a new line are recorded in the Load Exception file.

Security Exceptions: Only users with the role of IT Operator may perform loading functionality.

Additional Algorithm Detail:

The system loops through the AIP InstructorDownload file line by line. The record is fixed length format defined in the attachment section.

System extracts School number from the record and queries for pre-existing district school for designated school year (Active School). If the active school does not exist then system outputs exception error 1 with message “No ActiveSchool for school year. Please load school controls. Terminating load.” Load processing is terminated.

Establish Instructor Includes:

System extracts Teacher Employee Number from record and queries for existing Teacher (staff).

If not found then create Teacher (Staff) with extracted Teacher employee Id and Instructor name information.

If found then update non-key staff information. Create Instructor with Staff and Active School information.

If validation errors are encountered in mapping of data, then Exception 2 processing occurs. If Instructor is found then system checks values from record of Instructor name with stored values and updates if different.

Establish Instructor Content Area Includes:

System extracts content area, course number and course title from record

System queries for existing content area. If not found then log exception.

System queries for existing course. If not found then create course with values from record

Query for Instructor Content Area (content area, course, instructor).

If not found, system creates a new Instructor Content Area. If validation errors are encountered in mapping of data, then Exception 2 processing occurs.

If found or created without error then proceed. If error occurred then skip record.

4(i.) Use Case: Load School Controls

The purpose of this use case is to populate or update School and Principal information for a district for a particular School Year. An IT operator performs this activity primarily once per school year, in order to import the school and principal information for that particular year. This use case represents the first step in a four step process to populate the AIP system for a particular school district year. See FIG. 36 and file format, Record Format and Sample Data of FIG. 37.

Actors: IT Operator

Pre-Conditions Include:

The School Year has been entered in the system via the Maintain School Year use case.

The AIP School Download File (PFAPSCHL.txt) exists for the appropriate year, and is accessible from the local (server) file system. If the file is not available, system displays error “File not found for defined year. Please contact operations and have them generate the appropriate file for loading of Schools and Principals.”

Load School Controls Include:

User identifies District to which the file pertains.

User identifies School Year for which load pertains. Default is pulled from activeSchoolYear.

User identifies qualified filename

User selects OK or Cancel. If Cancel nothing happens, Use Case ends.

System opens file and confirms District and Year information.

If file matches, system prompts for confirmation, otherwise, file not found error is displayed.

On OK, system proceeds with load operation.

AIP System Log file is appended to with Log of file load activity including Username, date time, file info (name, datetime, size), username. (ie.ITUSER01, Sep. 1, 2000 23:20:15, School Controls Load, STARTED, PFAPSCHL.txt, Aug. 25, 2000 01:09:03, 25256)

The system Loops through the AIP School Download file line by line. Each record in file is a fixed length format.

System validates identified School Year for each line of data entry. If not the same year then error is logged and line is not processed. Load is terminated and errors written to log.

The records are processed according to rules defined in additional algorithm section and field mappings. If validation errors are encountered, then AIP System Log file is appended to with the message in Error Log of file load activity including USERNAME, date time, Activity, STATUS, file info (name, datetime, size). (i.e. ITUSER01, Sep. 1, 2000 23:22:49, School Controls Load, REFRESH ERROR, PFAPSCHL.txt, Aug. 25, 2000 01:09:03, 25256, ERROR DESCRIPTION: school->businessUnit may not be blank.) The detail error information plus the original record are recorded in the Load Exception file.

When Load completes, AIP System Log file is appended to with Log of file load activity including USERNAME, date time, Activity, STATUS, file info (name, datetime, size). (i.e. ITUSER01, Sep. 1, 2000 23:22:49, School Controls Load, REFRESH COMPLETED, PFAPSCHL.txt, Aug. 25, 2000 01:09:03, 25256)

Field Mapping Includes:

| Field Name | Create | Update | Validation Rule | Attribute in Model | Relative path |
|---|---|---|---|---|---|
| School Year | Y | N | —Not Blank | SchoolYear::name | ActiveSchool−>schoolYear−>name |
| School Number | Y | N | —Not Blank | School::businessUnit | ActiveSchool−>school−>businessUnit |
| School Name (full) | Y | Y | —Not Blank | School::name | ActiveSchool−>school−>name |
| Principals Employee | Y | N | —Not Blank | Staff::employeeId | ActiveSchool−>schoolAdmin−>Staff−> |
| Id | | | | | employeeId |
| Principals First Name | Y | Y | —Not Blank | Staff::firstName | ActiveSchool−>schoolAdmin−>Staff−> |
| | | | | | firstName |
| Principals Middle | Y | Y | — | Staff:middleName | ActiveSchool−>schoolAdmin−>staff−> |
| Name | | | | | middleName |
| Principals Last Name | Y | Y | —Not Blank | Staff::lastName | ActiveSchool−>schoolAdmin−>Staff−> |
| | | | | | lastName |
| Principals Appendage | Y | Y | — | Staff::appendage | ActiveSchool−>schoolAdmin−>staff−> |
| | | | | | appendage |
| School Type | Y | Y | —Not Blank | SchoolType::code | ActiveSchool−>school−>schoolType−> |
| | | | | | code |

Post-Conditions

Load School Controls has populated persistent data for Schools, and Principals. The system log file has been updated recording the activity. If no errors were encountered the system is prepared to run the Instructor Content Load use case. If errors were encountered the load may or may not have been terminated.

Error/Warning Exceptions:

The following logging actions of activity, exceptions, and errors may occur during the load use case as referenced in this document:

AIP System Log file is appended to with Log of file load activity including Username, date time, and passed information including activity, state, file info (name, datetime, size).

Example:

ITUSER01, Sep. 1, 2000 23:20:15, School Controls Load,<PASSED ACTIVITY>, PFAPSCHL.txt, Aug. 25, 2000 01:09:03, 25256)

If exceptions are encountered during database activity, then AIP System Log file is appended to with the message in Error Log of file load activity including USERNAME, date time, Activity, STATUS, file info (name, datetime, size).

Example:

ITUSER01, Sep. 1, 2000 23:22:49, School Controls Load, REFRESH ERROR, PFAPSCHL.txt, Aug. 25, 2000 01:09:03, 25256, ERROR DESCRIPTION:<passed error description.)

The detail error information and the original record on a new line are recorded in the Load Exception file.

Security Exceptions: Only users with the role of ITOperator may perform loading functionality.

Additional Algorithm Detail:

The system loops through the AIP School Download file line by line. The record is fixed length format defined in the attachment section.

System extracts School Year from the record. If school year is not the same as value selected by user then output Exception Error 1 with message “Year does not match desired School Year—terminating Load” and Load processing is terminated.

Establish School

System extracts School Type from record and queries for existing School Type. If not found then write error as in Exception 2 with message being “ERROR School Type Not Found—School Not Processed”. Output record as in Exception 2 and continue processing at step 1 with next record. If found continue processing.

System extracts School Number from record and queries for existing School. If not found then create School with extracted school name, number, and type. If validation errors are encountered in mapping of data, then Exception 2 processing occurs. If School is found then system checks values from record of School name and school type with stored values and updates if different.

System queries for Active School with SchoolYear and School. If not found then create.

Establish Principal

If SchoolAdmin of type principal is not found then Query Staff with Employee Id extracted from record.

If Principal is not found among Staff then create Staff with employee id and name information extracted from record.

If Principal is found among Staff then compare non-key values and update if they have changed.

Create SchoolAdmin of type Principal. If validation errors are encountered in mapping of data, then Exception 2 processing occurs.

4(j). Use Case: Load Students

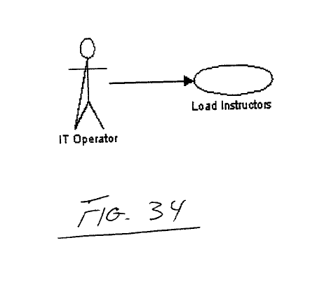

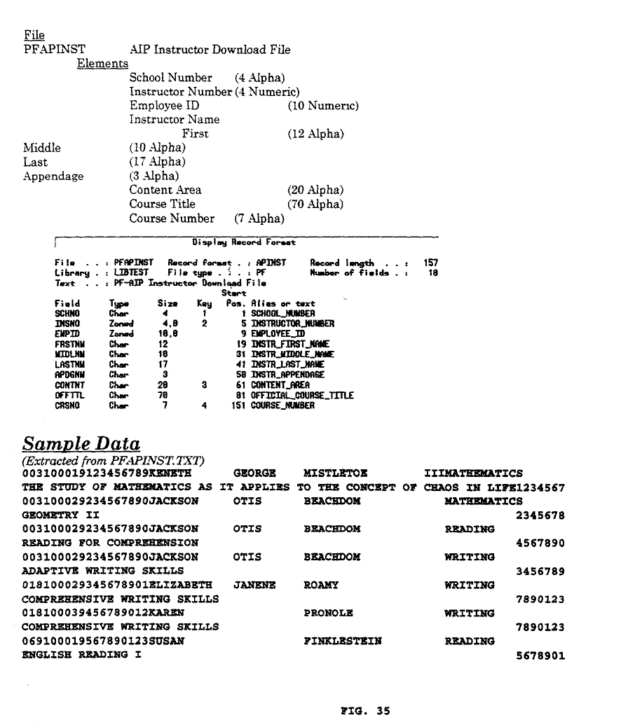

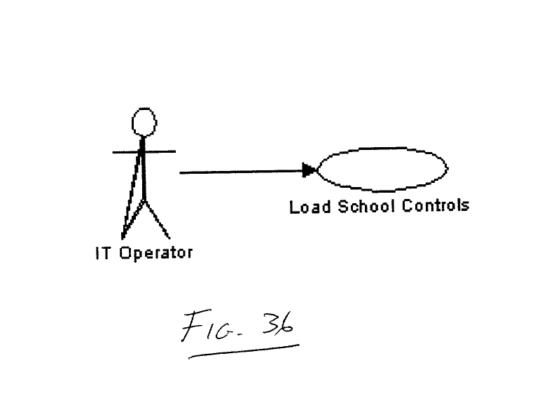

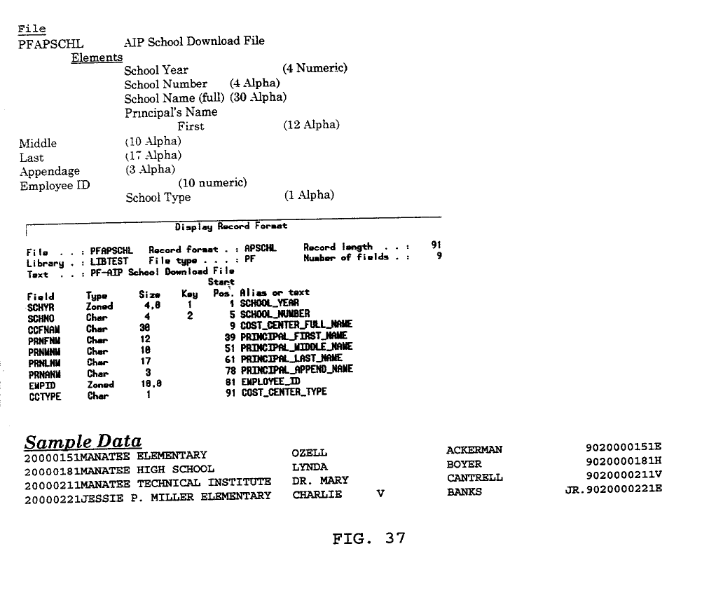

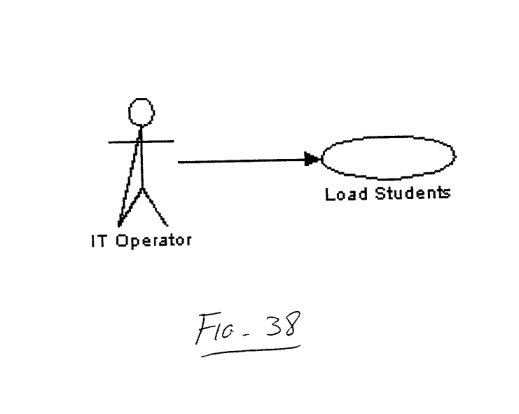

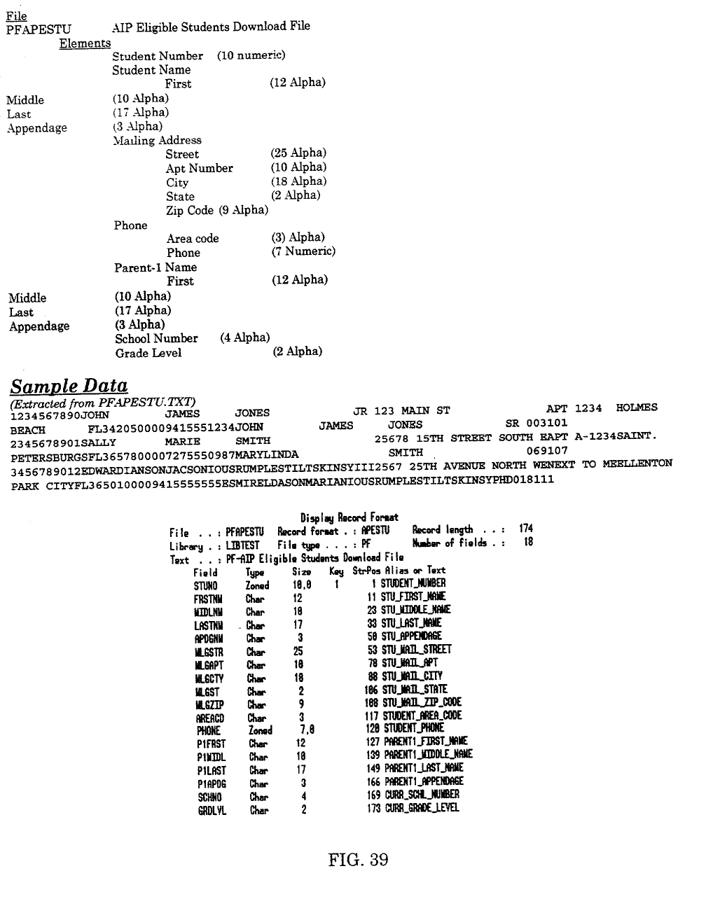

The purpose of this use case is to populate or update Student information for a District School for a particular year. An IT operator performs this activity primarily once per school year, in order to import the student information for that particular year. This use case represents the second step in a four step process to populate the AIP system for a particular school district year. See FIG. 38 and file format, Record Format and Sample Data of FIG. 39.

Actors: IT Operator

Pre-Conditions: The Load AIP School Controls use case has been run for the corresponding district and school year. This is necessary to ensure the establishment of the district schools for the active school year. If the district school has not been established for the school year, then an error message is displayed to the user: “District school for school year has not been established. Please load school controls for the requested school year.” The AIP Eligible Student Download File (PFAPESTU.txt) exists for the appropriate year, and is accessible from the local (server) file system. If the file is not available, system displays error “File not found for defined year. Please contact operations and have them generate the appropriate file for the load.”

Loading Students Include:

User identifies District to which the file pertains.

User identifies School Year for which load pertains. Default is pulled from active School Year.

User identifies qualified filename

User selects OK or Cancel. If Cancel nothing happens, Use Case ends.

System opens file and confirms existence of District School for Year for school number found in first record. If district school for identified school year is not found then message presented as in pre-condition. This step is done as a validation of the load file. It is not necessary for the maintenance of the student information.

If file matches, system prompts for confirmation, otherwise, file not found error is displayed.

On OK, system proceeds with load operation.

AIP System Log file is appended to with Log of file load activity including Username, date time, file info (name, datetime, size), username. (ie.ITUSER01, Sep. 1, 2000 23:20:15, Load Students, STARTED, PFAPESTU.txt, Aug. 25, 2000 01:09:03, 25256)

The system Loops through the download file line by line. Each record in file is a fixed length format.

The records are processed according to rules defined in additional algorithm section and field mappings. If validation errors are encountered, then AIP System Log file is appended to with the message in Error Log of file load activity including USERNAME, date time, Activity, STATUS, file info (name, datetime, size). (i.e. ITUSER01, Sep. 1, 2000 23:22:49, Load Students, REFRESH ERROR, PFAPESTU.txt, Aug. 8, 2000 01:09:03, 25256, ERROR DESCRIPTION: school->businessUnit may not be blank.) The detail error information plus the original record are recorded in the Load Exception file.

When Load completes, AIP System Log file is appended to with Log of file load activity including USERNAME, date time, Activity, STATUS, file info (name, datetime, size). (i.e. ITUSER01, Sep. 1, 2000 23:22:49, Load Students, REFRESH COMPLETED, PFAPESTU.txt, Aug. 25, 2000 01:09:03, 25256)

Field Mapping Includes:

| Field Name | Create | Update | Validation Rule | Attribute in Model | Relative path |
|---|---|---|---|---|---|
| Student Number | Y | N | ● Not Blank | Student::studentNumber | Student−>studentNumber |
| Student First | Y | Y | ● Not Blank | Student::firstName | |
| Name | | | | | Student−>firstName |
| Student Middle | Y | Y | ● | Student::middleName | |
| Name | | | | | Student−>middleName |
| Student Last Name | Y | Y | ● Not Blank | Student::lastName | Student−>lastName |
| Student | Y | Y | ● | Student::appendage | Student−>appendage |
| Appendage | | | | | |
| Mail Street | Y | Y | ● | Student::street | Student−>street |
| Mail Apt | Y | Y | ● | Student::aptNumber | Student−>aptNumber |
| Mail City | Y | Y | ● | Student::city | Student−>city |
| Mail State | Y | Y | ● | Student::state | Student−>state |
| Mail Zip Code | Y | Y | ● | Student::zip | Student−>zip |
| Area Code | Y | Y | ● | Student::areaCode | Student−>areaCode |
| Phone | Y | Y | ● | Student::phoneNumber | Student−>phoneNumber |
| Parent First Name | Y | Y | ● | Student::parent1FirstName | Student−>parent1FirstName |
| Parent Middle | Y | Y | ● | Student::parent1MiddleName | |
| Name | | | | | Student−>parent1MiddleName |
| Parent Last Name | Y | Y | ● | Student::parent1LastName | Student−>parent1LastName |
| Parent Appendage | Y | Y | ● | Student::parent1Appendage | Student−>parent1Appendage |
| School Number | | | ● | School::businessUnit | ****Not used in population**** |
| Grade Level | | | ● | | ****Not used in population**** |

Post-Conditions:

Load Students has populated persistent data for Students. The system log file has been updated recording the activity. If no errors were encountered the system is prepared to run the remaining use cases in the AIP Load process. If errors were encountered the load may or may not have been terminated.

Error/Warning Exceptions:

The following logging actions of activity, exceptions, and errors may occur during the load use case as referenced in this document:

AIP System Log file is appended to with Log of file load activity including Username, date time, and passed information including activity, state, file info (name, datetime, size).

Example:

ITUSER01, Sep. 1, 2000 23:20:15, Load Students,<PASSED ACTIVITY>, PFAPESTU.txt, Aug. 25, 2000 01:09:03, 25256)

If exceptions are encountered during database activity, then AIP System Log file is appended to with the message in Error Log of file load activity including USERNAME, date time, Activity, STATUS, file info (name, datetime, size).

Example:

ITUSER01, Sep. 1, 2000 23:22:49, Load Students, REFRESH ERROR, PFAPESTU.txt, Aug. 25, 2000 01:09:03, 25256, ERROR DESCRIPTION:<passed error description.)

The detail error information and the original record on a new line are recorded in the Load Exception file.

Security Exceptions: Only users with the role of ITOperator may perform loading functionality.

Additional Algorithm Detail:

The system loops through the AIP Student Download file line by line. The record is fixed length format defined in the attachment section.

System extracts School number from the record and queries for pre-existing district school for designated school year (Active School). If the active school does not exist then system outputs exception error 1 with message “No ActiveSchool for school year. Please load school controls. Terminating load.” Load processing is terminated.

Establish Student—System extracts Student Number from record and queries for existing Student.

If not found then create Student with extracted student name, address, and parent information. If validation errors are encountered in mapping of data, then Exception 2 processing occurs.

If Student is found then system checks values from record of Student information with stored values and updates if different.

4(k). Use Case: Main Menu

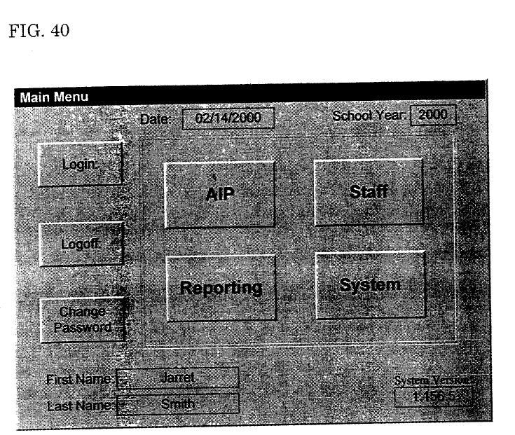

This use case describes the initial screen presented to all users of the AIP program. This screen provides module access to: User Authentication, Change Passwords, AIP, Reporting, Staff, and System. It also displays information for the current date, active school year, system version, and the user currently logged into the system. Prior to user authentication, the only option available to users is the Login button. All other buttons on the “Main Menu” are dimmed and not accessible. The security level of the user limits access to the other areas of the AIP program. See FIG. 25 and screen of FIG. 40.

Actors: All Users

Main Menu Includes:

Login: The user selects the Login button to begin the User Authentication Use Case. If a user is already logged into the system, the Login button is dimmed and inaccessible.

Logoff: The user selects the Logoff button to end the user's session with the system.

Change Password: The user selects the Change Password button to begin the Change Password Use Case. If no user is currently logged in, the Change Password button is dimmed and inaccessible.

AIP: The user selects the AIP button to begin the “Maintain AIP” Use Case. Access to this option is restricted by the User's security level (see Additional Rules).

Staff: The user selects the Staff button to begin the “Maintain Staff” Use Case. Access to this option is restricted by the User's security level (see Additional Rules).

Reporting: The user selects the Reporting button to begin the “Maintain Reports” Use Case. Access to this option is restricted by the User's security level (see Additional Rules).

System: The user selects the System button to begin the “Maintain System” Use Case. Access to this option is restricted by the User's security level (see Additional Rules).

Field Mapping:

| | | | Default | Validation | Attribute |
|---|---|---|---|---|---|
| Field Name | Create | Update | Value | Rule | in Model |
| Current Date: | n | n | Today's | | |
| | | | Date | | |
| Active Year: | n | n | System | | |
| | | | Defined | | |
| System Version | N | N | System | | |
| | | | Defined | | |
| First Name: | | | | | Staff:firstName |
| Last Name: | | | | | Staff:lastName |

| | Login/Logoff, | | | | |
|---|---|---|---|---|---|
| | Change | | | | |
| Actors | Password | AIP | Staff | Reporting | System |
| Teacher | Yes | Yes | | Yes | |
| Principal | Yes | Yes | Yes | Yes | |
| Guidance Counselor | Yes | Yes | Yes | Yes | |
| Assistant Principal | Yes | Yes | Yes | Yes | |
| School Registrar | Yes | Yes | Yes | Yes | |
| AIP Administrator | Yes | Yes | Yes | Yes | Yes |
| IT Operator | Yes | Yes | Yes | Yes | Yes |

If a user does not have access to one of the above options, it is dimmed and inaccessible for that user.

Related Use Cases:

User Authentication

Change Passwords

Maintain AIP

Maintain Reports

Maintain Staff

Maintain System

4(l). Use Case: Maintain AIP

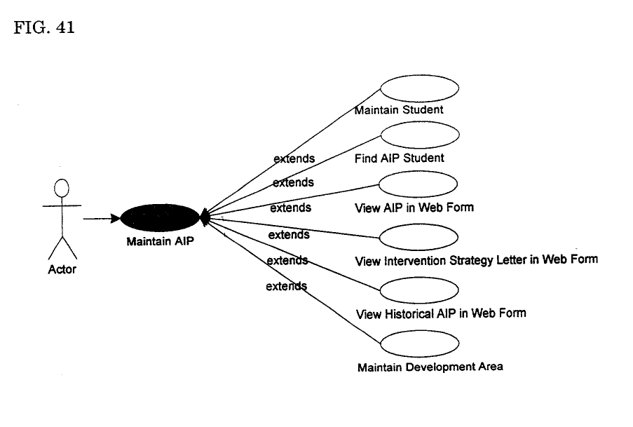

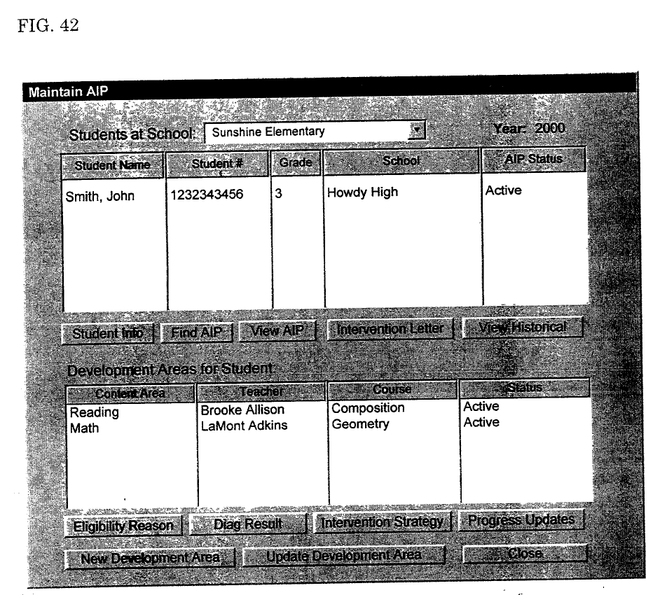

The Maintain AIP use case is used to display and query AIP information for students. The displayed AIP information includes information such as: Student Name, Student Number, Grade, School, and AIP Status. Student Information may be updated via the Student Info button. Other areas of the AIP system can be reached from the AIP menu, such as: Find AIP Student, View AIP, View Intervention Letter, and View Historical AIP information. Access to the Maintain AIP operations is limited by the security access of the user. By default, students are filtered and displayed automatically to the user depending on their access level and their association to students. See FIG. 41 and screen of FIG. 42.

Actors: Instructor, School Admin and District Admin

Maintenance Includes:

Student Info: The user selects a student from the displayed students and presses the Students... button to go to the “Maintain Student” Use Case for the currently selected student. If no Student is highlighted, then a warning message is displayed (see Error/Warning Exception#1).

Find AIP Student: The user presses the Find AIP button to go to the “Find AIP Student” use case, which allows the user to locate an AIP student from within the access level restrictions defining the user's students access.

View AIP: The user selects a student from the displayed students and presses the Print AIP button to go to the “View AIP in Web Form” use case, which will present the AIP for the currently selected student in the user's default Web Browser. If no Student is highlighted, then a warning message is displayed (see Error/Warning Exception#1).

Intervention Letter: The user selects a student from the displayed students and presses the Intervention Letter button to go to the “View Intervention Strategy Letter in Web Form” Use Case, which will present the Intervention Letter for the selected student in the user's default Web Browser. If no Student is highlighted, then a warning message is displayed (see Error/Warning Exception#1).

View Historical: The user selects a student from the displayed students and presses the View Historical button to go to the “View Historical AIP in Web Form” Use Case, which will present the Historical AIPs for the selected student in the user's default Web Browser. If no Student is highlighted, then a warning message is displayed (see Error/Warning Exception#1).

Done: The user may select the Done button to close the current screen and return to the previous screen.

Field Mapping:

| | | | | Validation | |
|---|---|---|---|---|---|
| Field Name | Create | Update | Default Value | Rule | Attribute in Model |
| Maintain AIP | | | | | |
| Student First Name | N | N | None | | Student:firstName |
| Student Last Name | N | N | None | | Student:lastName |
| Student Number | N | N | None | | Student:studentNumber |
| School Name | N | N | User's Current School | | School:name |
| Grade Level | N | N | None | | Grade:value |
| Creation Date | N | N | Current Date | | AIP:CreationDate |
| School Year | N | N | Current Year | | SchoolYear:name |
| Find AIP Screen | | | | | |
| First Name | N | N | None | | Student:firstName |
| Last Name | N | N | None | | Student:lastName |
| Student Number | N | N | None | | Student:studentNumber |
| AIP Status | N | N | Active | | AIPStatus:description |
| Dev Area Status | N | N | None | | |
| School Name | N | N | User's Current School | | School:name |
| Content Area: | N | N | None | | ContentArea:description |
| Grade Level | N | N | None | | Grade:value |
| Instructor: | N | N | None | | |

If the user does not make a selection before pressing the OK button, the following message will be displayed: “Please make a selection before proceeding.”

If a user attempts to press the OK button, but a validation rule is not met (see Field Mappings), an error message will be displayed which prompts the user to: “Please enter all data correctly in the required fields.” The user is then able to press the OK button to retry entering the proper data.

Security Exceptions: The Instructor and School Admin have full access to all screen displays and operations on the “AIP Menu.” The District Admin is able to view the displayed students for all schools, Find AIP, View AIP, Print Intervention Strategy Letter, View Historical. They are able to view but not maintain: Eligibility Reason, Diagnostic Results, Intervention Strategy, Progress Reports, Maintain Development Area.

Additional Rules:

Actor Use Case Access:

| | Instructor | School Admin | District Admin |
|---|---|---|---|
| Students | Yes | Yes | Yes |
| Find AIP | Yes | Yes | Yes |
| Print AIP | Yes | Yes | Yes |
| Print Intervention Letter | Yes | Yes | Yes |
| View Historical | Yes | Yes | Yes |

If a user does not have access to one of the above options, it is dimmed and inaccessible for that user.

AIP Status: The status of the AIP is automatically determined based upon the status of the Development Areas. When all the Development Areas are “Inactive,” the AIP Status becomes “Inactive.”

Related Use Cases:

Maintain Student

Find AIP Student

Maintain Development Area

View AIP in Web Form

View Intervention Strategy Letter in Web Form

View Historical AIP in Web Form

Maintain Development Area

4(m). Use Case: Maintain Development Area

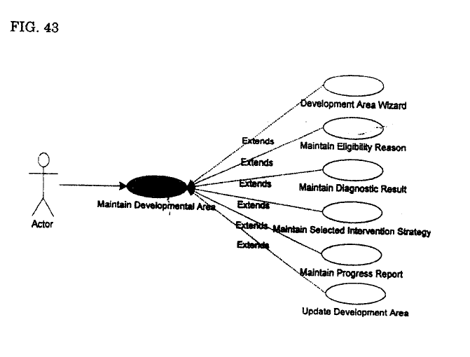

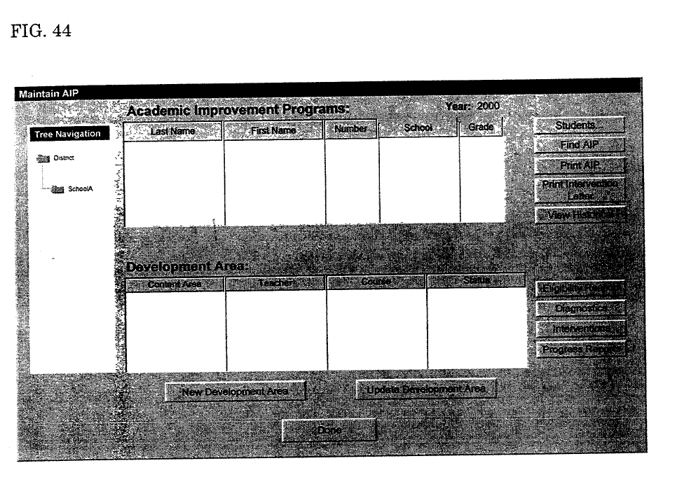

The Maintain Development Area use case is used to display and update Development Area information for a selected student. The displayed Development Area information includes basic information such as: Content Area, Teacher, Course, and Current AIP Status. Other areas of the AIP system can be reached from the Development Area screen, such as: Development Area Wizard, Eligibility Reasons, Diagnostics, Interventions, and Progress Reports. Access to the Maintain Development Area operations is limited by the security access of the user. By default, students are selected via the AIP interface depending on their access level, and student Development Area information is displayed. See FIG. 43 and screen of FIG. 44.

Actors: Teacher, Principal, Guidance Counselor, District Admin, and Academic.

Pre-Conditions: The Development Area menu works in conjunction with the AIP menu to display information. The user must select a student via the Academic Improvement Program menu before Development Area information will be displayed. If the user does not select a student, no Development Area information will be displayed.

Maintenance Includes:

Update Development Area

The user selects the Update Development Area button to modify student information.

The “Update Development Area” screen is displayed to the user.

The user modifies proper information, by choosing from the list or combo boxes.

The user selects the OK button to update Development Area information. If all necessary data has been completed (see Field Mappings), and passes validation, then the Development Area information is updated in the system. If a validation rule is not met, a warning message is displayed (see Error/Warning Exception#2). The user is returned to the “Maintain AIP” screen.

If the user selects the Cancel button, then no modifications are made to the system, and the user is returned to the “Maintain AIP” screen.

Eligibility Reason: The user selects a student from the displayed students and presses the Eligibility Reason button to go to the “Eligibility Reasons” screen for the currently selected student. If no Student is highlighted, then a warning message is displayed (see Error/Warning Exception#1).

Diagnostics: The user selects a student from the displayed students and presses the Diagnostics button to go to the “Diagnostics” screen for the currently selected student. If no Student is highlighted, then a warning message is displayed (see Error/Warning Exception#1).

Interventions: The user selects a student from the displayed students and presses the Interventions button to go to the “Interventions” screen for the currently selected student. If no Student is highlighted, then a warning message is displayed (see Error/Warning Exception#1).

Progress Reports: The user selects a student from the displayed students and presses the Progress Reports button to go to the “Progress Reports” screen for the currently selected student. If no Student is highlighted, then a warning message is displayed (see Error/Warning Exception#1).

Create Development Area Wizard: The user presses the Create Development Area Wizard button to begin the Development Area Wizard. The Development Area Wizard handles the creation of students, AIPs, Development Areas, and Eligibility Factors.

Field Mapping:

| | | | Default | | |
|---|---|---|---|---|---|
| Field Name | Create | Update | Value | Validation Rule | Attribute in Model |
| Display Only: | | | | | |
| Content Area | | | | | ContentArea:description |
| Teacher | | | | | Instructor:InstructorName |
| Course | | | | In Pick List | InstructorContentArea:course |
| Development Area | | | | In Pick list | CompletionDisposition:description |
| Status | | | | | |
| Update DA | | | | | |
| Screen: | | | | | |
| GradeQ1 | | | | | Development Area:gradeQ1 |
| GradeQ2 | | | | | Development Area:gradeQ2 |
| GradeQ3 | | | | | Development Area:gradeQ3 |
| GradeQ4 | | | | | Development Area:gradeQ4 |
| Content Area | | | | | ContentArea:description |
| Teacher | | | | Not editable by | Instructor:InstructorName |
| | | | | teacher | |
| | | | | If actor is a principle- | |
| | | | | edit field will list any | |
| | | | | teacher for the content | |
| | | | | area for school in | |
| | | | | which user is a | |
| | | | | principal | |
| | | | | If Counselor- edit | |
| | | | | field will list any | |
| | | | | teacher for the content | |
| | | | | area for school in | |
| | | | | which user is a | |
| | | | | counselor | |
| | | | | If District Admin- edit | |
| | | | | field will list any | |
| | | | | teacher for the content | |
| | | | | area for schools in the | |
| | | | | district. | |
| Course | | | | Courses only | InstructorContentArea:course |
| | | | | displayed in the | |
| | | | | content area for which | |
| | | | | the above teacher is | |
| | | | | the instructor. | |
| Status | | | | | CompletionDisposition:description |
| Date Created | | | | | DevelopmentArea:creationDate |
| Student First | | | | | Student:firstName |
| Student Last | | | | | Student:lastName |
| Student Number | | | | | Student:studentNumber |
| Grade Level | | | | | Grade:value |

Error/Warning Exceptions:

If the user does not make a selection before pressing the OK button, the following message will be displayed: “Please make a selection before proceeding.”

If a user attempts to press the OK button, but a validation rule is not met (see Field Mappings), an error message will be displayed which prompts the user to: “Please enter all data correctly in the required fields.” The user is then able to press the OK button to retry entering the proper data.

Additional Rules:

Actor Use Case Access:

| | | | | District | |
|---|---|---|---|---|---|
| | Teacher | Principal | Counselor | Admin | Academic |
| Eligibility | Yes | Yes | Yes | Read | TBD |
| Reasons | | | | | |
| Diagnostics | Yes | Yes | Yes | Read | TBD |
| Interventions | Yes | Yes | Yes | Read | TBD |
| Progress Reports | Yes | Yes | Yes | Read | TBD |
| New Develop | Yes | Yes | Yes | | TBD |
| Area | | | | | |
| Update Develop | Yes | Yes | Yes | Read | TBD |
| Area | | | | | |

Related Use Cases:

Development Area Wizard

Maintain Eligibility Reason

Maintain Diagnostic Results

Maintain Selected Intervention Strategies

Maintain Progress Reports

4(n). Use Case: Maintain Diagnostic Results

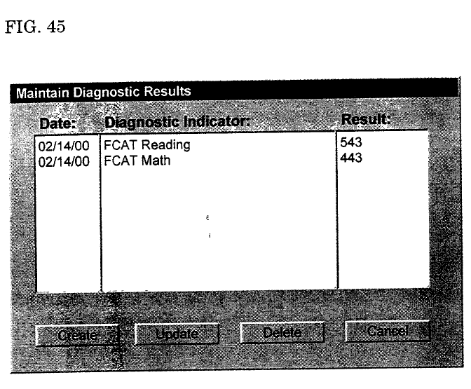

The Maintain Diagnostic Results use case is used to display and maintain diagnostic results for a selected Development Area for a student. Maintenance operations include creating, updating, and deleting of diagnostic results. The displayed diagnostic results information includes basic information such as: Date, Title of Diagnostic Indicator, and the diagnostic result. Access to the Maintain Diagnostic Results operations is limited by the security access of the user. See FIG. 43 and screen of FIG. 45.

Actors: Teacher, Guidance and Principal

Pre-Conditions: There must be a Development Area selected for a student.

Maintenance includes:

Create Diagnostic Result:

The user selects the Create button to add a new Diagnostic Result.

The “Create Diagnostic Result” screen is displayed with the default values pre-entered.

The user enters new Diagnostic Result information, as per each field definition.

The user selects OK to add the Diagnostic Result. If all necessary data has been completed (see Field Mappings), and passes validation, then the Diagnostic Result is created and added to the system. If a validation rule is not met, a warning message is displayed (see Error/Warning Exception#2).

The user is returned to the “Maintain AIP” screen.

If the user selects Cancel, then no modifications are made to the system, and the user is returned to the “Maintain Diagnostic Result” screen.

Update Diagnostic Result:

The user highlights a Diagnostic Result, and selects the Update button to modify Diagnostic Result data. If no Diagnostic Result is highlighted, then a warning message is displayed (see Error/Warning Exception#1).

The “Update Diagnostic Result” screen is displayed with a listing of the Diagnostic Result's current information. Fields are enabled according to the definitions in Field Mappings.

The user modifies Diagnostic Result information per each field definition.

The user selects OK to update Diagnostic Result data. If all necessary data has been completed (see Field Mappings), and pass validation, then the Diagnostic Result is updated in the system. If a validation rule is not met, a warning message is displayed (see Error/Warning Exception#2).

The user is returned to the “Maintain Diagnostic Result” screen, with the modified Diagnostic Result highlighted.

If the user selects Cancel, then no modifications are made to the system, and the user is returned to the “Maintain Diagnostic Result” screen.

Delete Diagnostic Result:

The user highlights a Diagnostic Result, and selects the Delete button to delete a Diagnostic Result and it's associated data. If no Diagnostic Result is highlighted, then a warning message is displayed (see Error/Warning Exception#1). A “Verify Delete?” window is displayed to user. If the user selects Yes, then the selected Diagnostic Result is deleted. If the user selects No, then no modifications are made to the system, and the user is returned to the “Maintain Diagnostic Result” screen, with the selected entry highlighted.

Field Mapping:

| Field Name | Create | Update | Default Value | Validation Rule | Attribute in Model |
|---|---|---|---|---|---|
| Date | Y | Y | Current Date | Not Blank | DiagnosticResult:date |
| Diagnostic Indicator | Y | Y | Blank | Not Blank | DiagnosticResult:title |
| Result | Y | Y | Blank | Not Blank | DiagosticResult:result |

Error/Warning Exceptions:

If the user does not make a selection before pressing the OK button, the following message will be displayed: “Please make a selection before proceeding.”

If a user attempts to press the OK button, but a validation rule is not met (see Field Mappings), an error message will be displayed which prompts the user to: “Please enter all data correctly in the required fields.” The user is then able to press the OK button to retry entering the proper data.

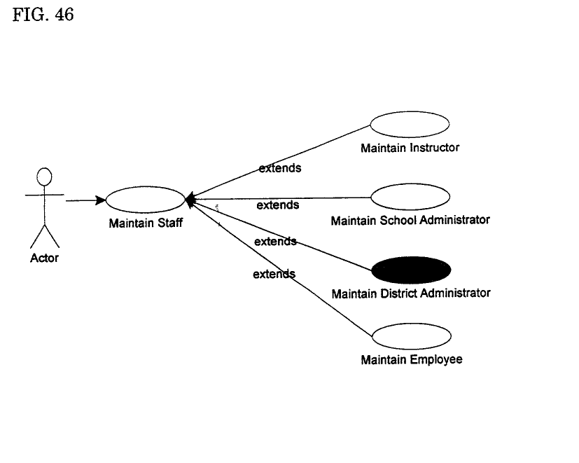

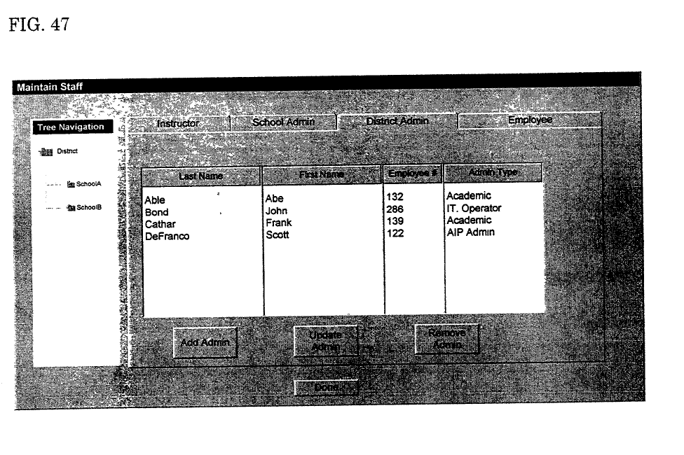

4(o). Use Case: Maintain District Administrator The “Maintain District Administrator” Use Case is used to Add, Update, or Delete District Administrators. The Tree Navigator Tool is visible but not utilized with this Use Case. District Administrator information includes fields such as Last Name, First Name, Employee ID, and Administrator Type. Access to the “Maintain District Administrator” operations is limited by the security access of the user. See FIG. 46 and screen of FIG. 47.

Actors: I.T. Operator and AIP Administrator

Pre-Conditions: Employee must exist in the system.

Add District Administrator Includes:

The user selects the Add Admin button to add a new Administrator to the district. Any selections in the District Administrator list display are ignored during this process.

The “Add Employee as District Administrator” screen is displayed, requesting the Employee ID of the employee to be added as an Administrator for the district. The user enters an Employee ID and presses OK. If all necessary data has been completed (see Field Mappings), and passes validation, then the user is presented with the “District Administrator Type” screen. If a validation rule is not met, a warning message is displayed (see Error/Warning Exception#2). If the user selects the Cancel button, then the user is returned to the previous screen.

The “District Administrator Type” screen is displayed, allowing the user to select the employee's District Administrator type for the district and press the OK button. If all necessary data has been completed (see Field Mappings), and passes validation, the District Administrator is added to the system and the user is returned to the previous menu. If the user selects the Cancel button, then no information is added to the system, and the user is returned to the previous screen.

Update District Administrator:

The user selects a District Administrator from the list display.

The user selects the Update Admin button to update the employee's District Administrator type.

The “District Administrator Type” screen is displayed, allowing the user to change the employee's District Administrator type for the district and press the OK button. . If all necessary data has been completed (see Field Mappings), and passes validation, the District Administrator Type is updated and the user is returned to the previous menu. If the user selects the Cancel button, then the user is returned to the previous screen.

Remove District Administrator:

The user highlights a District Administrator, and selects the Remove Admin button to delete an Administrator and it's associated data. If no District Administrator is highlighted, then a warning message is displayed (see Error/Warning Exception#1).

A “Confirm Deletion?” window is displayed to user. If the user selects Yes, then the selected District Administrator is deleted. If the user selects No, then no modifications are made to the system, and the user is returned to the previous screen.

Field Mapping:

| Field Name | Create | Update | Default Value | Validation Rule | Attribute in Model |
|---|---|---|---|---|---|
| Display List: | | | | | |
| Last Name | N/A | N/A | | | Staff:lastName |
| First Name | N/A | N/A | | | Staff:firstName |
| Employee ID | N/A | N/A | | | Staff:employeeID |
| Admin Type | N/A | N/A | | | DistrictAdminType:description |
| Tree Navigator Tool | | | | | |
| (Tree Selection) | N/A | N/A | Current District | Not editable | District:description |
| Add Employee as | | | | | |
| District Administrator | | | | | |
| Employee ID | N/A | N/A | | Not blank | Staff:employeeID |
| | | | | Exists in | |
| | | | | database | |
| | | | | Not already a | |
| | | | | District Admin | |
| District Administrator | | | | | |
| Type | | | | | |
| Employee | N/A | N/A | | Not editable | Staff:firstName + |
| | | | | | Staff:lastName |
| District | N/A | N/A | | Not editable | District:description |
| Admin Type | Yes | Yes | | In pick list | DistrictAdminType:description |
| | | | | Not blank | |
| Status | Yes | Yes | ACTIVE | | DistrictAdminType:Status |

Post-Conditions: The database may exist in a new state if a District Administrator has been added, updated, or deleted.

Alternate Course:

Add District Administrator:

From the “Add Employee as District Administrator” screen: If the Employee ID is not found, the “Employee ID not found” screen is displayed to the user, instructing them to add the employee to the system using the Staff tab function. (See attachments). The user may select the OK button to return to the previous screen.

From the “Add Employee as District Administrator” screen: If the Employee ID is found, but is already an Administrator of the district, the “District Administrator Exists” screen is displayed to the user, informing them that: “the employee is already an District Administrator.” (See attachments). The user may select the OK button to return to the “Maintain Employee” screen with that District Administrator highlighted in the display listing.

Error/Warning Exceptions:

If the user does not make a selection before pressing the OK button, the following message will be displayed: “Please make a selection before proceeding.”

If a user attempts to press the OK button, but a validation rule is not met (see Field Mappings), an error message will be displayed which prompts the user to: “Please enter all data correctly in the required fields.” The user is then able to press the OK button to retry entering the proper data.

Additional Rules:

The following chart defines Actor access to the use case options:

| Actors: | | |
|---|---|---|
| Options: | I.T. Oper | AIP Admin |
| Add District Admin | Yes | Yes |
| Update District Admin | Yes | Yes |
| Remove District Admin | TBD | TBD |

A District Administrator cannot be deleted if he/she has a Development Area or Progress Report reference. If the user attempts to delete a District Administrator with these references, a Dialog box appears informing the user that the action cannot be completed because the District Administrator is being referenced to either Development Areas or Progress Reports.

4(p). Use Case: Maintain Eligibility Reasons

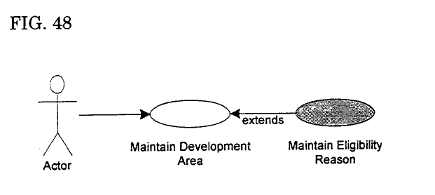

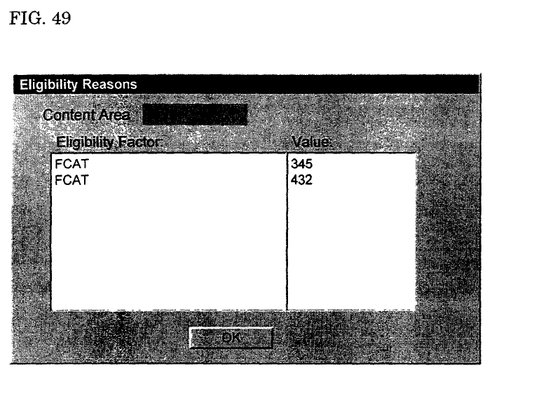

This use case allows the user to view the Eligibility Reasons for an Development Area of a selected student. The “Eligibility Reasons” screen is composed of the Content Area, Eligibility Factor, and a Value. The screen is for reference information only, and cannot be edited by the user. Access to the “Eligibility Reasons” screen is limited by the security access of the user. See FIG. 48 and screen of FIG. 49.

Actors: Teacher, Guidance, Principal

Pre-Conditions: A Development Area must be selected from the “Maintain AIP” screen.

Maintenance includes: The Eligibility Reasons screen is displayed for informational purposes only, the user is returned to the “Maintain AIP” screen when the OK button is pressed.

Field Mapping:

| | | | | | |
|---|---|---|---|---|---|
| Field Name | Create | Update | Default Value | Validation Rule | Attribute in Model |

| | | | |
|---|---|---|---|
| Content Area | N | N | ContentArea:description |
| Eligibility | N | N | EligibilityFactor:description |
| Factor | | | |
| Value | N | N | EligibilityCriteriaReason:value |

Error/Warning Exceptions:

If the user does not make a selection before pressing the OK button, the following message will be displayed: “Please make a selection before proceeding.”

If a user attempts to press the OK button, but a validation rule is not met (see Field Mappings), an error message will be displayed which prompts the user to: “Please enter all data correctly in the required fields.” The user is then able to press the OK button to retry entering the proper data.

4(q). Use Case: Maintain Employee

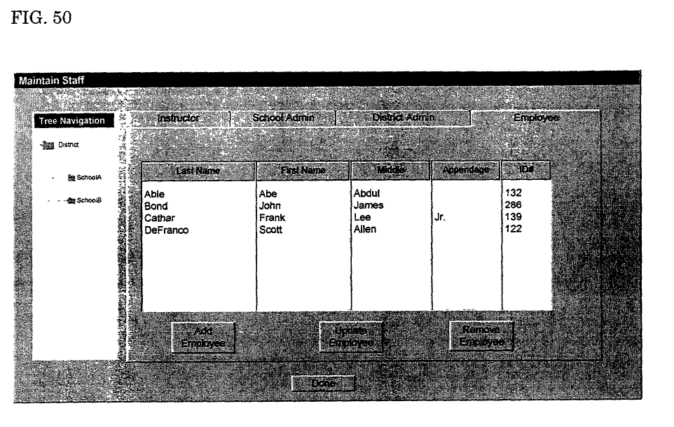

The “Maintain Employee” Use Case is used to Add, Update, or Delete Employees from the District. The Tree Navigator Tool is not utilized for this Use Case. Employee information includes fields such as Last Name, First Name, Middle Name, Appendage, and Employee ID. Access to the “Maintain Employee” operations is limited by the security access of the user. See FIG. 46 and screen of FIG. 50.

Actors: IT Operator and AIP Administrator

Maintenance includes:

Add Employee: The user selects the Add Employee button to add a new Employee to the district. Any selections in the Employee list display are ignored during this process.

The “Employee” screen is displayed, requesting Employee information for the employee to be added to the district. If all necessary data has been completed (see Field Mappings), and passes validation, then the employee is added to the system, and the user is returned to the previous menu. If a validation rule is not met, a warning message is displayed (see Error/Warning Exception#2). If the user selects the Cancel button, then the user is returned to the previous screen.

Update Employee: The user selects an Employee from the list display.

The user selects the Update Employee button to update the Employee's information.

The “Employee” screen is displayed, allowing the user to change the employee's information. If all necessary data has been completed (see Field Mappings), and passes validation, selecting the OK button updates the system and the user is returned to the previous menu. If the user selects the Cancel button, then no data is updated to the system, and the user is returned to the previous screen.

Remove Employee: The user highlights an Employee, and selects the Remove Employee button to delete an Employee and it's associated data. If no Employee is highlighted, then a warning message is displayed (see Error/Warning Exception#1).

A “Confirm Deletion?” window is displayed to user. If the user selects Yes, then the selected Employee is deleted. If the user selects No, then no modifications are made to the system, and the user is returned to the previous screen.

Field Mapping:

| Field Name | Create | Update | Default Value | Validation Rule | Attribute in Model |
|---|---|---|---|---|---|
| Display List: | | | | | |
| Last Name | N/A | N/A | | | Staff:lastName |
| First Name | N/A | N/A | | | Staff:firstName |
| Middle | N/A | N/A | | | Staff:middleName |
| Appendage | N/A | N/A | | | Staff:appendage |
| Employee ID | N/A | N/A | | | Staff:employeeID |
| Tree Navigator Tool | | | | | |
| (Tree Selection) | N/A | N/A | Current District | Not editable | District:description |
| Employee Screen: | | | | | |
| Last Name | Yes | Yes | | Not blank | Staff:lastName |
| First Name | Yes | Yes | | Not blank | Staff:firstName |
| Middle | Yes | Yes | | | Staff:middleName |
| Appendage | Yes | Yes | | | Staff:appendage |
| Employee ID | Yes | Yes | | Unique | Staff:employeeID |
| Password: | Yes | Yes | | Echoed as * | SFSystemUser:password |
| | | | | character | |
| Status | Yes | Yes | Active | In Pick List | SFSystemUser:active |

Post-Conditions: The database may exist in a new state if an Employee has been added, updated, or deleted.

Alternate Course: From the “Employee” screen: If the Employee ID already exists in the system, the “Employee ID Exists” screen is displayed to the user, informing them that: “The employee ID is already in the system.” (See attachments). The user may select the OK button to return to the “Maintain Employee” screen with that Employee highlighted in the display listing.

Error/Warning Exceptions:

If the user does not make a selection before pressing the OK button, the following message will be displayed: “Please make a selection before proceeding.”

If a user attempts to press the OK button, but a validation rule is not met (see Field Mappings), an error message will be displayed which prompts the user to: “Please enter all data correctly in the required fields.” The user is then able to press the OK button to retry entering the proper data.

Security Exceptions:

| Additional Rules: Actors: | | |
|---|---|---|
| Options: | I.T. Oper | AIP Admin |
| Add Employee | Yes | Yes |
| Update Employee | Yes | Yes |
| Remove Employee | TBD | TBD |

1) If the user changes Employee Status to Inactive and presses OK, all positions the employee holds in other areas of the system (Instructor, School Admin, District Admin, etc) are also changed to “Inactive.”

2) An Employee cannot be deleted if he/she is an Instructor, School Administrator, or District Administrator. If the user attempts to delete an Employee still holding one of these positions, a Dialog box appears informing the user that the action cannot be completed because the Employee still holds a staff position in the system.

4(r). Use Case: Maintain Instructor Course

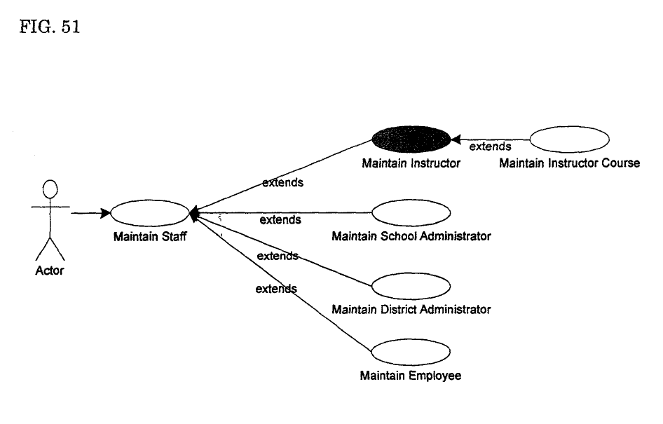

The Maintain Instructor Course use case is used to display and maintain courses for an Instructor. The school and instructor are selected via the “Maintain Instructor” Use Case. Maintenance operations include viewing an instructor's course(s), adding courses, and removing courses from an Instructor. The displayed Course information includes information such as: Content Area, Course Number, and Course Name. Access to the Maintain Instructor Course operations is limited by the security access of the user. See FIG. 51 and screen of FIG. 52.

Actors: IT Operator, Principal, Assistant Principal, School Registrar, Guidance Counselor, AIP Administrator.

Pre-Conditions:

Employee must exist in the system.

Instructor must be selected in the Maintain Instructor screen.

Maintenance Includes:

The user selects a Content Area from the “Available Courses for Content Area” pick list. The available courses will be listed below in the left display window. These courses have not been assigned to the Instructor, and are available for assignment.

To add a course to an Instructor, the user selects a course from the available courses in the left display window and presses the >> button. The course will be moved from the left display window to the right display window. If the >> button is pressed without a course being selected, no course move will occur.

The course listed in the right display window have been assigned to the Instructor, and are able to be removed via the << button.

To remove a course to an Instructor, the user selects a course from the assigned courses in the right display window and presses the << button. The course will be moved from the right display window to the left display window. If the << button is pressed without a course being selected, no course move will occur.

When the user has finished editing the Intervention Strategies, pressing the Done button will close the screen.

Field Mapping:

| | | Up- | Default | Validation | Attribute |
|---|---|---|---|---|---|
| Field Name | Create | date | Value | Rule | in Model |
| Pick List | | | | | |
| Content Area | N/A | N/A | Mathematics | | |
| Instructor | | | | | |
| Name: | | | | | |
| Selected | N/A | N/A | | | Staff:lastName |
| Courses for | | | | | Staff:firstName |
| Instructor: | | | | | |
| Course | | | | | |
| Displays: | | | | | |
| Content Area | N/A | N/A | | | |
| Course # | N/A | N/A | | | |
| Course Title | N/A | N/A | | | |

Post-Conditions: The database may exist in a new state if a course has been added or removed from an Instructor.

Related Use Cases: Maintain Instructor.

4(s). Use Case: Maintain Instructor

The “Maintain Instructor” Use Case is used to Add, Update, or Delete Instructors for a specific school. The school is selected via the Tree Navigation Tool. When a school is selected on the Tree Navigation Tool, the school's instructors are shown in the display list. Instructor information includes fields such as Last Name, First Name, Instructor Number, and Employee ID. The “Maintain Course for Instructor” use case may be accessed via the “Maintain Instructor” screen. Access to the “Maintain Instructor” operations is limited by the security access of the user. See FIG. 51.

Actors: IT Operator, Principal, Assistant Principal, School Registrar, Guidance Counselor, AIP Administrator.

Pre-Conditions:

Employee must exist in the system.

User must select a school via the Tree Navigation Tool.

Maintenance includes:

Add Instructor:

The user selects the Add Instructor button to add a new instructor to the selected school. Any selections in the instructor list display are ignored during this process.

The “Add Employee as Instructor” screen is displayed, requesting the Employee ID of the employee to be added as an instructor for the selected school. The user enters an Employee ID and presses OK. If all necessary data has been completed (see Field Mappings), and passes validation, then the user is presented with the “Instructor Number” screen. If a validation rule is not met, a warning message is displayed (see Error/Warning Exception#2). If the user selects the Cancel button, then the user is returned to the previous screen.

The “Instructor Number” screen is displayed, allowing the user to enter the employee's Instructor Number for the selected school and press the OK button. If all necessary data has been completed (see Field Mappings), and passes validation, the Instructor is added to the school, and the user is returned to the previous menu. If the user selects the Cancel button, then no information is saved to the system, and the user is returned to the previous screen.

Update Instructor: The user selects an Instructor from the list display. The user selects the Update Instructor button to update the employee's Instructor Number.

The “Instructor Number” screen is displayed, allowing the user to change the employee's Instructor Number for the selected school and press the OK button. If all necessary data has been completed (see Field Mappings), and passes validation, the Instructor Number is updated in the system and the user is returned to the previous menu. If the user selects the Cancel button, no data is saved to the system, and the user is returned to the previous screen.

Remove Instructor: The user highlights an Instructor, and selects the Remove button to delete an Instructor and it's associated data. If no Instructor is highlighted, then a warning message is displayed (see Error/Warning Exception#1).

A “Confirm Deletion?” window is displayed to user. If the user selects Yes, then the selected Instructor is deleted. If the user selects No, then no modifications are made to the system, and the user is returned to the previous screen, with the selected entry highlighted.

Field Mapping:

| Field Name | Create | Update | Default Value | Validation Rule | Attribute in Model |
|---|---|---|---|---|---|
| Display List | | | | | |
| Last Name | N/A | N/A | | | Staff:lastName |
| First Name | N/A | N/A | | | Staff:firstName |
| Employee ID | N/A | N/A | | | Staff:employeeID |
| Instructor Number | N/A | N/A | | | Instructor:instructorNumber |
| Tree Navigator Tool | N/A | N/A | | Selection required | School:name |
| (Tree School Selection) | | | | | |
| Add Employee as | | | | | |
| Instructor | | | | | |
| Employee ID | Yes | N/A | | Not blank | Staff:employeeID |
| | | | | Exists in database | |
| | | | | Not exist already as | |
| | | | | instructor at this | |
| | | | | school | |
| Instructor Number | | | | | |
| Employee | N/A | N/A | | Not editable | Staff:firstName + |
| | | | | | Staff:lastName |
| School | N/A | N/A | | Not editable | School:name |
| Instructor Number | Yes | Yes | | Unique for the | Instructor:instructorNumber |
| | | | | School and Year | |
| Status | Yes | Yes | ACTIVE | | Instructor:status |

Post-Conditions: The database may exist in a new state if an instructor has been added, updated, or deleted.

Alternate Course:

Add Instructor: From the “Add Employee as Instructor” screen: If the Employee ID is not found, the “Employee ID not found” screen is displayed to the user, instructing them to add the employee to the system using the Staff tab function. (See attachments). The user may select the OK button to return to the previous screen.

From the “Add Employee as Instructor” screen: If the Employee ID is found, and is already an instructor of the selected school, the “Instructor Exists” screen is displayed to the user, informing them that: “the employee is already an instructor for this school.” (See attachments). The user may select the OK button to return to the “Maintain Employee” screen with that instructor highlighted in the display listing.

Error/Warning Exceptions:

If the user does not make a selection before pressing the OK button, the following message will be displayed: “Please make a selection before proceeding.”

If a user attempts to press the OK button, but a validation rule is not met (see Field Mappings), an error message will be displayed which prompts the user to: “Please enter all data correctly in the required fields.” The user is then able to press the OK button to retry entering the proper data.

Additional Rules:

1) An Instructor cannot be deleted if he/she has a Development Area or Progress Report reference. If the user attempts to delete an Instructor with these references, a Dialog box appears informing the user that the action cannot be completed because the Instructor is being referenced to either Development Areas or Progress Reports.

The following chart defines Actor access to the use case options:

| Actors: | IT | | Assist | | | AIP |
|---|---|---|---|---|---|---|
| Options: | Op | Principal | Prin | Registrar | Counselor | Admin |
| Add | Yes | Yes | Yes | Yes | Yes | Yes |
| Instructor | | | | | | |
| Update | Yes | Yes | Yes | Yes | Yes | Yes |
| Instructor | | | | | | |
| Remove | TBD | TBD | TBD | TBD | TBD | TBD |
| Instructor | | | | | | |
| Instruc- | Yes | Yes | Yes | Yes | Yes | Yes |
| tor's | | | | | | |
| Courses | | | | | | |

4(t). Use Case: Maintain Progress Report

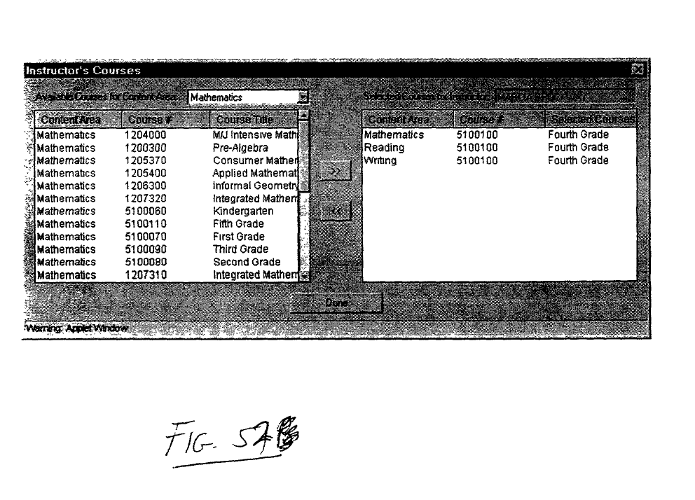

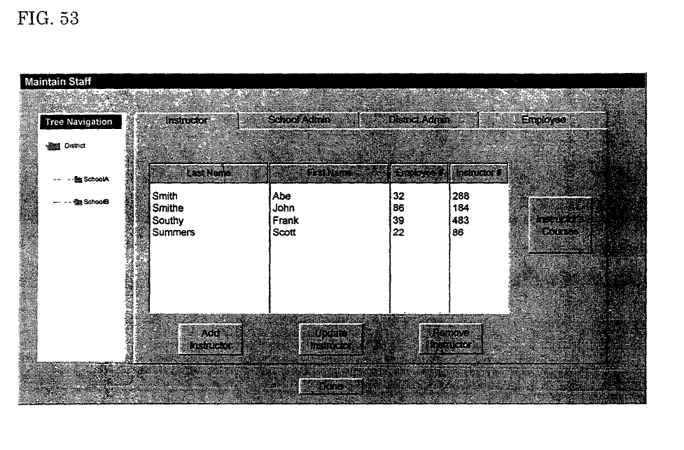

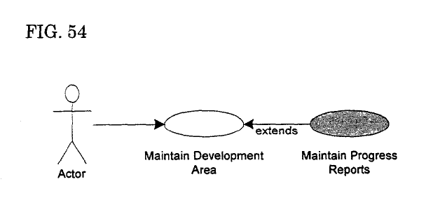

The Maintain Progress Reports use case is used to maintain Progress Reports information for a selected student. Maintenance operations include creating, updating, and deleting of Progress Reports. The displayed Progress Reports information includes basic information such as: Date, Report Type, and Comments. Access to the Maintain Progress Reports operations is limited by the security access of the user. See FIG. 54.

Actors: Teacher, Guidance, Principal.

Pre-Conditions: A Development Area must be selected.

Maintenance includes:

View by Type:

The user selects a report type from the drop-down “View by Type:” list box to display different report types in the report display area.

Create Progress Report:

The user selects the Create button to add a new Progress Report.

The “Create Progress Report” screen is displayed with the default values pre-entered.

The user enters new Progress Report information, as per each field definition.

The user selects OK to add the Progress Report. If all necessary data has been completed (see Field Mappings), and passes validation, then the Progress Report is created and added to the system. If a validation rule is not met, a warning message is displayed (see Error/Warning Exception#2).

The user is returned to the “Maintain Progress Report” screen.

If the user selects Cancel, then no modifications are made to the system, and the user is returned to the “Maintain Progress Report” screen.

Update Progress Report:

The user highlights a Progress Report, and selects the Update button to modify Progress Report data. If no Progress Report is highlighted, then a warning message is displayed (see Error/Warning Exception#1).

The “Update Progress Report” screen is displayed with a listing of the Progress Report's current information. Fields are enabled according to the definitions in Field Mappings.

The user modifies Progress Report information per each field definition. The user selects OK to update Progress Report data. If all necessary data has been completed (see Field Mappings), and pass validation, then the Progress Report is updated in the system. If a validation rule is not met, a warning message is displayed (see Error/Warning Exception#2).

The user is returned to the “Maintain Progress Report” screen, with the modified Progress Report highlighted.

If the user selects Cancel, then no modifications are made to the system, and the user is returned to the “Maintain Progress Report” screen.

Delete Progress Report: The user highlights a Progress Report, and selects the Delete button to delete a Progress Report and it's associated data. If no Progress Report is highlighted, then a warning message is displayed (see Error/Warning Exception#1).

A “Verify Delete?” window is displayed to user. If the user selects Yes, then the selected Progress Report is deleted. If the user selects No, then no modifications are made to the system, and the user is returned to the “Maintain Progress Report” screen, with the selected entry highlighted.

Field Mapping:

| Field Name | Create | Update | Default Value | Validation Rule | Attribute in Model |
|---|---|---|---|---|---|
| Comments | Y | Y | None | | ProgressReport:comment |
| Date | n | n | Current Date | | ProgressReport:Date |
| Report Type | n | y | None | In Pick List | ProgressReportType:description |
| Employee ID: | n | n | System Provided | Not editable | Staff:employeeId |
| First: | n | n | System Provided | Not editable | Staff:firstName |
| Middle: | n | n | System Provided | Not editable | Staff:middleName |
| Last: | n | n | System Provided | Not editable | Staff:lastName |
| Appendage: | n | n | System Provided | Not editable | Staff:appendage |

Post-Conditions: The database may exist in a new state if the user has added or updated Progress Report data.

Error/Warning Exceptions:

If the user does not make a selection before pressing the OK button, the following message will be displayed: “Please make a selection before proceeding.”

If a user attempts to press the OK button, but a validation rule is not met (see Field Mappings), an error message will be displayed which prompts the user to: “Please enter all data correctly in the required fields.” The user is then able to press the OK button to retry entering the proper data.

Additional Rules:

Description of how AIP status updates are handled:

| | |
|---|---|
| Status of each | JULY 1 STATUS |

| Development Need | | AIP Status | AIP | AIP |
|---|---|---|---|---|
| READING | WRITING | MATHEMATICS | STATUS | STATUS |
| PA | PA | PA | PA | PA |
| PA | A | A | A | AC |
| A | PA | A | A | AC |
| A | A | PA | A | AC |
| PA | PA | A | A | AC |
| PA | A | PA | A | AC |
| A | PA | PA | A | AC |
| DC | DC | DC | DC | DC |
| DC | A | A | A | AC |
| A | DC | A | A | AC |
| A | A | DC | A | AC |
| DC | DC | A | A | AC |
| DC | A | DC | A | AC |
| A | DC | DC | A | AC |
| PA | DC | A | A | AC |
| PA | A | DC | A | AC |
| PA | DC | DC | CM | CM |
| PA | PA | DC | CM | CM |
| DC | PA | PA | CM | CM |

If a student does not have an area of developmental need, the status of the AIP would be based on the status of the areas of development need. For example:

| Status of Development Area | | | AIP Status | July 1 Status |
|---|---|---|---|---|
| READING | WRITING | MATHEMATICS | AIP STATUS | JULY 1 STATUS |
| NOT APPLY | NOT APPLY | PA | PA | PA |
| PA | NOT APPLY | PA | PA | PA |
| PA | NOT APPLY | A | A | AC |
| DC | NOT APPLY | NOT APPLY | DC | DC |
| DC | NOT APPLY | A | A | AC |
| PA | DC | NOT APPLY | CM | CM |
| DC | NOT APPLY | PA | CM | CM |
| A | NOT APPLY | NOT APPLY | A | AC |

PA PROFICIENCY ACHIEVED
A ACTIVE
DC DOCUMENTED CLOSED
AC AUTOMATIC CLOSED AT END OF YEAR
CM CLOSED MULTIPLE REASONS

4(u). Use Case: Maintain School Administrator

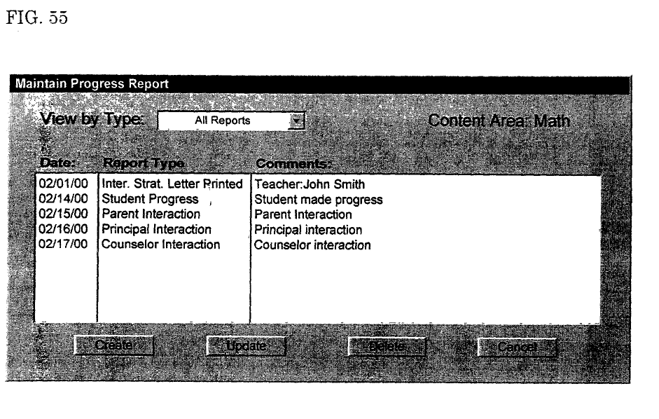

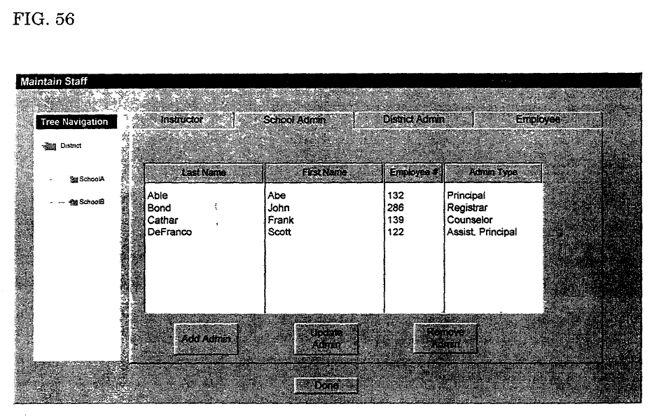

The “Maintain School Administrator” Use Case is used to Add, Update, or Delete School Administrators for a specific school. The target school is selected via the Tree Navigation Tool. When a school is selected on the Tree Navigation Tool, the School Administrators' information is shown in the display list. School Administrator information includes fields such as Last Name, First Name, Employee ID, and Administrator Type. Access to the “Maintain School Administrator” operations is limited by the security access of the user. See FIG. 46 and screen of FIG. 56.

Actors: Principal and AIP Administrator

Pre-Conditions:

Employee must exist in the system.

User must select a school via the Tree Navigation Tool.

Maintenance Includes:

Add School Administrator: The user selects the Add Admin button to add a new Administrator to the selected school. Any selections in the School Administrator list display are ignored during this process.

The “Add Employee as School Administrator” screen is displayed, requesting the Employee ID of the employee to be added as an Administrator for the selected school. The user enters an Employee ID and presses OK. If all necessary data has been completed (see Field Mappings), and passes validation, then the user is presented with the “School Administrator Type” screen. If a validation rule is not met, a warning message is displayed (see Error/Warning Exception#2). If the user selects the Cancel button, then the user is returned to the previous screen.

The “School Administrator Type” screen is displayed, allowing the user to select the employee's School Administrator type for the school and press the OK button. If all necessary data has been completed (see Field Mappings), and passes validation, the School Administrator is added to the system and the user is returned to the previous menu. If the user selects the Cancel button, then no information is added to the system, and the user is returned to the previous screen.

Update School Administrator: The user selects a School Administrator from the list display.

The user selects the Update Admin button to update the employee's School Administrator type.

The “School Administrator Type” screen is displayed, allowing the user to change the employee's Administrator type for the school and press the OK button. If all necessary data has been completed (see Field Mappings), and passes validation, the School Administrator Type is updated and the user is returned to the previous menu. If the user selects the Cancel button, then the user is returned to the previous screen.

Remove School Administrator: The user highlights a School Administrator, and selects the Remove Admin button to delete an Administrator and it's associated data. If no School Administrator is highlighted, then a warning message is displayed (see Error/Warning Exception#1).

A “Confirm Deletion?” window is displayed to user. If the user selects Yes, then the selected School Administrator is deleted. If the user selects No, then no modifications are made to the system, and the user is returned to the previous screen.

Field Mapping:

| Field Name | Create | Update | Default Value | Validation Rule | Attribute in Model |
|---|---|---|---|---|---|
| Display List: | | | | | |
| Last Name | N/A | N/A | | | Staff:lastName |
| First Name | N/A | N/A | | | Staff:firstName |
| Employee ID | N/A | N/A | | | Staff:employeeID |
| Admin Type | N/A | N/A | | | SchoolAdminType:description |
| Tree Navigator Tool | N/A | N/A | | Selection required | School:name |
| (Tree School Selection) | | | | | |
| Add Employee as School | | | | | |
| Administrator | | | | | |
| Employee ID | N/A | N/A | | Integer only | Staff:employeeID |
| | | | | Not blank | |
| | | | | Exists in database | |
| | | | | Not already a | |
| | | | | School Admin | |
| School Administrator | | | | | |
| Type | | | | | |
| Employee | No | No | | Not editable | Staff:firstName + |
| | | | | | Staff:lastName |
| School | No | No | | Not editable | School:name |
| Admin Type | Yes | Yes | | In pick list | SchoolAdminType:description |
| | | | | Not blank | |
| Status | Yes | Yes | | | SchoolAdminType:status |

Post-Conditions: The database may exist in a new state if a School Administrator has been added, updated, or deleted.

Alternate Course:

Add School Administrator:

From the “Add Employee as School Administrator” screen: If the Employee ID is not found, the “Employee ID not found” screen is displayed to the user, instructing them to add the employee to the system using the Staff tab function. (See attachments). The user may select the OK button to return to the previous screen.

From the “Add Employee as School Administrator” screen: If the Employee ID is found, and is already an Administrator of the selected school, the “School Administrator Exists” screen is displayed to the user, informing them that: “the employee is already an School Administrator for this school.” (See attachments). The user may select the OK button to return to the “Maintain Employee” screen with that School Administrator highlighted in the display listing.

Error/Warning Exceptions:

If the user does not make a selection before pressing the OK button, the following message will be displayed: “Please make a selection before proceeding.”

If a user attempts to press the OK button, but a validation rule is not met (see Field Mappings), an error message will be displayed which prompts the user to: “Please enter all data correctly in the required fields.” The user is then able to press the OK button to retry entering the proper data.

Additional Rules:

1) A School Administrator cannot be deleted if he/she has a Progress Report reference. If the user attempts to delete a School Administrator with a reference, a Dialog box appears informing the user that the action cannot be completed because the School Administrator is being referenced by a Progress Report.

The following chart defines Actor access to the use case options:

| Actors: | | |
|---|---|---|
| Options: | Principal | AIP Admin |
| Add School Admin | Yes | Yes |
| Update School Admin | Yes | Yes |
| Remove School Admin | TBD | TBD |

4(v). Use Case: Maintain Selected Intervention Strategies

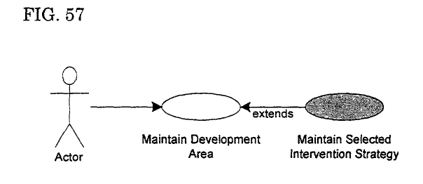

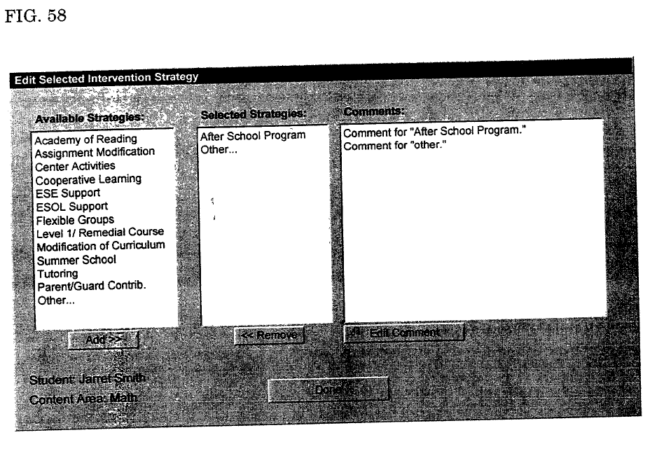

The Maintain Intervention Strategies use case is used to display and maintain Intervention Strategies for a Development Area. Maintenance operations include creating, updating, and deleting of Intervention Strategies via the “Edit Selected Intervention Strategy Screen.” The displayed Intervention Strategy information includes basic information such as: Date, Intervention Strategy, and Description of Strategy. Access to the Maintain Intervention Strategy operations is limited by the security access of the user. See FIG. 57 and screen of FIG. 58.

Actors: Teacher, Guidance and Principal

Pre-Conditions:

Student must be selected in the Maintain AIP screen.

Development Area must be selected.

Maintenance Includes:

Maintain Selected Intervention Strategy Screen:

To Add, Update, or Delete Selected Intervention Strategies for a Development Area, the user presses the Edit button to move to the “Edit Selected Intervention Strategy” Screen. The user presses the Done button to close the window.

Edit Intervention Strategy: The Intervention Strategies listed in the “Available Strategies” window have not been assigned to the Development area, and are available for assignment via the Add button.

To add an Intervention Strategy, the user selects a strategy from the “Available Strategies” window and presses the Add button. The strategy will be moved from the “Available Strategies” window to the “Selected Strategies” window. If the Add button is pressed without an “Available Strategy” selected, no move will occur.

The Intervention Strategies listed in the “Selected Strategies” window have been assigned to the Development area, and are able to be removed via the Remove button.

To remove an Intervention Strategy, the user selects a strategy from the “Selected Strategies” window and presses the Remove button. The selected strategy will be moved from the “Selected Strategies” window to the “Available Strategies” window. If the Remove button is pressed without an “Available Strategy” selected, no move will occur.

To add or edit a comment to a strategy listed in the “Selected Strategies” window, the user selects a strategy in the “Selected Strategies” window and presses the Comment button. The Comment field of that strategy will become highlighted and editable so that the user may type in the appropriate comment. When the user is finished typing in the comment, pressing the “Enter” key will save the Strategy's comment. Pressing the screen's Done button will also save the Strategy's comment.

When the user has finished editing the Intervention Strategies, pressing the Done button will close the screen.

Field Mapping:

| | | | Default | Validation | |
|---|---|---|---|---|---|
| Field Name | Create | Update | Value | Rule | Attribute in Model |
| Content Area | N | N | | | ContentArea:description |
| Intervention | Y | Y | | | InterventionStrategy:description |
| Strategy | | | | | |
| Selected | Y | Y | | | SelectedInterventionStrategy: |
| Intervention | | | | | description |
| Strategy | | | | | |
| Creation Date: | N | N | | | SelectedInterventionStrategy: |
| | | | | | date |
| First Name | N | N | | | Student:firstName |
| Last Name | N | N | | | Student:lastName |

Post-Conditions: The database may exist in a new state if the user has added, removed or commented an Intervention Strategy.

4(w). Use Case: Maintain Staff

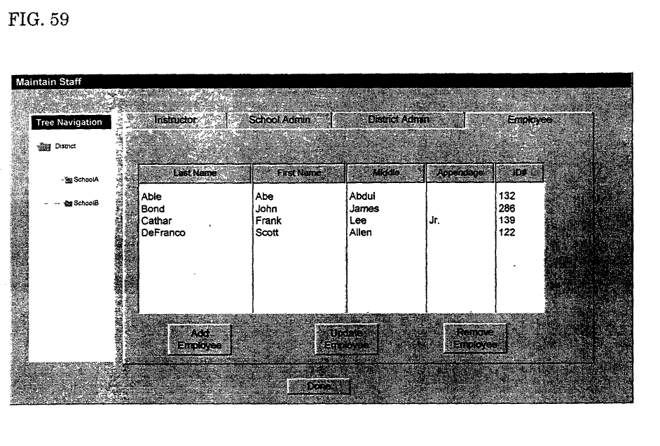

This use case describes the “Maintain Staff” function tab, which primarily provides access to the Maintain Instructor, Maintain School Administrator, Maintain District Administrator, and Maintain Employee Use Cases. The security level of the user limits access to each of the Use Cases accessed via the “Maintain Staff” screen. See FIG. 46 and screen of FIG. 59.

Actors: IT Operator, Principal, Assistant Principal, School Registrar, Guidance Counselor, AIP Administrator.

Maintenance Includes:

Tree Navigator: The Tree Navigation Tool is used in conjunction with the currently active Maintenance tab. When the Tree Navigator Tool is required, it normally specifies a school to be used by the user to perform a task. The staff members displayed will be limited to the school selected.

Instructor: The user selects the Instructor tab to begin the “Maintain Instructor” Use Case. Access to this option is restricted by the User's security level (see Additional Rules).

School Admin: The user selects the School Admin tab begin the “Maintain School Administrator” Use Case. Access to this option is restricted by the User's security level (see Additional Rules).

District Admin: The user selects the District Admin tab to begin the “Maintain District Administrator” Use Case. Access to this option is restricted by the User's security level (see Additional Rules).

Employee: The user selects the Employee tab to begin the “Maintain Employee” Use Case. Access to this option is restricted by the User's security level (see Additional Rules).

Done: The user selects the Done button to close the “Maintain Staff” screen.

Field Mapping:

| | | | | Vali- | |
|---|---|---|---|---|---|
| | | | Default | dation | |
| Field Name | Create | Update | Value | Rule | Attribute in Model |
| Tree Naviga- | | | | | |
| tion Tool: | | | | | |
| (School | N/A | N/A | | | School:name |
| Selection) | | | | | |
| (District | N/A | N/A | | | District:description |
| Selection) | | | | | |

Additional Rules:

The following chart defines Actor access to the use case options:

| Options: | | School | District | |
|---|---|---|---|---|
| Actors: | Instructor | Admin | Admin | Employee |
| I.T. Operator | Yes | | Yes | Yes |
| Principal | Yes | Yes | | |
| Asst. Principal | Yes | | | |
| School Registrar | Yes | | | |
| Guidance Counselor | Yes | | | |
| AIP Administrator | Yes | Yes | Yes | Yes |

Related Use Cases:

Maintain Instructor

Maintain School Admin

Maintain District Admin

Maintain Employee

4(x).Use Case: Maintain Student

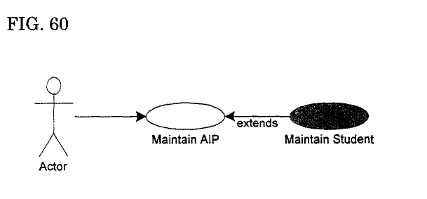

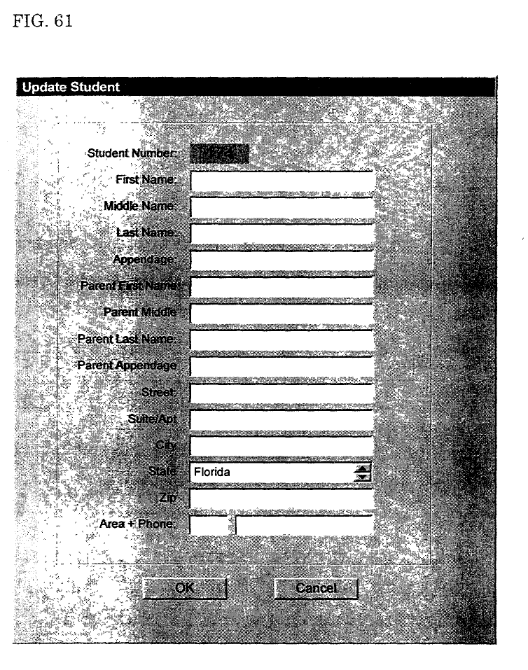

The Maintain Student use case is used to maintain student information for a selected student. Maintenance operations include updating student information. The displayed student information includes all editable fields relating to student information. Access to the Maintain Student operations is limited by the security access of the user. See FIG. 60 and screen of FIG. 61.

Actors: Teacher, School Admin, Guidance, Principal.

Pre-Conditions: Student must be selected from the “Maintain AIP” screen.

Maintenance Includes:

Update Student: The user selects the Students button from the “Main Menu” to modify student information. The “Update Student” screen is displayed to the user. The user modifies student information, as per each field definition. The user selects the OK button to update student information. If all necessary data has been completed (see Field Mappings), and passes validation, then the student information is updated in the system. If a validation rule is not met, a warning message is displayed (see Error/Warning Exception#1). The user is returned to the “Main Menu” screen.

If the user selects the Cancel button, then no modifications are made to the system, and the user is returned to the previous screen.

Field Mapping:

| Field Name | Create | Update | Default Value | Validation Rule | Attribute in Model |
|---|---|---|---|---|---|
| Number | N | N | System Provided | Not editable | Student:studentNumber |
| First Name | N | Y | | Not Blank | Student:firstName |
| Middle Name | N | Y | | Not Blank | Student:middleName |
| Last Name | N | Y | | Not Blank | Student:lastName |
| Appendage | N | Y | | | Student:appendage |
| Parent First Name | N | Y | | Not Blank | Student:parent1FirstName |
| Parent Middle | N | Y | | | Student:parent1MiddleName |
| Parent Last Name | N | Y | | Not Blank | Student:parent1lastName |
| Parent Appendage | N | Y | | | Student:parent1Appendage |
| Street | N | Y | | Not Blank | Student:street |
| Suite/Apt | N | Y | | | Student:aptNumber |
| City | N | Y | | Not Blank | Student:city |
| State | N | Y | Florida | Not Blank | Student:state |
| | | | | In Pick List | |
| Zip | N | Y | | Not Blank | Student:zip |
| Area | N | Y | | Not Blank | Student:areaCode |
| Phone | N | Y | | Not Blank | Student:phoneNumber |

Post-Conditions: The student may exist in a new state if the user has updated student data.

Error/Warning Exceptions: If a user attempts to press the OK button, but a validation rule is not met (see Field Mappings), an error message will be displayed which prompts the user to: “Please enter all data correctly in the required fields.” The user is then able to press the OK button to retry entering the proper data.

Related Use Cases: Maintain AIP

4(y). Use Case: AIP & Content Area Status by Grade for School

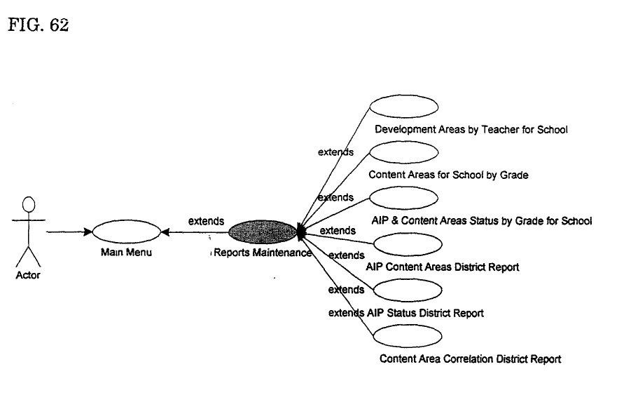

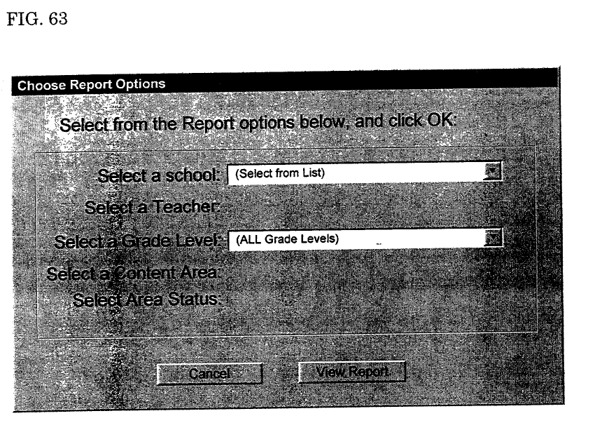

This use case describes the “AIP & Content Area Status by Grade for School” Use Case, which allows the user to choose from report options, and display the results of the report in a Web Browser. The user may then print the Report from within the Web Browser. See FIG. 62 and screen of FIG. 63.

Actors: Principal, Counselor, Academic, IT Operator, School Registrar.

Status Includes:

Choose Report Options:

The user may make a selection from each pick-list to provide report-filtering criteria.

When applicable, the user may accept the default selection of “All.”

Every field modified by the user will narrow the report parameters further.

To view the report in a web browser, the user presses the View Report button.

The user is presented with the Report in a Web Browser.

If the user pulls down from the FILE menu to PRINT, the report will be printed on a printer.

When the user closes the Web Browser, the user is returned to the “Choose Reports Option” screen.

If the user selects the Cancel button, the user will be returned to the previous screen.

Field Mapping:

| Field Name | Create | Update | Default Value | Validation Rule | Attribute in Model |
|---|---|---|---|---|---|
| Choose Report Type: | | | | | |
| Select a School: | No | No | (Select from | In Pick List | School:Name |
| | | | List) | Not Blank | |
| | | | | Selection Required | |
| Select a Teacher: | No | No | (ALL | In Pick List | Staff:lastname |
| | | | Teachers) | Dimmed, according to | Staff:firstname |
| | | | | report (see chart in | |
| | | | | Additional Rules) | |
| Select a Grade Level: | No | No | (ALL Grades) | In Pick List | Grade:description |
| | | | | Dimmed, according to | |
| | | | | report (see chart in | |
| | | | | Additional Rules) | |
| Select a Content | No | No | (ALL Content | In Pick List | ContentArea:description |
| Area: | | | Areas) | Dimmed, according to | |
| | | | | report (see chart in | |
| | | | | Additional Rules) | |
| Select an Area Status | No | No | (Select from | In Pick List | DevelopmentAreaStatus |
| | | | List) | Not Blank | description |
| | | | | Selection Required | |
| | | | | Dimmed, according to | |
| | | | | report (see chart in | |
| | | | | Additional Rules) | |
| AIP & Content Area | | | | | |
| Status by Grade for | | | | | |
| School Report: | | | | | |
| Grade: | No | No | | | Grade:description |
| Student Name: | No | No | | | Student:lastName |
| | | | | | Student:firstName |
| Student ID: | No | No | | | Student:studentNumber |
| AIP Status: | No | No | | | AIPStatus:description |
| Content Areas: | No | No | | | ContentArea:description |
| Development Area | No | No | | | Course:title |
| Course: | | | | | |
| Development Area | No | No | | | DevelopmentAreaStatus |
| Status: | | | | | description |
| Teacher: | No | No | | | Staff:lastname |
| | | | | | Staff:firstname |
| Course #: | No | No | | | Course:courseNumber |

Additional Rules:

The following chart describes whether a pick list is “active” or “dimmed” by Report Type for the “Choose Report Options” screen:

| | Development | Content Areas | AIP & Content |
|---|---|---|---|
| Report Type: | Areas for | for School | Area Status by |
| Pick List: | Teacher | by Grade | Grade for School |
| Select a School: | Active | Active | Active |
| Select a Teacher: | Active | Dimmed | Dimmed |
| Select a Grade Level: | Dimmed | Active | Active |
| Select a Content Area: | Active | Dimmed | Dimmed |
| Select an Area Status: | Active | Dimmed | Dimmed |

Related Use Cases: Reports Maintenance

SAMPLE REPORT OF AIP & CONTENT AREA STATUS BY GRADE FOR SCHOOL:

Arthur Mills Middle:

GRADE 7: Students

| | | AIP | Content | | | | |
|---|---|---|---|---|---|---|---|
| Student: | ID#: | Status: | Areas: | Dev. Areas: | Dev. Status: | Teacher: | Course: |
| Ben, Julie | 4568 | ACTIVE | Reading | Comp 101 | ACTIVE | Barns, Joe | 934702 |
| Cleary, Jen | 1483 | ACTIVE | Math | Math 101 | ACTIVE | Mills, Frank | 223344 |
| Scott, Sue | 3498 | Prof. | Writing | Writing 101 | Prof. Ach. | South, Bob | 999999 |
| | | Ach. | | | | | |
| Zimmer, Hali | 3499 | ACTIVE | Reading | Amer. Lit | ACTIVE | Jens, Peter | 934999 |
| | | | Reading | Literature | Prof. Ach. | Barns, Joe | 934702 |
| | | | Math | Math 101 | ACTIVE | Mills, Frank | 223344 |
| | | | Writing | Comp 101 | Prof. Ach. | South, Bob | 999999 |

Grade 7: AIP Status:

| | | | | |
|---|---|---|---|---|
| | Prof. | Doc. | | Yearly |
| Active | Achieved | Closed | Closed-Multiple | Auto-Close |

| | |
|---|---|
| 3 | 1 |

Grade 7: Content Area Status:

| Content | | Prof. | Inst. | | Doc. |
|---|---|---|---|---|---|
| Area Status | Active | Achieved | Assigned | Unassigned | Closed |
| Reading | 2 | 1 | | | |
| Writing | | 2 | | | |
| Math | 2 | | | | |

4(z). Use Case: Content Areas for School by Grade

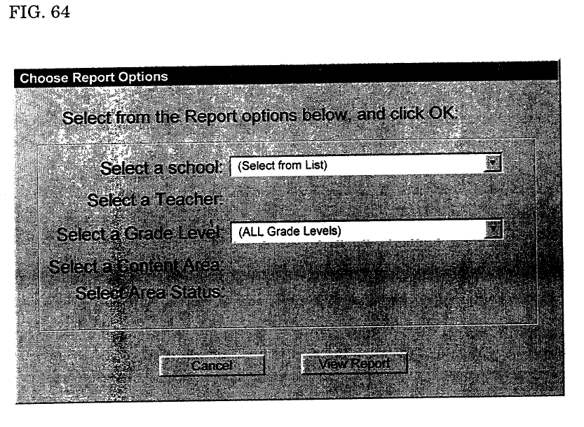

This use case describes the “Content Areas for School by Grade” Use Case, which allows the user to choose from report options, and display the results of the report in a Web Browser. The user may then print the Report from within the Web Browser. See FIG. 62 and screen of FIG. 64.

Actors: Principal, Counselor, Academic, IT Operator, School Registrar.

Content Area includes:

Choose Report Options: The user may make a selection from each pick-list to provide report-filtering criteria. When applicable, the user may accept the default selection of “All.” Every field modified by the user will narrow the report parameters further. To view the report in a web browser, the user presses the View Report button. The user is presented with the Report in a Web Browser. If the user pulls down from the FILE menu to PRINT, the report will be printed on a printer. When the user closes the Web Browser, the user is returned to the “Choose Reports Option” screen. If the user selects the Cancel button, the user will be returned to the previous screen.

Field Mapping:

| | | | | | |
|---|---|---|---|---|---|
| Field Name | Create | Update | Default Value | Validation Rule | Attribute in Model |

Choose Report Type:

| | | | | | |
|---|---|---|---|---|---|
| Select a School: | No | No | (Select from List) | In Pick List Not Blank | School:Name |
| | | | | Selection Required | |
| Select a Teacher: | No | No | (ALL Teachers) | In Pick List Dimmed, according | Staff:lastname |
| | | | | to report (see chart in | Staff:firstname |
| | | | | Additional Rules) | |
| Select a Grade Level: | No | No | (ALL Grades) | In Pick List Dimmed, according | Grade:description |
| | | | | to report (see chart in | |
| | | | | Additional Rules) | |
| Select a Content | No | No | (ALL Content Areas) | In Pick List Dimmed, according | ContentArea:description |
| Area: | | | | to report (see chart in | |
| | | | | Additional Rules) | |
| Select an Area Status | No | No | (Select from List) | In Pick List Not Blank | DevelopmentAreaStatus: |
| | | | | Selection Required | description |
| | | | | Dimmed, according to | |
| | | | | report (see chart in | |
| | | | | Additional Rules) | |
| Content Areas for School | | | | | |
| by Grade Report: | | | | | |
| Student Name: | No | No | | | Student:lastName |
| | | | | | Student:firstName |
| Student ID: | No | No | | | Student:studentNumber |
| AIP Status: | No | No | | | AIPStatus:description |
| Content Areas: | No | No | | | ContentArea:description |
| Dev. Area Course: | No | No | | | Course:title |
| Course #: | No | No | | | Course:courseNumber |
| Development Area | No | No | | | DevelopmentAreaStatus |
| Status: | | | | | description |
| Teacher: | No | No | | | Staff:lastname |
| | | | | | Staff:firstname |
| Grade: | No | No | | | Grade:description |

Additional Rules:

The following chart describes whether a pick list is “active” or “dimmed” by Report Type for the “Choose Report Options” screen:

| | Development | Content Areas | AIP & Content |
|---|---|---|---|
| Report Type: | Areas for | for School | Area Status by |
| Pick List: | Teacher | by Grade | Grade for School |
| Select a School: | Active | Active | Active |
| Select a Teacher: | Active | Dimmed | Dimmed |
| Select a Grade Level: | Dimmed | Active | Active |
| Select a Content Area: | Active | Dimmed | Dimmed |
| Select an Area Status: | Active | Dimmed | Dimmed |

Related Use Cases: Reports Maintenance

SAMPLE REPORT OF CONTENT AREAS FOR SCHOOL BY GRADE

Arthur Mills Middle School: ps Grade 7: Students

| | | AIP | Content | Dev. Area | | | |
|---|---|---|---|---|---|---|---|
| Student: | ID#: | Status: | Areas: | Course: | Course#: | Dev. Status: | Teacher: |
| Ben, Julie | 4568 | ACTIVE | Reading | Comp 101 | 934702 | ACTIVE | Barns, Joe |
| Cleary, Jen | 1483 | ACTIVE | Math | Math 101 | 223344 | ACTIVE | Mills, Frank |
| Scott, Sue | 3498 | ACTIVE | Writing | Writing 101 | 999999 | ACTIVE | South, Bob |
| Zimmer, Hal | 3499 | ACTIVE | Reading | Amer. Lit | 934999 | ACTIVE | Jens, Peter |
| | | | Reading | Literature | 934702 | ACTIVE | Barns, Joe |
| | | | Math | Math 101 | 223344 | ACTIVE | Mills, Frank |
| | | | Writing | Comp 101 | 999999 | ACTIVE | South, Bob |

Grade 7: Total AIP Students and Content Areas:

| | | Math: | | Reading: | | Writing: | |
|---|---|---|---|---|---|---|---|
| | | | Develop- | | Develop- | | Develop- |
| | Total | | ment | | ment | | ment |
| Grade: | AIPs | AIP | Areas | AIP | Areas | AIP | Areas |
| 7 | 4 | 2 | 2 | 2 | 3 | 1 | 1 |

Grade 8: Students

| | | AIP | Content | | | | |
|---|---|---|---|---|---|---|---|
| Student: | ID# | Status: | Areas: | Dev. Areas: | Course#: | Dev. Status: | Teacher: |
| Echo, Joe | 934 | ACTIVE | Reading | Comp 102 | 934702 | ACTIVE | Barns, Joe |
| | | | Writing | Writing 102 | 999999 | ACTIVE | South, Bob |
| | | | Math | Math 102 | 223344 | ACTIVE | Mills, Frank |
| Dumont, Abe | 9343 | ACTIVE | Writing | Writing 102 | 999999 | ACTIVE | South, Bob |
| Fuzz, John | 3384 | ACTIVE | Reading | Comp 102 | 934702 | ACTIVE | Barns, Joe |
| | | | Math | Math 102 | 223344 | ACTIVE | Mills, Frank |

Grade 8: Total AIP Students and Content Areas:

| | | Math: | | Reading: | | Writing: | |
|---|---|---|---|---|---|---|---|
| | | | Develop- | | Develop- | | Develop- |
| | Total | | ment | | ment | | ment |
| Grade: | AIPs | AIP | Areas | AIP | Areas | AIP | Areas |
| 8 | 3 | 2 | 2 | 2 | 2 | 2 | 2 |

School Totals:

Arthur Mills Middle School:

| | Active | Math | Reading | Writing |
|---|---|---|---|---|
| Grade: | AIPs | Content Areas | Content Areas | Content Areas |
| 7 | 4 | 2 | 2 | 1 |
| 8 | 3 | 2 | 2 | 2 |

4(aa). Use Case: Development Areas by Teacher for School

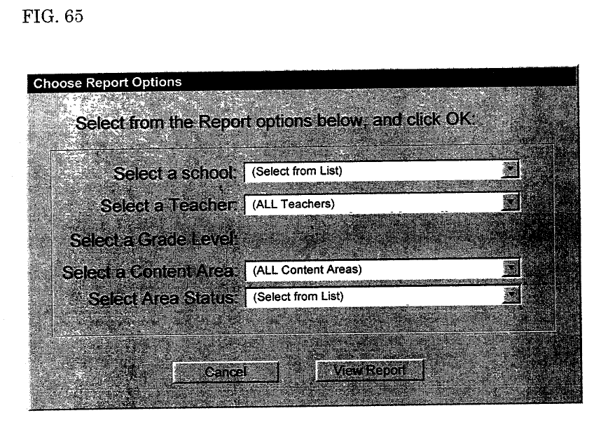

This use case describes the “Development Areas by Teacher for School” report, which allows the user to choose from report options, and display the results of the report in a Web Browser. The user may then print the Report from within the Web Browser. See FIG. 62 and screen of FIG. 65.

Actors: Principal, Counselor, Academic, IT Operator, School Registrar, Teacher.

Areas Include:

Choose Report Options: The user may make a selection from each pick-list to provide report-filtering criteria. When applicable, the user may accept the default selection of “All.” Every field modified by the user will narrow the report parameters further. To view the report in a web browser, the user presses the View Report button. The user is presented with the Report in a Web Browser. If the user pulls down from the FILE menu to PRINT, the report will be printed on a printer. When the user closes the Web Browser, the user is returned to the “Choose Reports Option” screen. If the user selects the Cancel button, the user will be returned to the previous screen.

Field Mapping:

| | | | | | |
|---|---|---|---|---|---|
| Field Name | Create | Update | Default Value | Validation Rule | Attribute in Model |

Choose Report Type:

| | | | | | |
|---|---|---|---|---|---|
| Select a School: | No | No | (Select from List) | In Pick List Not Blank | School:Name |
| | | | | Selection Required | |
| Select a Teacher: | No | No | (ALL Teachers) | In Pick List Dimmed, | Staff:lastname |
| | | | | according to report | Staff:firstname |
| | | | | (see chart in | |
| | | | | Additional Rules) | |
| Select a Grade Level: | No | No | (ALL Grades) | In Pick List Dimmed, | Grade:description |
| | | | | according to report | |
| | | | | (see chart in | |
| | | | | Additional Rules) | |
| Select a Content Area: | No | No | (ALL Content Areas) | In Pick List Dimmed, | ContentArea:description |
| | | | | according to report | |
| | | | | (see chart in | |
| | | | | Additional Rules) | |
| Select an Area Status | No | No | (Select from List) | In Pick List Not Blank | DevelopmentAreaStatus: |
| | | | | Selection Required | description |
| | | | | Dimmed, according to | |
| | | | | report (see chart in | |
| | | | | Additional Rules) | |
| Development Area by | | | | | |
| Teacher Report: | | | | | |
| Teacher: | No | No | | | Staff:lastname |
| | | | | | Staff:firstname |
| Course: | No | No | | | Course:title |
| Student Name: | No | No | | | Student:lastName |
| | | | | | Student:firstName |
| Student ID: | No | No | | | Student:studentNumber |
| Development Area Status: | No | No | | | DevelopmentAreaStatus: |
| | | | | | description |

Additional Rules:

The following chart describes whether a pick list is “active” or “dimmed” by Report Type for the “Choose Report Options” screen:

| | Development | Content Areas | AIP & Content |
|---|---|---|---|
| Report Type: | Areas for | for School | Area Status by |
| Pick List: | Teacher | by Grade | Grade for School |
| Select a School: | Active | Active | Active |
| Select a Teacher: | Active | Dimmed | Dimmed |
| Select a Grade Level: | Dimmed | Active | Active |
| Select a Content Area: | Active | Dimmed | Dimmed |
| Select an Area Status: | Active | Dimmed | Dimmed |

Related Use Cases: Reports Maintenance

Sample Report of Development Areas by Teacher for School

Madison High School:

| | | | | Development |
|---|---|---|---|---|
| Teacher | Course | Student | Student ID | Area Status |
| Bob, Rob | Algebra | One, Student | 1111 | Active |
| | | Two, Student | 2222 | Active |
| | | Three, Student | 3333 | Active |
| | | Four, Student | 4444 | Active |
| | Geometry | One, Student | 1111 | Active |
| | | Two, Student | 2222 | Active |
| | | Three, Student | 3333 | Active |
| | | Four, Student | 4444 | Active |
| | | Five, Student | 5555 | Active |
| | | Six, Student | 6666 | Active |
| | | Seven, Student | 7777 | Active |
| Total | | | | 11 |
| Development | | | | |
| Areas for | | | | |
| Teacher: | | | | |

Madison High School:

| | | | | Development |
|---|---|---|---|---|
| Teacher | Course | Student | Student ID | Area Status |
| Tell, Will | Literature | One, Student | 1111 | Active |
| | | Two, Student | 2222 | Active |
| | | Three, Student | 3333 | Active |
| | | Four, Student | 4444 | Active |
| | Am. Lit | One, Student | 1111 | Active |
| | | Two, Student | 2222 | Active |
| | | Three, Student | 3333 | Active |
| | | Four, Student | 4444 | Active |
| | | Five, Student | 5555 | Active |
| | | Six, Student | 6666 | Active |
| | | Seven, Student | 7777 | Active |
| Total | | | | 11 |
| Development | | | | |
| Areas for | | | | |
| Teacher: | | | | |

Madison High School:

| | |
|---|---|
| Total Development | 22 |
| Areas for school: | |

4(bb). Use Case: Reports Maintenance

This use case describes the “Report Maintenance” Use Case, which allows the user to select a report type and proceed to the selected reporting Use Case. See FIG. 62.

Actors: Principal, Counselor, Academic, IT Operator, School Registrar, Teacher.

Maintenance Includes:

Report Maintenance Screen: The user selects the desired report by choosing an entry in the Select Report display window. The user filters the report data via the other fields available. The user clicks the OK button to continue to the selected report type. If the user selects the Done button, the “Report Maintenance” screen will be closed.

Field Mapping:

| Field Name | Create | Update | Default Value | Validation Rule | Attribute in Model |
|---|---|---|---|---|---|
| Report Maintenance: | | | | | |
| Report Type | No | No | No | Selection Required | |

4(cc). Use Case: Student Transfer Maintenance

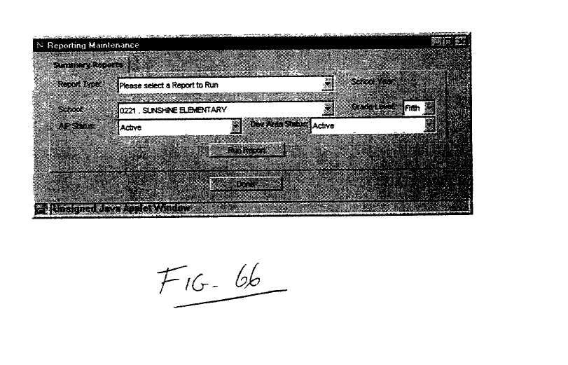

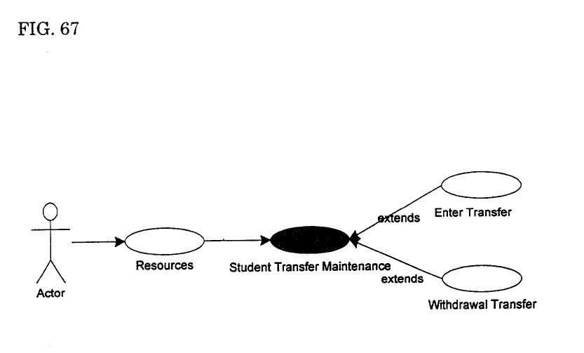

This use case describes the “Student Transfer Maintenance” menu, which primarily provides access to the “Enter Transfer” and “Withdrawal Transfer” Use Cases. The security level of the user limits access to each of the Use Cases accessed via the Students tab on the “Resource Maintenance” screen. See FIG. 67.

Actors: School Administrators.

Maintenance Includes:

Enter Transfer: The user selects the Enter Transfer Student button to begin the “Enter Transfer” Use Case. Access to this option is restricted by the User's security level.

Withdrawal Transfer: The user selects the Withdrawal Student button begin the “Withdrawal Transfer” Use Case. Access to this option is restricted by the User's security level.

Done: The user selects the Done button to close the “Student Transfer Maintenance” screen.

Related Use Cases: Enter Transfer, Withdrawal Transfer.

4(dd). Use Case: User Authentication

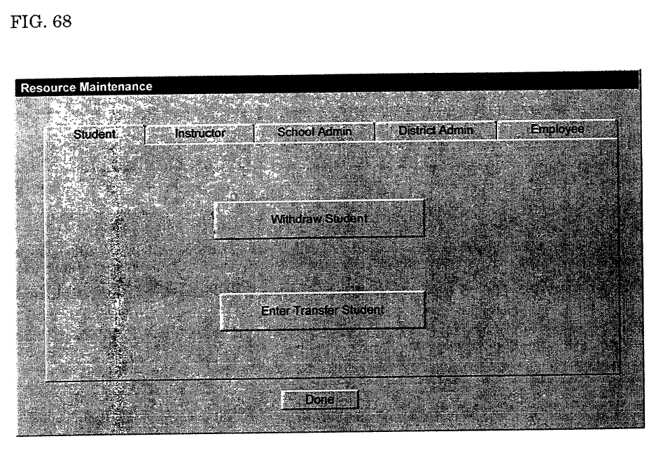

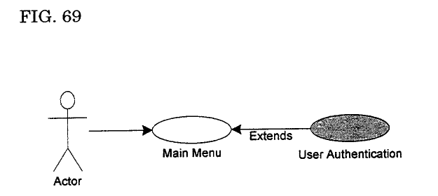

This Use Case describes the steps required for a user to provide their login and password information to be authenticated as a user of the system. Access to all other areas of the system depends upon successful user authentication. Once a user is logged into the system, the Login button is dimmed and inaccessible. See FIG. 69.

Actors: All Users.

Pre-Conditions: A User must not already be logged into the system.

Authentication includes:

Login: The user selects the Login button to begin the login process. The “Login” screen is displayed, without default values in any fields. The user enters authentication information, per each field definition. The user selects OK to request authentication. If all necessary data has been completed (see Field Mappings), and passes validation and authentication, then the User Profile is assigned via the Defile User Profile Use Case and the user is authenticated to the system. If a validation rules is not met, a warning message is displayed (see Error/Warning Exception#2). If the user is not authenticated, a warning message is displayed (see Error/Warning Exception#3). The user is returned to the “Main Menu” screen, with additional options accessible based upon their security level. If the user selects Cancel, then no authentication is requested of the system, and the user is returned to the “Main Menu.” After the user has been authenticated, the Login button is not accessible.

Logoff: The user selects the Logoff button to end the user session with the AIP Program. After the user has been logged off, the only button available on the “Main Menu” is the Login button.

Field Mapping:

| Field Name | Create | Update | Default Value | Validation Rule | Attribute in Model |
|---|---|---|---|---|---|
| User Name: | n | n | None | Not blank | SFSystemUser:systemUsername |
| Password | n | y | None | Not blank | SFSystemUser:password |
| | | | | Password echoed as * | |
| | | | | characters | |

Post-Conditions: The database may exist in a new state if the user has changed passwords.

Error/Warning Exceptions:

If the user does not make a selection before pressing the OK button, the message will be displayed: “Please make a selection before proceeding.”

If a user attempts to press OK and a validation rule is not met (see Field Mappings), an error message will be displayed which prompts the user to “Please enter all data correctly in the required fields.” The user presses OK to try again.

If a user provides incorrect login or password information, the following error message is displayed: “Incorrect Login or Password, please try again.” The user presses OK to try again.

4(ee). Use Case: Print AIP in Web Form

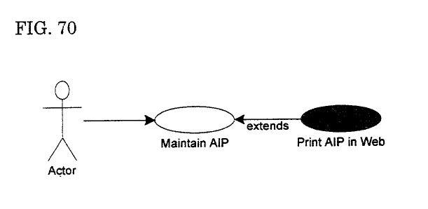

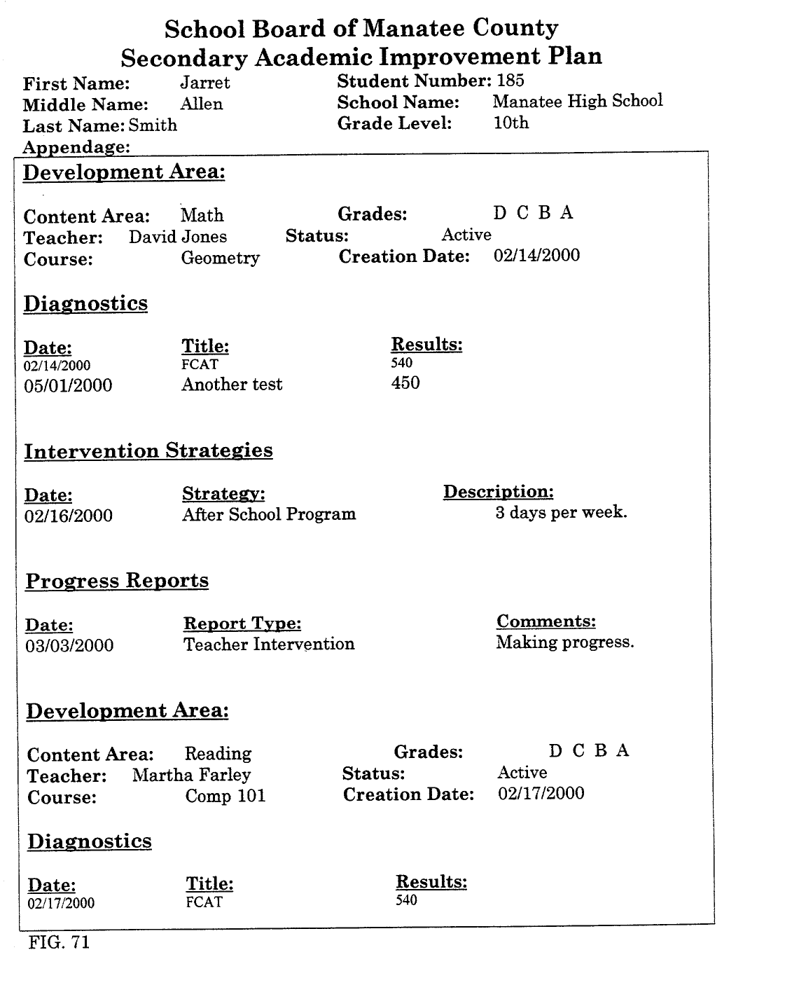

The Print AIP in Web Form Use Case allows users to print detailed AIP information for a single student using a form in a Web browser. See FIG. 70 and sample report of FIG. 71.

Actors: Teacher, Guidance, Principal, Academic.

Pre-Conditions: A student must be selected in the Maintain AIP screen.

Printing includes: The user is presented with the student's AIP information in a Web page. If the user pulls down from the FILE menu to PRINT, and the AIP form is printed. When the user closes the Web Browser, the user is returned to the “Maintain AIP” menu.

Field Mapping:

| Field Name | Create | Update | Default Value | Validation Rule | Attribute in Model |
|---|---|---|---|---|---|
| Student Number | | | | | Student:studentNumber |
| Student First Name | | | | | Student:firstName |
| Student Middle Name | | | | | Student:middleName |
| Student Last Name | | | | | Student:lasName |
| Student Appendage | | | | | Student:appendage |
| School | | | | | School:name |
| Grade Level | | | | | Grade:value |
| Content Area | N | N | | | ContentArea:description |
| Diagnostic Dates | N | N | | | DiagnosticResult:date |
| Diagnostic Indicators | | | | | DiagnosticResult:title |
| Diagnostic Results | | | | | DiagnosticResult:result |
| Intervention Strategy | | | | | SelectedInterventionStrategy:date |
| Creation Date | | | | | |
| Intervention Strategies | | | | | InterventionStrategy:description |
| Intervention Strategy | | | | | InterventionStrategy:description |
| Description | | | | | |
| Development Area | | | | | CompletionDisposition:description |
| Status | | | | | |
| Date | | | Today's Date | | |
| Teacher First Name | | | | | Staff:firstName |
| Teacher Last Name: | | | | | Staff:lastName |
| Course | | | | | InstructorContentArea:course |
| GradeQ1 | | | | | Development Area:gradeQ1 |
| GradeQ2 | | | | | Development Area:gradeQ2 |
| GradeQ3 | | | | | Development Area:gradeQ3 |
| GradeQ4 | | | | | Development Area:gradeQ4 |
| Comments | | | | | ProgressReport:comment |
| Date | | | | | ProgressReport:Date |
| Report Type | | | | | ProgressReportType:description |

Post-Conditions: The AIP is printed on a printer.

4(ff). Use Case: View Historical AIP

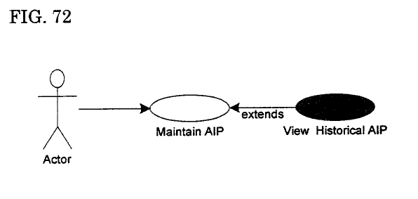

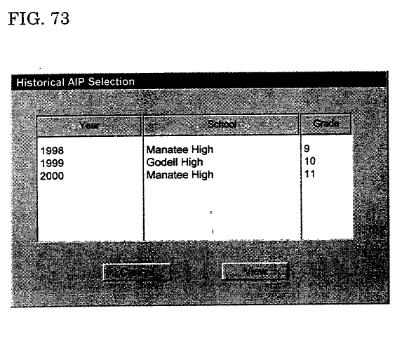

The View Historical AIP Use Case allows users to view and/or print previous AIP information for a student. The user may select from the student's previous A/MPs and view them using a Web browser. From the Web browser, the user may opt to print the AIP using the Web browser's print function. See FIG. 72.

Actors: All Actors.

Pre-Conditions: A student must be selected in the Maintain AIP screen.

Viewing includes: The user is presented with the “Historical AIP Selection” screen, listing all previous AIPs. The user selects an AIP and presses the View button to open the Historical AIP in a Web Browser. If the user presses the Cancel button, the “Historical AIP Selection” screen is closed. The user may elect to pull down from FILE menu to PRINT, and the AIP form will be printed. When the user closes the Web Browser, the user is returned to the “Historical AIP Selection” menu.

Field Mapping:

| Field Name | Create | Update | Default Value | Validation Rule | Attribute in Model |
|---|---|---|---|---|---|
| Student Number | N/A | N/A | | | Student:studentNumber |
| Student First Name | N/A | N/A | | | Student:firstName |
| Student Middle Name | N/A | N/A | | | Student:middleName |
| Student Last Name | N/A | N/A | | | Student:lasName |
| Student Appendage | N/A | N/A | | | Student:appendage |
| School | N/A | N/A | | | School:name |
| Grade Level | N/A | N/A | | | Grade:value |
| Content Area | N | N | | | ContentArea:description |
| Diagnostic Dates | N | N | | | DiagnosticResult:date |
| Diagnostic Indicators | N/A | N/A | | | DiagnosticResult:title |
| Diagostic Results | N/A | N/A | | | DiagnosticResult:result |
| Intervention Strategy | N/A | N/A | | | SelectedlnterventionStrategy:Date |
| Creation Date | | | | | |
| Intervention Strategies | N/A | N/A | | | InterventionStratey:description |
| Intervention Strategy | N/A | N/A | | | InterventionStrategy:description |
| Description | | | | | |
| Development Area | N/A | N/A | | | CompletionDisposition:description |
| Status | | | | | |
| Date | N/A | N/A | Today's Date | | N/a |
| Teacher First Name | N/A | N/A | | | Staff:firstName |
| Teacher Last Name: | N/A | N/A | | | Staff:lastName |
| Course | N/A | N/A | | | InstructorContentArea:course |
| GradeQ1 | N/A | N/A | | | Development Area:gradeQ1 |
| GradeQ2 | N/A | N/A | | | Development Area:gradeQ2 |
| GradeQ3 | N/A | N/A | | | Development Area:gradeQ3 |
| GradeQ4 | N/A | N/A | | | Development Area:gradeQ4 |
| Comments | N/A | N/A | | | ProgressReport:comment |
| Date | N/A | N/A | | | ProgessReport:Date |
| Report Type | N/A | N/A | | | ProgressReportType:description |
| Year | N/A | N/A | | | SchoolYear:Name |

Post-Conditions: The AIP may be printed on a printer.

Alternate Course: If there are no Historical AIPs for the selected student, the “No Historical AIP found” screen is presented. The user presses the OK button to close this window and return to the previous screen.

4(gg). Use Case: Create Parent Intervention Strategy Letter

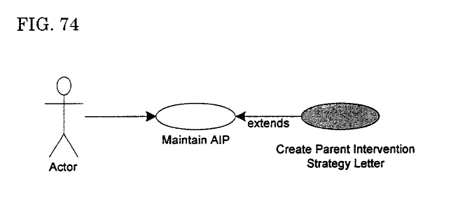

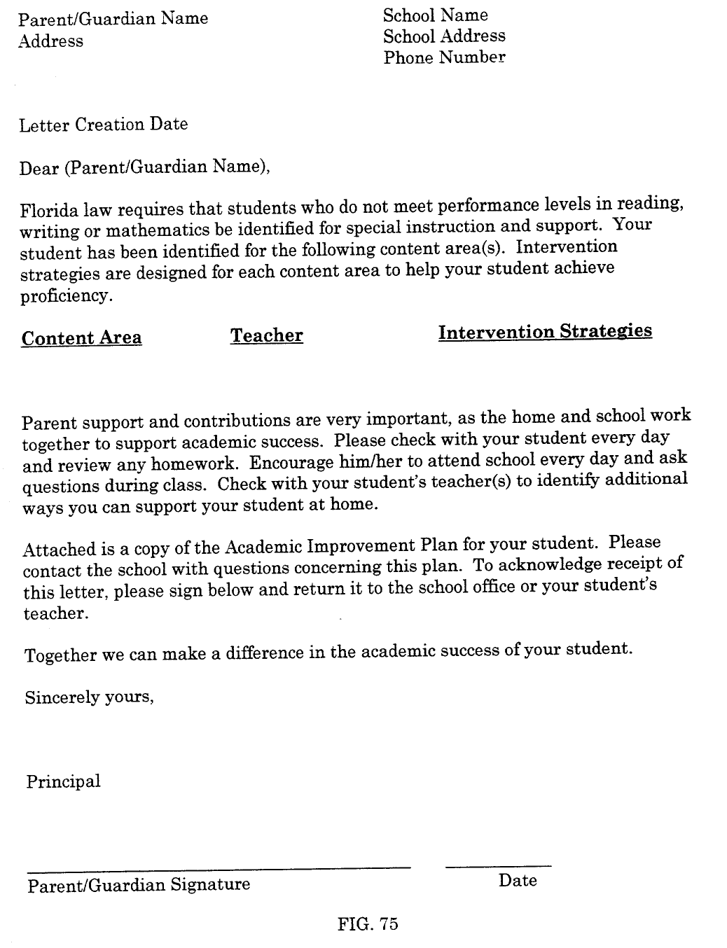

This use case allows the user to create an Intervention Strategy Letter to send to the guardians of the student. See FIG. 74.

Actors: Teacher, Guidance Counselor, Principal.

Creation includes: The user is presented with a Parent Intervention Letter in a Web page. If the user pulls down from the FILE menu to PRINT, and the Intervention Letter is printed. When the user closes the Web Browser, the user is returned to the “Maintain AIP” menu.

Field Mapping:

| | | | Default | Validation | |
|---|---|---|---|---|---|
| Field Name | Create | Update | Value | Rule | Attribute in Model |
| Student First Name | Y | Y | | | Student:firstName |
| Student Middle | Y | Y | | | Student:middleName |
| Student Last Name | Y | Y | | | Student:lastName |
| Student Appendage | Y | Y | | | Student:appendage |
| Parent First Name | Y | Y | | | Student:parent1FirstName |
| Parent Middle | Y | Y | | | Student:parent1MiddleName |
| Parent Last Name | Y | Y | | | Student:parent1lastName |
| Parent Appendage | Y | Y | | | Student:parent1Appendage |
| School Name | N | N | Tree Value | | School:name |
| School Year | N | N | Current Year | | SchoolYear:name |
| Street | Y | Y | | | Student:street |
| Suite/Apt | Y | Y | | | Student:aptNumber |
| City | Y | Y | | | Student:city |
| State | Y | Y | | | Student:state |
| Zip | Y | Y | | | Student:zip |
| Area | Y | Y | | | Student:areaCode |
| Phone | Y | Y | | | Student:phoneNumber |
| Content Area | N | N | | | ContentArea:description |
| Intervention | N | N | | | SelectedInterventionStrategy: |
| Strategy | | | | | description |
| IS Strategy | N | N | | | InterventionStrategy: |
| Description | | | | | description |
| Letter Creation Date | N | N | Today's date | | |
| School Name | | | | | School:name |
| School Address | | | | | |
| School City | | | | | |
| School State | | | | | |
| School Zip | | | | | |
| Staff First Name | | | | | Staff:firstName |
| Staff Last Name | | | | | Staff:lastName |
| Staff Appendage | | | | | Staff:appendage |

Post-Conditions: The Parent Intervention Letter may be printed on a printer.

4(hh). Use Case: Withdrawal Transfer

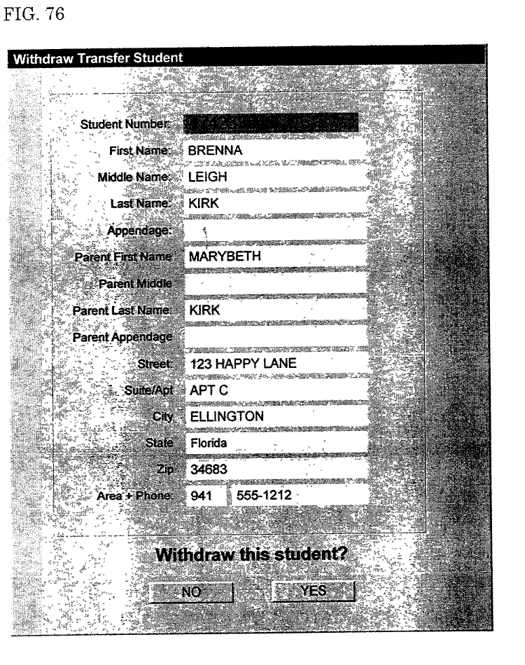

This use case describes the “Withdrawal Transfer” use case, which allowed a user to transfer a student from a school to the “Transfer” state. Another User may then transfer the student from the “Transfer” state into another school. See FIG. 67 and screen of FIG. 76.

Actors: School Administrators.

Withdrawals and transfers include: The user is presented with the “Student ID” dialog box, and enters the Student ID and presses the OK button. If the user presses the Cancel button, the user is returned to the previous menu. The “Withdrawal Transfer Student” screen is presented with the Student Information displayed to confirm the correct student has been selected. The user presses the YES button to withdraw the student from the school. If the Cancel button is pressed, the user is returned to the previous screen. The “Success!” screen appears, indicating a successful student withdrawal. The user presses the OK button to return to the “Resource Maintenance” screen.

Field Mapping:

| | | | Default | Validation | |
|---|---|---|---|---|---|
| Field Name | Create | Update | Value | Rule | Attribute in Model |
| Number | N | N | | Not editable | Student:studentNumber |
| First Name | N | Y | | Not editable | Student:firstName |
| Middle Name | N | Y | | Not editable | Student:middleName |
| Last Name | N | Y | | Not editable | Student:lastName |
| Appendage | N | Y | | Not editable | Student:appendage |
| Parent First Name | N | Y | | Not editable | Student:parent1FirstName |
| Parent Middle | N | Y | | Not editable | Student:parent1MiddleName |
| Parent Last Name | N | Y | | Not editable | Student:parent1lastName |
| Parent Appendage | N | Y | | Not editable | Student:parent1Appendage |
| Street | N | Y | | Not editable | Student:street |
| Suite/Apt | N | V | | Not editable | Student:aptNumber |
| City | N | Y | | Not editable | Student:city |
| State | N | Y | | Not editable | Student:state |
| Zip | N | Y | | Not editable | Student:zip |
| Area | N | Y | | Not editable | Student:areaCode |
| Phone | N | Y | | Not editable | Student:phoneNumber |

Additional Rules:

During the “Withdraw Transfer Student” process: Development Areas for the student are changed to “idle.” Teachers are removed from the Development Areas.

Progress Report is created: “Student Withdrawn from School A.”

Progress Report created: List of previous Development Area Courses and Teachers.

Related Use Cases: Student Transfer Maintenance. Now that the invention has been described,

What is claimed is:

1. A method for facilitating academic improvement, comprising the steps of:
providing a database of students who have qualified for an academic improvement plan in at least one predefined content area;
diagnostic testing of the students relating to their respective content area and recording in the database the diagnostic results of the testing in the database;
developing and recording in the database at least one intervention strategy based in part upon the results of the diagnostic testing of the respective students or based in part on a standardized testing;
monitoring and recording in the database each of the student's respective progress; and
documenting in the database the successful completion of the academic improvement for each respective student.

2. The method as set forth in claim 1, wherein the step of providing a database of students who have qualified for an academic improvement plan in at least one predefined content area comprises at least one development area within predefined content areas.

3. The method as set forth in claim 2, wherein the step of monitoring and recording in the database each of the student's respective progress comprises monitoring in the respective development area.

4. The method as set forth in claim 3, wherein the step of diagnostic testing of the students relating to their respective content area comprises diagnostic testing in their respective development area and recording in the database the diagnostic results of the testing in the database.

5. The method as set forth in claim 4, further comprising the step of managing and evaluating the implementation of the intervention strategies for the students by modifying the intervention strategies or developing additional intervention strategies as needed based upon the respective student's progress in each development area and then recording each management activity in the database.

6. The method as set forth in claim 5, wherein the step of documenting in the database the successful completion of the academic improvement for each respective student includes each respective development area.

7. The method as set forth in claim 2, wherein the step of providing a database of students who have qualified for an academic improvement plan in at least one development area within at least one predefined content areas comprises the step of creating a working database of students, courses, teachers, schools, test scores and eligibility and building linkages therebetween.

8. The method as set forth in claim 7, wherein the step of building linkages among students, courses, teachers, schools, test scores and eligibility comprises the steps of obtaining information concerning the respective student's demographics, student's tests, student's courses, teacher's courses, teacher demographics and school controls.

9. The method as set forth in claim 8, wherein once the information is obtained, the information is linked to relate each teacher to a school, each teacher's course to a teacher, each student to a school, each student to a teacher's course and each test score to a student.

10. The method as set forth in claim 9, wherein the step of building linkages among students, courses, teachers, schools, test scores and eligibility comprises the steps of mapping courses to content areas.

11. The method as set forth in claim 9, wherein the step of building linkages among students, courses, teachers, schools, test scores and eligibility comprises the steps of identifying eligibility rules and for each, retrieving students that meet the eligibility rules and creating an eligibility relationship between student, test score, content area and eligibility reason.

12. The method as set forth in claim 6, further comprising the steps of creating import files from the working database containing the school's control file, teacher's course file, student's file and student eligibility factors file and importing the import files into the database to load the school's control file relating to the active school year and district and to load the teacher's course file creating courses, and then associating courses to schools, creating teachers and associating teachers to courses.

13. The method as set forth in claim 2, further including the step of recording in the database the eligibility reason for each content area for each student who qualified for an academic improvement plan in at least one development area.

14. The method as set forth in claim 13, further including the step of providing means for viewing the eligibility reason for each student by the student's teacher or the student's administrator.

15. The method as set forth in claim 2, further including the step of providing means for viewing, updating or deleting the diagnostic testing result of the students in their respective development area by the student's teacher or the student's administrator.

16. The method as set forth in claim 2, further including the step of providing means for adding additional diagnostic testing results of the students in their respective development area and recording them in the database.

17. The method as set forth in claim 2, further including the step of providing means for viewing, updating or deleting the intervention strategies by the student's teacher or the student's administrator.

18. The method as set forth in claim 2, further including the step of providing means for adding additional intervention strategies for the students in their respective development area and recording them in the database.

19. The method as set forth in claim 2, wherein the step of developing intervention strategies for the students in their respective development area and recording them in the database comprises the selection of the intervention strategies from a list of available strategies.

20. The method as set forth in claim 1, further including the step of producing an intervention strategy letter for each student and recording the same in the database.

21. The method as set forth in claim 20, wherein the intervention strategy letter comprises a listing of the intervention strategy and teacher for each content area for the student.

22. The method as set forth in claim 21, wherein the intervention strategy letter is communicated to the parent or guardian of the student.

23. The method as set forth in claim 2, wherein the step of monitoring and recording in the database each of the student's respective progress comprises the step of adding a progress update to the respective development area of the students.

24. The method as set forth in claim 2, wherein the step of monitoring and recording in the database each of the student's respective progress comprises the step of viewing, updating or deleting the progress update to the development area for the students.

25. The method as set forth in claim 5, wherein the step of managing and evaluating the implementation of the intervention strategies for the students by modifying the intervention strategies or developing additional intervention strategies as needed based upon the respective student's progress and then recording each management activity in the database comprises the steps of viewing, adding, updating or deleting the intervention strategies based upon the progress updates to the respective development area for the students.

26. The method as set forth in claim 5, wherein the step of managing and evaluating the implementation of the intervention strategies for the students by modifying the intervention strategies or developing additional intervention strategies as needed based upon the respective student's progress and then recording each management activity in the database comprises the steps of viewing, adding, updating or deleting the intervention strategies based upon additional diagnostic testing of the students in their respective development area.

27. The method as set forth in claim 1, wherein the database is secured to allow access by teachers to only the records of the teacher's students.

28. The method as set forth in claim 1, wherein the database is secured to allow access by school administrators to only the records of the students of the administrator' school.

29. The method as set forth in claim 1, wherein the database is secured to allow access by district administrators to only the records of the students of the administrator's district.

30. The method as set forth in claim 1, further including the step of withdrawing a student from one school and registering the student in a new school allowing the academic improvement to be continued in the new school.

31. The method as set forth in claim 1, further including the step of maintaining teachers, teacher's courses and administrators in the database.

32. The method as set forth in claim 1, further including the step of creating reports from the database listing information such as development areas by teachers, academic improvements by grade, content area by grade, academic improvement status, development areas and students by content area, development area by status, students by school and content area or students by school and grade for selected content areas.

33. The method as set forth in claim 1, wherein the database is server-based and accessible by teachers and administrators of the students.

34. The method as set forth in claim 1, wherein the database is web-enabled allowing access to the database via an intranet, extranet or the Internet.
